(19) United States
(12) Patent Application Publication
(10) Pub. No.: US 2003/0126054 A1
(43) Pub. Date: Jul. 3, 2003

(54) Method and apparatus for optimizing investment portfolio plans for long-term financial plans and goals

(76) Inventor: W. Richard Purcell, JR., Boulder, CO (US)

Correspondence Address: W. Richard Purcell, Jr., 810 S. Lashley, Boulder, CO, 80305, US

(21) Appl. No.: 10/034,872

(22) Filed: Dec. 28, 2001

(51) Int. Cl. G06F 17/60

(52) U.S. Cl. 705/36

(57) ABSTRACT

The present invention provides information to enable investors to see how portfolio plans comprising pluralities of best-diversified portfolios compare in probabilistic measures of prospects and risks for their long-term financial plans and goals, to enable and educate investors to select and stay on most promising portfolio paths for their long-term plans, goals, and priorities.

Users are enabled to indicate asset classes or investment categories to be considered for investment portfolios, specify a long-term financial plan including cash flows to and from a portfolio plan in a plurality of years, and specify desires for a portfolio plan to comprise different portfolios for differently taxed funds and different investment periods of the financial plan as the time horizon shortens. Concepts and methods of Modern Portfolio Theory are applied in combination with the specified desires for pluralities of portfolios in a portfolio plan to determine a series of best-diversified portfolio plans; for the long-term financial plan, with each of the series of best-diversified portfolio plans Monte Carlo simulations are run to develop a probability distribution of final wealth at the end of the time horizon of the financial plan. From these analyses, best-diversified portfolio plans are compared graphically in probabilistic measures of long-term results for the plan, on which measures the portfolio plans will standardly rank and compare differently.

From the foregoing, investors can obtain, for plans with realistic pluralities of cash flows and portfolios, information and understanding for judging and selecting portfolio plans that offer best prospects for their long-term goals and priorities and for staying with well-selected portfolio plans in the face of short-term volatilities that would frighten less informed investors off course.

### FIELD OF THE INVENTION

The present invention relates to providing information for investors to compare, judge, select, and maintain best multi-portfolio plans for their long-term financial plans and goals.

### BACKGROUND OF THE INVENTION

With respect to comparison and selection of investment portfolios for long-term plans and goals, there are two quite different bodies of methods and tools that one could consider prior art. One is a body of theoretical writings presented in terms of mathematical equations addressed to financial theorists, the other a body of methods and tools presented to the investing public and to financial planners who advise investors.

While the theoretical writings provide methods for selecting portfolios for long-term investments, the nature and intended use of these methods are so different from those of the present invention that they simply do not meet the invention's purpose. In contrast to the present invention's purpose of informing investors on how portfolio plans compare in relevant measures, to enable investors to judge, select, and follow good portfolio paths toward their goals and priorities, the methods in the theoretical writings put the portfolio selection in the hands of equations, based on simplified mathematical representations of investor plans and artificial mathematical abstractions to represent investors' priorities and goals. Investors get portfolio recommendations based on mathematical abstractions, without the information and understanding essential for accepting and maintaining good investment paths toward long-term goals.

In the theoretical methods, investor plans are standardly represented by equations that omit essential common realities in real investors' plans, such as major cash flows in particular future years, different portfolios to take advantage of differences in taxations of different investment accounts, and changes to more conservative portfolios in investors' older years. Investors' goals and priorities are standardly represented by theoretical equations such as logarithmic or hyperbolic utility functions, which cannot adequately represent real investors' goals and priorities for all the following reasons: investors are concerned with more dimensions, measures, and characteristics of portfolios and their prospects than such formulations represent, such as concern with the tradeoff between long-term prospects and short-term ups and downs along the way; investor goals and priorities commonly have discontinuities that utility function formulations do not represent, such as major concern that results reach certain levels at certain times and far less interest in additional gains; and most important, investors do not and cannot define their goals and priorities in terms of the mathematical utility functions the theoretical methods require. The result that these theoretical methods deliver to the investor is simply identification of a recommended portfolio, with no information in defense of the recommendation but mathematical formulations that investors do not understand.

In the most fundamental aspects of both purpose and method, the approaches in the theoretical writings are exactly the opposite of the present invention. Relative to the core question, “Who is in charge and being served?”, the methods in the theoretical writings are computer-mathematics-centered, while the invention is investor-centered. Those theoretical methods put the computerized mathematics in charge of weighing the alternatives and making the portfolio selection, requiring and using abstracted formulations of investor plans and goals for the convenience of the computerized mathematics. This is the opposite of the purpose and method of the present invention, which puts the investor or user in charge of weighing the alternatives and making the selection, with the role of the computer and its mathematics being development and presentation of the most appropriate information to inform the investor or user for his/her understanding, consideration, and selection decision.

Based on unrealistic simplifications of investors plans and artificial abstractions of their goals, chosen for mathematical convenience and elegance more than to fit investors' plans and goals, the recommendations produced by these methods are not validly selected for and unlikely to be best for real investors' real plans and real goals. Furthermore, to effectively help investors with long-term goals, a portfolio recommendation is not enough. It's essential to show investors why the recommended portfolios are best, to build likelihood that the investor will adopt a good portfolio plan and stay on track in the face of short-term ups and downs that frighten uninformed investors off track. This the methods in the theoretical writings do not do.

The body of theoretical writings is so different in purpose, method, and output from the present invention, and so remote from what most investors need, that relative to the present invention it should not even be considered relevant prior art.

In the face of unsuitability of the theoretical writings for the investing public, another quite different body of methods and tools for portfolio comparison and selection is provided to the investing public and to financial planners who advise investors. But this prior art is based on a misconception so fundamental it makes the prior art not only inadequate but dangerously misleading. This misconception is, in comparisons of best-diversified portfolios for selection for investors with long-term plans and goals, omission of the time-horizon dimension of the investor's plans and goals. In prospects and risks for the dollar results investors seek, time horizon is a most important factor in portfolio comparison and selection. For the various longer time horizons typical of individuals' and families' financial plans and goals, portfolios compare differently, and very differently than for a single year. For this reason, it is most essential to base selections on comparisons for the full time horizons of investor's plans and goals, and to enable the investor to direct the comparison to portfolio plans that comprise different portfolios in different years of the plan as the time horizon shortens. In omitting the time-horizon dimension, the prior art fails to do either of these essential things. Instead, for the investor with long-term plans and goals, it misleads investors to select a single portfolio for the length of the time horizon of the plan, and to base this selection on a comparison of best-diversified portfolios in only annual rate of return for the individual single investment year.

Because this body of prior art methods and tools is intended for the present invention's purpose of providing information for investors and their financial advisors to understand and use, for selecting investment portfolios for long-term plans and goals, it is the relevant prior art for consideration relative to the present invention. It deserves discussion not only to describe its inadequacies that the present invention overcomes, but also because it includes elements of analysis that the present invention combines in a novel way to overcome the prior art's inadequacies.

In a paper published in 1952, Harry M. Markowitz introduced a major advance in comparing and selecting investments in terms of result probabilities. He presented a concept and method for determining a range of best-diversified mixes of a set of investments, offering a range of expected returns for a single investment period each with minimal uncertainty or probabilistic variation from the expected result as measured by variance or standard deviation of the result for the single investment period. This analytical method has become known as Modern Portfolio Theory, and is commonly applied to portfolios comprising sets of broad and fundamentally different types of investment called asset classes in a process called asset allocation. The result of the analysis is standardly presented on a graph as an efficient frontier curve along which the points represent the range of best-diversified investment mixes or portfolios. The efficient frontier graph standardly presents and compares these portfolio points in probabilistic measures of annual rate of return, for the individual year. The vertical axis represents mean or expected rate of return, and the horizontal axis represents return-rate standard deviation, a probabilistic measure of variation above and below the expected return rate for the individual year. The process of planning and analysis often called asset allocation and summarized by the efficient frontier graph offers two very valuable advantages: it leads the investor toward effective diversification, spreading investment funds among differing investments to reduce uncertainty and risk, and it narrows the best-portfolio search from a vast number of potential portfolios to a range of the best-diversified portfolios along a curve.

Use of Modern Portfolio Theory for asset allocation has become widely accepted and applied in comparing and selecting investment portfolios for individuals and families with long-term financial plans and goals. For this purpose, a second step is required: from the range of the best-diversified portfolios represented by the efficient frontier curve, a particular portfolio must be selected. For this purpose, in standard current practice the vertical axis of the efficient frontier graph is labeled “return”, the horizontal axis is labeled “risk”, and the graph is presented and used as a “risk/return” comparison of the portfolio points along the curve as if valid for any time horizon. To select a particular portfolio for the investor from those along the curve, commonly the investor's “risk tolerance” is judged from a multiple-choice questionnaire and used to determine the choice. In this approach, the “risk” basis for the selection is actually return-rate standard deviation, a measure of individual-year return-rate variation. For comparing, selecting, and recommending investment portfolios for individuals and families with long-term financial plans and goals, this process is the prior art. It is standardly taught in college courses on investment, taught in training and continuing education of professional investment-financial planning advisors, incorporated in professional and governmental regulations and guidelines for such professionals, and performed by widely used software tools for professional financial planners who advise investors and now increasingly for individual investors on the Internet.

However, the second step in this process, by which the portfolios along the curve are compared and one selected, is fundamentally misconceived, mislabeled in ways that tend to conceal the misconception, and unacceptably misleading. The fundamental misconception is failure to consider the time-horizon dimension of the investor's plans and goals. Due to two powerful long-term effects, compounding and the tendency of individual-year return-rate variations to balance out, over longer time horizons the advantage of higher expected return rate increasingly outweighs the disadvantage of larger return-rate standard deviation. As a result, for longer time horizons portfolios that appear far too “risky” on the single-year efficient frontier become far more favorable in overall long-term prospects, and even more favorable in measures of long-term risk. The second step in the prior art, selecting one portfolio for a long-term plan and goal based on the individual-year “risk/return” comparison of the efficient frontier and “risk tolerance” criterion, amounts to choosing a portfolio for long-term plans and goals based on investor fear of individual-year ups and downs as measured by individual-year standard deviation, without even considering multi portfolio plans or how the portfolio plans considered compare in probabilistic prospects and risks for the investor's long-term plans and goals. Therefore this prevalent prior art is rejected as not only inadequate but dangerously misleading.

To adequately incorporate the time-horizon dimension in comparisons for portfolio selection, to enable investors to select portfolio plans that are best in probabilistic prospects and risks for their long-term plans, goals, and priorities, it is necessary to (1.) consider portfolio plans comprising pluralities of best-diversified portfolios held in different time phases of the financial plan as the remaining time horizon shrinks, and (2.) compare the portfolio plans in probabilistic measures of results for the investor's financial plan over its full time horizon.

Further, because these probabilistic assessments are multi-dimensional, with more than one meaningful measure of comparison on which portfolio plans commonly compare differently, and because investors may also consider other portfolio-plan characteristics important for the selection, simply identifying a “best” portfolio plan is not sufficient. Instead, it's essential to (3.) with respect to a probabilistic measure of financial plan results, show the investor how a series of best-diversified portfolio plans compare, to help investor find a portfolio plan that represents offers the best combination of attractions in that measure and one or more other criteria relative to his/her plan, goals, and priorities.

There is nothing in the prior art that fulfills these three essential requirements.

However, systems have been introduced that include or claim to include both portfolio selection and probabilistic assessment for long-term plans and goals, which deserve further discussion, to summarize their inadequacies and also for discussion of methods these systems use which the present invention applies in a novel way.

In recent years, methods have been proposed in which portfolios are assessed and compared for long-term plans in terms of long-term final wealth probabilities determined according to the assumption that the final wealth probability distribution is a lognormal distribution, or stated another way that the probability distribution of the log of the final wealth is a normal distribution. However, for almost every long-term financial or investment plan, this assumption is not valid. Almost every such plan includes cash flows in or out, from investor to portfolio or portfolio to investor, in each of a plurality of the years of the plan, and for such plans the lognormal final wealth distribution assumption is not valid. Therefore, for the purpose of the present invention methods based on the lognormal final wealth distribution assumption are not satisfactory.

Other methods and tools have been introduced to assess final wealth probabilities of long-term investment plans using Monte Carlo simulation. Monte Carlo simulation was pioneered by Stanislaw Ulam for assessment of nuclear process result probabilities at Los Alamos half a century ago, at essentially the same time that Harry Markowitz originated concepts and methods of Modern Portfolio Theory. Monte Carlo simulation has since come into wide use in various fields of science, engineering, and economics, for assessing result probabilities of processes with probabilistic inputs and no method at hand for direct calculation of the result probabilities. Monte Carlo simulation does not require that the result probability distribution be lognormal or any other particular shape, and enables development of a probability distribution of the final wealth for virtually any financial plan and portfolio plan.

However, for selecting best portfolio plans for long-term financial goals, Monte Carlo simulation alone is not a sufficient or acceptable method. For even a small number of asset classes, even if only portfolios defined in integer allocation percentages are considered, the number of portfolios is vast. But for just one portfolio, to develop a probability distribution of the final wealth for a long-term financial plan, Monte Carlo simulation requires thousands of simulations each proceeding year by year to the time horizon of the plan. Even with the powers and speeds of computers in current use by investors and financial planners, assessing all the potential portfolios with Monte Carlo simulation for just one financial plan would commonly require hours or days. Exploring what-ifs for variations of the financial plan would take much longer. Monte Carlo simulation alone does not provide any system or capability for zeroing in on best portfolio plans for long-term financial plans and goals with acceptable efficiency and speed.

While neither Modern Portfolio Theory nor Monte Carlo simulation is by itself adequate for selecting best portfolios for long-term financial plans and goals, the two techniques offer complementary powers. While Modern Portfolio Theory produces a portfolio comparison in only rates of return for the individual year, it efficiently guides the analysis toward effective diversification and greatly narrows the search for best portfolios to a range of the best-diversified along a curve. And while Monte Carlo simulation offers no way to efficiently find best portfolio plans, it offers a means to advance the probabilistic assessment of any one portfolio or portfolio plan from single-year return rate to long-term dollar results for a long-term plan and goal. Together, these two analytical techniques offer capabilities for fulfilling the present invention's purpose.

Recently systems and methods for portfolio selection have been introduced that use both Modern Portfolio Theory and Monte Carlo simulation, or claim to do so. However, these systems suffer deficiencies in all three essential requirements previously stated. Even where such systems apply Modern Portfolio Theory for portfolio selection also offer or claim to offer Monte Carlo simulation, they fail to incorporate the Monte Carlo simulation in the portfolio comparison for the selection. Instead, these systems present the comparison for portfolio selection using the results of only the Modern Portfolio Theory, the efficient frontier graph comparing individual best-diversified portfolios in terms of rate of return for the only the individual year. Only after the portfolio selection id made do these systems offer anything said to be produced by Monte Carlo simulation, applied to just the one previously selected portfolio. Thus the basis provided for the portfolio selection offers choice of only one or another single portfolio for the entire length of the time horizon of the financial plan, failing requirement (1.); displays comparison of these choices only in terms of return rate for the individual year, failing requirement (2.); and in probabilistic measures of results for the financial plan over its full time horizon, does not provide any comparison of portfolio choices, failing requirement (3.).

Accordingly, it would be beneficial for investing individuals and families to provide a system for selection of portfolio plans for long-term plans and goals that includes these three essentials, and thus provides investors heretofore-unavailable information and understanding for comparing and selecting best portfolio plans for their long-term plans, goals, and priorities.

### SUMMARY OF THE INVENTION

In accordance with the present invention, method and apparatus are provided for determining and graphically displaying a range of best-diversified portfolio plans comprising pluralities of best-diversified portfolios, assessed and compared in several measures of probabilistic prospects and risks for long-term final wealth results for long-term financial plans and goals, derived from user entry and selection of information on sets of investment categories to be considered as components of portfolios with data regarding their return-rate probabilities; information on financial plans including time horizons, schedules of cash flow investments into and withdrawals from a portfolio plan, and other relevant considerations including fees, taxes, and inflation rates; and information for defining a series of best-diversified portfolio plans in which a portfolio plan may comprise a plurality of best-diversified portfolios in parallel or in series or both with respect to time. The present invention combines in an integrated analysis the powers of both Modern Portfolio Theory (MPT) and methods of simulation for assessing probabilities for multi-period financial or investment results such as Monte Carlo simulation (MCS), to determine, for a set of investment categories selected by the user, a range of best-diversified portfolios of the investment categories; to determine from the foregoing and information for defining portfolio plans a series of best-diversified portfolio plans comprising pluralities of best-diversified portfolios; to determine for the long-term financial plan a probability distribution for long-term final wealth results with each of the series of best-diversified portfolio plans comprising best-diversified portfolios; and to display graphically assessments and comparisons of the series of best-diversified portfolio plans in several probabilistic measures of prospects and risks for long-term final wealth results for the user-entered plans and goals. With respect to these graphic analyses the user is enabled to obtain displays including additional user-entered portfolio plans assessed in comparison with the series of best-diversified portfolio plans, and to interactively obtain additional information relative to probabilistic prospects and risks of portfolio plans represented on the graphs and graphic and numeric displays of allocation proportions of the investment categories for each of a number of portfolio plans offering equivalent prospects and risks for the financial plan. For a user-designated portfolio plan, and for pluralities of portfolio plans for comparison, the user is enabled to obtain additional graphic analyses and displays including probabilistic simulations of year-by-year progressions of portfolio value through the time horizon of the plan, and probability distributions of long-term final wealth results on which the user can move interactively to obtain displays of probabilities for meeting various targets for the final wealth. From this information the user can compare best-diversified portfolio plans in several measures on which they will commonly compare differently to judge a portfolio plan that offers best prospects for the investor's long-term plans, goals, and priorities. For a portfolio plan thus selected, the user is enabled to obtain additional graphic analyses and displays of probabilities for meeting the investor's goals through various numbers of years and how these probabilities would be changed if values of key items in the financial plan are changed by various amounts.

The graphic analyses and numerical displays of user inputs and selections and analyses, results, and graphs are presented on an electronic display screen offering interactive access to further information relative to what the graphs display, and together with text narration and explanation are produced in the form of a user-customizable printed report for the investor.

The apparatus of the present invention preferably includes a computer system that executes software for receiving user entries and selections, performing mathematical analyses, and displaying results and supporting data in the form of graphs as well as numerical presentations on a computer display screen and on printed pages. In one embodiment, this software includes a word processing software package that enables user customizing, storage, and production of printed reports and a spreadsheet software package that enables electronic exchange of data between the invention's novel software and other computerized data processing and storage systems.

The invention further includes a novel long-term optimizing (LTO) software package that enables users to enter values and otherwise provide information to define a long-term financial plan, including a multi-period time horizon, schedules of cash flow contributions and goals that define inputs to and withdrawals from a portfolio plan, and data regarding fees, taxes, and inflation values; information specifying asset classes or investment categories to be considered for portfolios, for which return-rate data are provided; and information for defining a series of best-diversified portfolio plans comprising pluralities of best-diversified portfolios in the same or different investment periods. The novel LTO software performs analyses and presents graphic and numeric displays to identify, assess, and compare best-diversified portfolio plans in several probabilistic measures of prospects and risks for long-term final wealth results for the long-term financial plan.

More particularly, from user selection or entry of asset classes or other investment categories each with historical or predicted data for expected return rates, return-rate standard deviations, and correlation coefficients relative to corresponding data for the other investment categories, the LTO software determines and produces a graphic display of a range of portfolio points representing best-diversified portfolios or allocation proportions of the investment categories, offering a range of expected return rates each at minimal return-rate standard deviation or uncertainty. This range of portfolio points is presented graphically as a curve on an efficient frontier graph, showing and comparing the range of best-diversified portfolios in terms of expected return rate and return-rate standard deviation for the individual year. The LTO software determines this curve using established mathematical methods of MPT such as modified Simplex linear programming, which produces a theoretical curve reflecting portfolios in which the allocation proportions of the investment categories are fractional percentages of unlimited precision, which as a practical matter no investor could attain or maintain. In a preferred embodiment of the invention, the curve is also produced as a range of practical portfolio points representing a range of the best-diversified portfolios in a population including only portfolios in which the allocation proportions are integer percentages, representing portfolios that offer essentially the same best-diversification benefits as portfolios along the theoretical curve but are more practical targets for investors to obtain and maintain. In any case the efficient frontier curve resulting from this part of the invention's analysis measures and compares the range of best-diversified portfolios in terms of individual-year rate of return, specifically expected individual-year return rate and individual-year return-rate standard deviation. This analysis does not incorporate any consideration of the investor's long-term plan or goals or their time-horizon dimension with respect to either desirability of different portfolios in different time phases of the plan or need for assessment and comparison of portfolio alternatives for the financial plan over its full time horizon, and therefore does not provide an adequate comparison of the portfolios for selection of a particular portfolio plan for the investor's long-term plan. But this analysis and its results do provide essential raw material for further analysis performed by the present invention, specifically identification of the range of best-diversified portfolios upon which the further analysis should be focused and the description of this range as a curve.

The LTO software then defines a series of best-diversified portfolio plans comprising pluralities of best-diversified portfolios, based on information provided by the user for this purpose together with the information defining the range of best-diversified portfolios.

The novel long-term optimizing software then performs analyses to determine a probability distribution for the long-term final wealth results of the user-entered financial plan with each of the series of best-diversified portfolio plans. In one embodiment, the software develops the final wealth probability distributions using Monte Carlo simulation. More specifically, for each of the series of best-diversified portfolio plans the software produces a large number of Monte Carlo simulations for the entered long-term financial plan to determine a distribution of probabilities for the long-term final wealth.

From such distributions for each of the series of best-diversified portfolio plans, in a preferred embodiment the LTO software produces and displays graphic assessments and comparisons of the series of portfolio plans in several probabilistic measures of prospects and risks for the final wealth for the long-term financial plan. In one embodiment, one assessment and comparison is presented in a “Goal Frontier” graph with one axis representing expected value of the final wealth, as a best single measure of long-term prospects; the second axis representing minimum final wealth that at a specific high probability will be met or exceeded, as a measure of long-term safety versus risk; and a series of portfolio plan points are positioned to represent the series of best-diversified portfolio plans assessed and compared relative to the measures of the two axes. Another assessment and comparison is presented in another Goal Frontier graph identical to that just described except that the second axis represents probability of meeting-or-beating a final wealth goal as the measure of safety versus risk, and the portfolio plan points are positioned relative to the scale of this second axis to represent assessment and comparison with respect to this measure.

In this embodiment, once the graphic long-term probabilistic assessments and comparisons are produced and displayed on Goal Frontier graphs, the long-term optimizing software enables the user to interactively obtain additional graphic and numeric displays of information pertaining to portfolio plans represented on the graphs and the prospects they offer for the financial plan, for portfolio plan assessment, comparison, and selection by the investor for his/her long-term financial plan, goals, and priorities.

Further, in a preferred embodiment of the present invention, for a portfolio plan the user selects on a Goal Frontier graph or enters, or for each of two such portfolio plans for comparison, the novel long-term optimizing software produces and graphically displays individual probabilistic simulations of the development of portfolio value, net of cash inflows to and outflows from the portfolio plan in the financial plan, year by year through the time horizon of the plan. Additionally, for a portfolio plan selected on a Goal Frontier graph or entered by the user, or for each of two portfolio plans for comparison, a graphic presentation is produced and displayed showing a probability distribution of the long-term final wealth for the investor's entered long-term financial plan. On such a probability distribution display the user is enabled to interactively move to various target heights for the final wealth, and at each target height moved to, obtain a graphic and numeric display of the probabilities of meeting-or-beating versus falling short of that final wealth target.

For a user-entered long-term financial plan and user selected or entered portfolio plan, in a preferred embodiment the novel long-term optimizing software produces an additional set of probabilistic sensitivity graphs showing and comparing probabilities of meeting the investor's goals through various numbers of years with values of key items in the financial plan changed by various amounts. On each graph in this set a first curve shows probabilities of meeting the investor's goals through various numbers of years with all financial plan items at planned values. For each of a number of user selectable items in the financial plan, additional curves are produced and displayed showing what the goal-meeting probabilities would be for various numbers of years with the value of the user-selected financial plan item changed by various amounts. Through interactive explorations on these graphs, investors and their financial and investment advisors can obtain information on alternatives for key financial plan items and resulting probabilities for meeting goals useful for optimizing the financial plan relative to the investor's priorities.

In a preferred embodiment of the invention, additional graphs based on the user's entries and selections are produced and displayed to educate users and investors on the overwhelming power and effect of the time-horizon dimension in determining comparisons and relative favorabilities of portfolios and portfolio plans, to help users and investors understand and benefit from the novel features of the present invention to incorporate the time-horizon dimension in assessments and comparisons of portfolio plans, specifically (1.) considering multi-portfolio plans in which different portfolios can be held during different phases of the plan as the remaining time horizon shrinks, and (2.) assessing and comparing portfolio plans for the financial plan over its full time horizon. To provide the desired education, graphs are produced and displayed to illustrate separately and jointly two long-term investment effects that cause portfolios and portfolio plans to compare differently for longer time horizons: long-term compounding, and reduction of standard deviation of the return-rate average for longer investment time horizons due to the tendency of high and low deviations to partially offset each other. These graphs show visually that for longer time horizons, the advantage of higher expected return rate increasingly outweighs the disadvantage of larger return-rate standard deviation, making best-diversified portfolios with higher return rates and larger return-rate standard deviations compare much more favorably for longer time horizons. It is especially important to help users see and understand these time-horizon effects on portfolio comparisons and best selections for two reasons: in the absence of such understanding, investors are inclined to react to immediate short-term ups and downs in ways that are adverse for prospects for their long-term plans and goals; and the prior art with its single-year method of comparing single portfolios, including labeling of the measure of short-term ups and downs as “risk,” encourages this misconceived viewpoint and approach.

In a preferred embodiment of the invention, the user is enabled to electronically produce printed reports containing all of the graphic and numeric information and displays produced on the computer display, or a user-selected subset of such information and displays, together with text narration and explanations of the graphic and numeric information, in a format the user can display, manipulate, customize, store, and print using the LTO software or popular word processing software products. Electronic or magnetic files of investor plans, including information to restore or recreate user entries and selections and graphic and numeric analyses and results, are storable in electronic file formats that can be opened and manipulated in the LTO software or popular spreadsheet software products, enabling the user to electronically exchange and use in other computer and software systems and products information from the invention, and electronically exchange and use in the novel long-term optimizing software information from other computer and software systems and products.

Based on the foregoing, it can be readily seen that the present invention provides major advantages and benefits in enabling investors and their financial advisors to identify, compare, judge, understand the advantages of, and select and maintain portfolio plans that are optimal in probabilistic prospects and risks for investors' long-term plans, goals, and priorities.

For an investor's long-term financial plans and goals, selected list of investment categories with return-rate data, and desires regarding pluralities of portfolios in portfolio plans, information is developed to identify the range of portfolios that through effective diversification offer various expected return rates each at minimal return-rate variation or uncertainty, and define a series of best-diversified portfolio plans comprising best-diversified portfolios, and then assess the best-diversified portfolio plans and display graphic comparisons of them in measures of probabilistic prospects and risks for the investor's long-term financial plans and goals, enabling investors and users to judge, select, and commit to portfolio plans that are optimal in probabilistic prospects and risks for the investor's long-term financial plans, goals, and priorities. Additional information is developed and displayed graphically and numerically to help users and investors understand and explain the superiority and extent of superiority of optimal portfolio plans, obtain fuller understanding of the prospects and risks for investors' long-term financial plans and goals with various portfolio plans, and with a selected portfolio plan obtain information useful for optimizing other key elements of the financial plan relative to the investor's priorities. This information is of great importance to most individuals'and families' financial plans for a number of reasons. For most long-term financial plans, optimal portfolio plans offer high probabilities of producing value from investment returns that greatly exceeds net value of original investment amounts and provides most of the means to meet long-term needs and goals, while other portfolio plans or investments offer probabilities of only a small fraction of the prospects for value gain over the time horizon of the financial plan that the most advantageous portfolio plans offer. And compared to other key factors in long-term financial plans, portfolio plan selection is far less suitable to common intuition, in fact counterintuitive in the sense that selections best and safest for long-term plans appear more risky in short-term views and news and when compared using the prevalent prior art method of single-year portfolio comparison. With much of the American public now participating in investment, and various trends increasing individuals' and families' responsibilities for their long-term financial wellbeing, the present invention can be described as offering important value to most of the public as well as to the community of professionals and organizations offering investment and financial planning education, advisory, and management services to the public.

Additional advantages of the present invention will become readily apparent from the following discussion, particularly when taken together with accompanying drawings.

### BRIEF DESCRIPTIONS OF THE DRAWINGS

FIG. 1 is a block diagram generally identifying the hardware and software of the present invention.

FIG. 2 identifies principal steps and processes of the long-term optimizing software.

FIG. 3 illustrates a computer display screen having a window for user selection of investment categories including display and revision of investment categories and return-rate data.

FIG. 4 illustrates a computer display screen having a window for user entry of allocation proportion constraints.

FIG. 5 illustrates a computer display screen having a window containing an efficient frontier graph.

FIG. 6 illustrates a computer display screen having a window containing an efficient frontier graph with both theoretical and practical-portfolio-points efficient frontier curves.

FIG. 7 illustrates a computer display screen having a window containing an efficient frontier graph showing user scrolling on the graph, a window containing a toolbox for the graph, and a window showing probabilistic return-rate extremes for a portfolio point scrolled to.

FIG. 8 illustrates a computer display screen having a portfolios window showing allocation proportions for a number of portfolios corresponding to a portfolio point scrolled to on an efficient frontier graph.

FIG. 9 illustrates a computer display screen having a window containing an efficient frontier graph with the axes labeled according to current portfolio comparison-and-selection practice: the expected-return-rate axis labeled “return” and the return-rate standard deviation axis labeled “risk”.

FIG. 10 illustrates a computer display screen having a window for graph selection showing a first page with buttons for selection of an efficient frontier graph and several graphs illustrating long-term effects that make portfolios compare differently for longer-term plans and goals.

FIG. 11 illustrates a computer display screen having a window containing a graph showing compound return for various numbers of time periods at various return rates.

FIG. 12 illustrates a computer display screen having a window containing a graph showing compound return for various numbers of time periods at expected return rates of various investment categories.

FIG. 13 illustrates a computer display screen having a window containing a compound frontier graph, like an efficient frontier graph except that the vertical axis compares the portfolios' expected returns compounded for a plurality of time periods instead of for a single period.

FIG. 14 illustrates a computer display screen having a window containing a graph illustrating that for return-rate average, for longer time horizons the standard deviation shrinks.

FIG. 15 illustrates a computer display screen having a window containing a graph illustrating that for longer investment time horizons, the advantage of higher expected return rate increasingly outweighs the disadvantage of larger return-rate standard deviation.

FIG. 16 illustrates a computer display screen having a financial plan entry window with a page for user entries pertaining to investment withdrawal amounts and time periods in a financial plan.

FIG. 17 illustrates a computer display screen having a financial plan entry window with a page for user entries pertaining to investment amounts and time periods in a financial plan.

FIG. 18 illustrates a computer display screen having a window showing a period-by-period cash flow schedule of investment and withdrawal amounts in a financial plan.

FIG. 19 illustrates a computer display screen having a financial plan entry window with a page for user entries pertaining to fees, taxes, and inflation in a financial plan.

FIG. 20 illustrates a computer display screen having a window with a page for specifications concerning portfolio plans.

FIG. 21 illustrates a computer display screen having a window for graph selection showing a second page with buttons for selection of graphs illustrating probabilistic analyses of long-term financial and portfolio plans.

FIG. 22 illustrates a computer display screen having a window containing a graph showing ten Monte Carlo simulations of year-by-year development of portfolio value for a long-term financial plan with one portfolio plan.

FIG. 23 illustrates a computer display screen having a window containing a graph showing two sets of Monte Carlo simulations of year-by-year development of portfolio value for a long-term financial plan with two different portfolio plans.

FIG. 24 illustrates a computer display screen having a window containing a graph showing fifty Monte Carlo simulations of year-by-year development of portfolio value for a long-term financial plan with one portfolio plan.

FIG. 25 illustrates a computer display screen having a window containing a graph showing a final wealth probability distribution for a long-term financial plan with one portfolio plan, obtained from ten thousand Monte Carlo simulations.

FIG. 26 illustrates a computer display screen having a window containing a graph showing a final wealth probability distribution for a long-term financial plan with one portfolio plan, with a toolbox window and user scrolling on the graph and display of probabilities relative to a target value scrolled to.

FIG. 27 illustrates a computer display screen having a window containing a graph showing final wealth probability distributions for a long-term financial plan with each of two portfolio plans, each obtained from ten thousand Monte Carlo simulations.

FIG. 28 illustrates a computer display screen having a window containing a graph showing final wealth probability distributions for a long-term financial plan with each of two portfolio plans, with user scrolling and display of probabilities relative to a target height scrolled to for each portfolio plan.

FIG. 29 illustrates a computer display screen having a window for graph selection showing a third page including buttons for selection of graphs for comparing, selecting, and optimizing portfolio plans in probabilistic prospects and risks for long-term plans and goals.

FIG. 30 illustrates a computer display screen having a window containing a “Goal Frontier” graph of type A comparing a range of best-diversified portfolio plan points in probabilistic measures of prospects and risks for final wealth of a long-term financial plan.

FIG. 31 illustrates a computer display screen having a window containing a “Goal Frontier” graph of type B comparing a range of best-diversified portfolio plan points in probabilistic measures of prospects and risks for final wealth of a long-term financial plan.

FIG. 32 illustrates a computer display screen having a window containing a “Goal Frontier” graph of type B comparing a range of best-diversified portfolio plan points in probabilistic measures of prospects and risks for final wealth of a long-term financial plan, with a Toolbox window and display of portfolio plan points shown to be safest, competitive, and uncompetitive.

FIG. 33 illustrates a computer display screen having a window containing a “Goal Frontier” graph of type B comparing a range of best-diversified portfolio plan points in probabilistic measures of prospects and risks for final wealth of a long-term financial plan, with user scrolling, display of final wealth prospect and risk measures for a portfolio plan point moved to, and addition of portfolio plan points along the curve of best-diversified.

FIG. 34 illustrates a computer display screen having a portfolio plans window showing allocation proportions information for portfolios in a number of portfolio plans corresponding to a portfolio plan point scrolled to on a Goal Frontier graph.

FIG. 35 illustrates a computer display screen having a window containing a probabilistic sensitivity graph with a curve showing probabilities of meeting goals for a long-term financial plan and portfolio plan for each of a range of financial plan time horizons.

FIG. 36 illustrates a computer display screen having a window containing a probabilistic sensitivity graph with a curve showing probabilities of meeting goals for a long-term financial plan and portfolio plan for each of a range of financial plan time horizons with user scrolling and display of values for the position scrolled to along the curve.

FIG. 37 illustrates a computer display screen having a window containing a probabilistic sensitivity graph showing probabilities of meeting goals for a long-term financial plan and portfolio plan for each of a range of financial plan time horizons, and a number of additional curves each representing a different value for a first item in the financial plan chosen from a menu in a toolbox also shown in the illustration.

FIG. 38 is similar to FIG. 37 except that the additional curves on the graph represent different values for a second financial plan item chosen in the illustrated toolbox menu.

FIG. 39 illustrates a computer display screen having a window containing the same graph shown in FIG. 37 with additional illustration of user scrolling to a desired position along a user-selected one of the curves and display of values for a position scrolled to along the curve.

FIG. 40 illustrates a computer display screen showing simultaneous display of a plurality of windows containing plan entries or selections and graphic analyses of the plan and comparisons of alternatives for the plan.

FIG. 41 illustrates a computer display screen showing a page in a word processing software product containing a graph copied and pasted from the long-term optimizing software together with text added in the word processing software.

FIG. 42 illustrates a computer display screen having a window enabling the user to customize and produce a report containing plan information and graphs together with supporting texts, to be opened in word processing software where the user can further customize, save, and print the report.

FIG. 43 illustrates a computer display screen showing a print preview of several pages of a report in word processing software produced by the long-term optimizing software.

FIG. 44 illustrates a computer display screen showing a window for saving to disk information enabling later display of a plan and graphs in the long-term optimizing software.

FIG. 45 illustrates a computer display screen showing a long-term optimizing software plan file opened and displayed in spreadsheet software.

### DETAILED DESCRIPTION

The description of the current invention that follows is directed to an embodiment for use (a) on an IBM-compatible PC system, (b) in a Microsoft “Windows” environment, in general conformance with Microsoft “Windows” user-interface style conventions, (c) with analysis of data and production and display of graphic, tabular, and numeric output performed by novel long-term optimizing (“LTO”) software, (d) with data stored and exchanged electronically in a format compatible with Microsoft Excel spreadsheet software and displays and reports produced and stored in a format manipulable and printable in Microsoft Word word processing software. However, the invention is not limited to the elements of the described embodiment. It could be used in other computer or electronic systems, such as handheld devices or systems including computer servers and client devices in a network or communication with the internet or with other means of data exchange, in other software environments (e.g., UNIX, LINUX, or Java), with user-interface conventions different from those of Microsoft “Windows” such as those found on Macintosh or Palm computers or electronic devices. The invention could be embodied in systems including long-term optimizing software different from that described hereinafter. The long-term optimizing software of the present invention could use data from a number of sources including user entry or selection, electronic storage, electronic data exchange with other computer or software systems or the internet, and data containment within the novel LTO software. Storage and electronic input, output, and exchange of data could be by means other than Microsoft Excel compatible format, and user manipulation and printing of reports and other printed output could be by means other than compatibility with Microsoft Word format, such as compatibility with other software and user manipulation and printing of reports and other output from the novel LTO software.

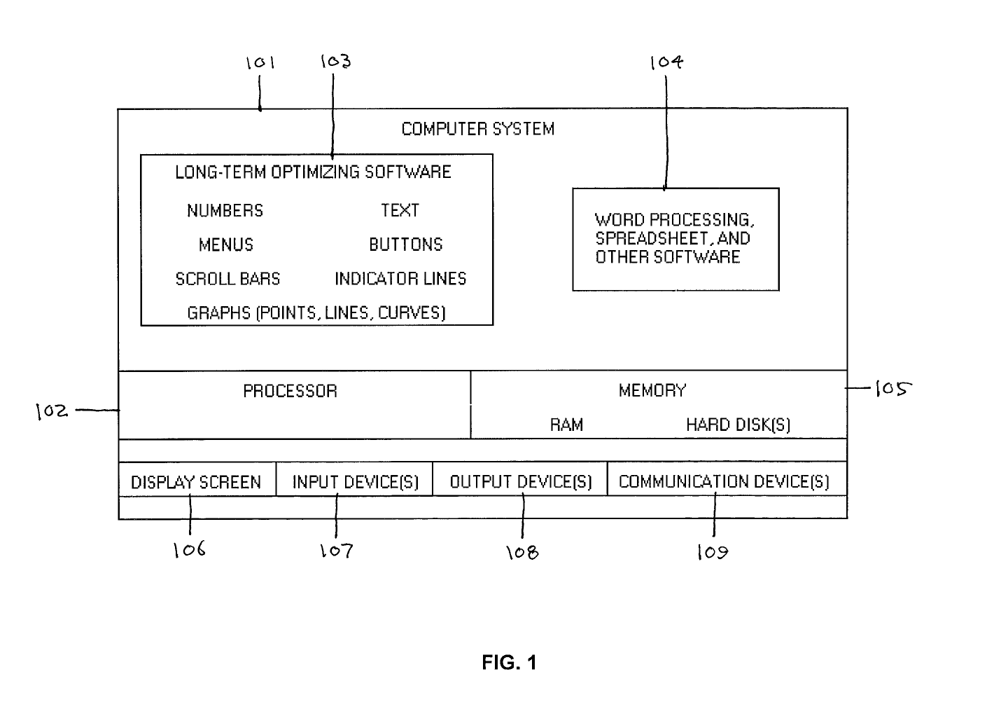

With reference to FIG. 1, this preferred embodiment of the present invention is schematically illustrated in a block diagram. The present invention is embodied in a computer system 101 that includes the IBM-compatible PC having a processor 102 processing the data and other information inputted or otherwise provided to or otherwise developed by the computer system 101. The processor executes software 103 that enables the user to identify, for a plurality of investment categories and a financial plan covering a plurality of investment periods, a comparison of a plurality of portfolio plans comprising favorably diversified portfolios or mixes of the investment categories in probabilistic measures of prospects and risks relative to results and goals for the plurality of investment periods. In one embodiment the software includes novel long-term optimizing software which performs a number of advantageous functions, which will be described in detail later herein, including performing probabilistic analyses, displaying analyses in form of graphs as well as tables and numeric output and printed reports, and displaying for activation by the user menus, tabs, buttons, scroll bars, and other tools for user manipulation of the software and interaction with the graphic analyses. In the embodiment described herein the software also includes other software 104 including spreadsheet software able to open, manipulate, and store data stored by the novel LTO software and data stored by other software systems, and word processing software able to open, manipulate, print, and store reports and other output created by the novel LTO software.

The computer system also includes a memory 105 that communicates with and is accessed by the processor 102 for performing the desired functions, including obtaining data from memory in connection with execution of the software 103, 104. In one embodiment, the storage memory 105 includes a random access memory (RAM) that typically stores data involved in processing such as calculated data or interim calculated data. The memory 105 also includes one or more hard or floppy disks or other storage devices for storing the executable software, as well as saving data or other information, such as information for reproducing graphic analyses that were created and are stored for later display, interaction, revision, and other use.

The computer system 101 further includes a computer terminal display screen 106 that illustrates or displays information in a desired or advantageous format, such as tabular and other displays of data entered or selected by the user or obtained electronically and graphic displays of analyses such as comparison of probabilistic measures of calculated results of financial plans with each of a plurality of portfolio plans. One or more input devices 107 enable the user to communicate the user's inputs, selections, and desired interactions to the computer system 100. The input devices 107 typically include a keyboard and mouse. One or more output devices 108 may also be provided and could include, for example, a printer that provides desired hard copies of displayed information including graphic analyses and reports. One or more communication devices 109 provide electronic connection and permit communication with the internet, other computers, servers, and networks and other electronic devices via wire, cable, wireless, or other communication media.

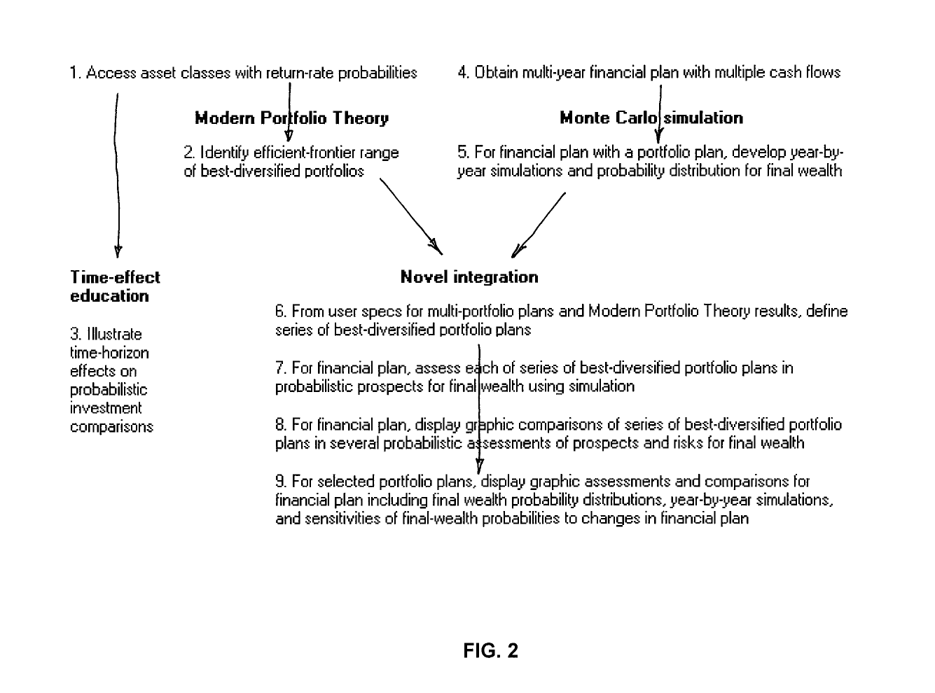

FIG. 2 illustrates a flow diagram of major parts of the process of the present invention performed by the LTO software in one embodiment of the invention. Before proceeding to detailed discussion of each of these parts of the process, it is desirable to summarize an overview of the process as illustrated in FIG. 2, first to identify inadequacies of known processes which perform only one or another subset of this process, and then to preview the order in which these steps are discussed in detail in the description that will follow.

In current prior art practice using known methods and tools, portfolio comparison-and-selection is performed using Modern Portfolio Theory as summarized in parts 1 and 2 at upper left in FIG. 2. This two-part process provides the benefit of sifting through a vast numbers of portfolios to identify a range of best-diversified portfolios of the selected investment categories, which range can be described as a curve, but compares only single-portfolio alternatives and compares them only in rate of return for the individual year. This analysis omits the time-horizon dimension of the investor's financial plans and goals, and due to this omission fails to (1.) consider portfolio plans comprising different portfolios in different time phases of the financial plan as the remaining time horizon shrinks, and (2.) assess and compare the portfolio plans for the financial plan over its full time horizon. Part 3 summarized at lower left in FIG. 2, which an embodiment of the present invention provides for user education, shows that time effects make portfolio comparisons very different for longer time horizons. Therefore, for portfolio selection for long-term plans and goals, the prior art portfolio comparison method summarized in parts 1 and 2 in FIG. 2 is not adequate.

Another body of known methods and tools features application of Monte Carlo simulation to develop probabilistic assessments for results through the time horizon of a long-term financial plan with a particular portfolio or portfolio plan, as summarized in parts 4 and 5 of the present invention process diagram at upper right in FIG. 2. While this method can offer long-term assessment with any one portfolio or portfolio plan, it provides no system or efficient method for sifting though the vast numbers of portfolios or portfolio plans that could be assembled from even a very short list of asset classes to reveal the best for a long-term financial plan, and is therefore inadequate for identifying best portfolio plans for long-term financial plans and goals.

As illustrated in FIG. 2, the present invention includes both of the known methods discussed just above, illustrated respectively in parts 1 and 2 featuring Modern Portfolio Theory and parts 4 and 5 featuring Monte Carlo simulation. In parts 6, 7, 8, and 9 of the process diagrammed in FIG. 2, the present invention provides a novel integration of these two known methods to define, assess, and graphically compare a series of best-diversified portfolio plans comprising pluralities of best-diversified portfolios in several measures of probabilistic prospects and risks for final wealth of a long-term financial plan. Through this novel integration the present invention provides the valuable benefit of enabling users and investors to see, compare, judge, select, and maintain portfolio plans that are optimal for the investor's particular long-term financial plans, goals, and priorities.

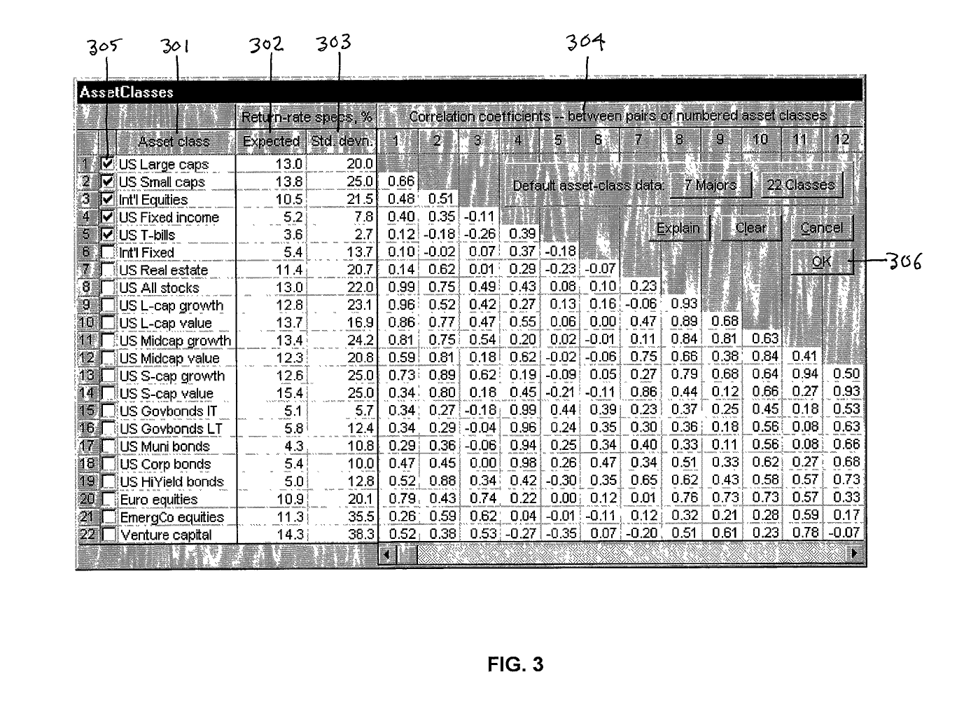

Referring now to FIG. 3, detailed description is commenced regarding a version of the LTO software in one embodiment of the present invention. FIG. 3 illustrates a window that can be generated on a computer screen for the purpose of executing part 1 of the process illustrated in FIG. 2, namely selection or determination of investment categories to be included in portfolios and provision of return-rate data for the investment categories. In this window the investment categories are assumed though not required to be asset classes. In this window a table is displayed with numbered rows for asset classes or other investment categories, with columns for their names 301, their mean or expected return rates 302, and their return-rate standard deviations 303. In the LTO software the investment period is the year, and accordingly in this window and elsewhere return rate means individual-year return rate. Additional columns 304, with numbered column headings corresponding to the asset classes' numbered rows, provide cells for correlation coefficients representing same-investment-period relations between return-rate variations of all pairs of the asset classes or investment categories. Data are provided for asset class names and their expected return rates, return-rate standard deviations, and correlation coefficients based on historical data for indices of the asset classes. The user is enabled to revise or replace any or all of these provided entries and to electronically save the revised or new entries for future use.

For user selection of asset classes or investment categories for inclusion in portfolios, checkboxes are provided in a column 305 to left of the column for names 301. It should be noted that to enable meaningful analysis applying the concept of Modern Portfolio Theory to determine a range of favorably diversified portfolios, at least three asset classes or investment categories must be selected. After selection of asset classes as indicated by marks in checkboxes as illustrated 305, the user can confirm the selections and close the asset classes window using the OK button 306 located in the window's upper right.

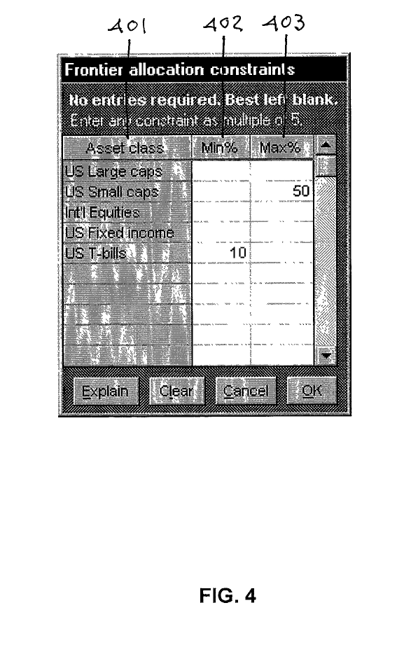

FIG. 4 illustrates a window for optional user specification of constraints or limits on allocation proportions of individual investment categories. The investment categories previously selected as shown in FIG. 3 are listed in rows of a column 401. In the row of any of the selected investment categories or asset classes, the user can enter a percentage number representing a lower limit in a Min % column 402 or an upper limit in a Max % column 403. In another embodiment of the invention the user is enabled to specify minimum and maximum constraints for the total of a plurality of investment categories. Any constraints entered will be observed by the LTO software in identifying best-diversified portfolios at various expected return rates in development of efficient frontier curves, as will be described next.

Once asset classes or investment categories are selected with return rate data provided as illustrated in FIG. 3, performing part 1 of the process shown in FIG. 2, the user can make selections that cause the LTO software to perform part 2 of the process shown in FIG. 2 and develop an efficient frontier graph with a curve comprising portfolio points representing a range of best-diversified portfolios or allocation proportions of the asset classes.

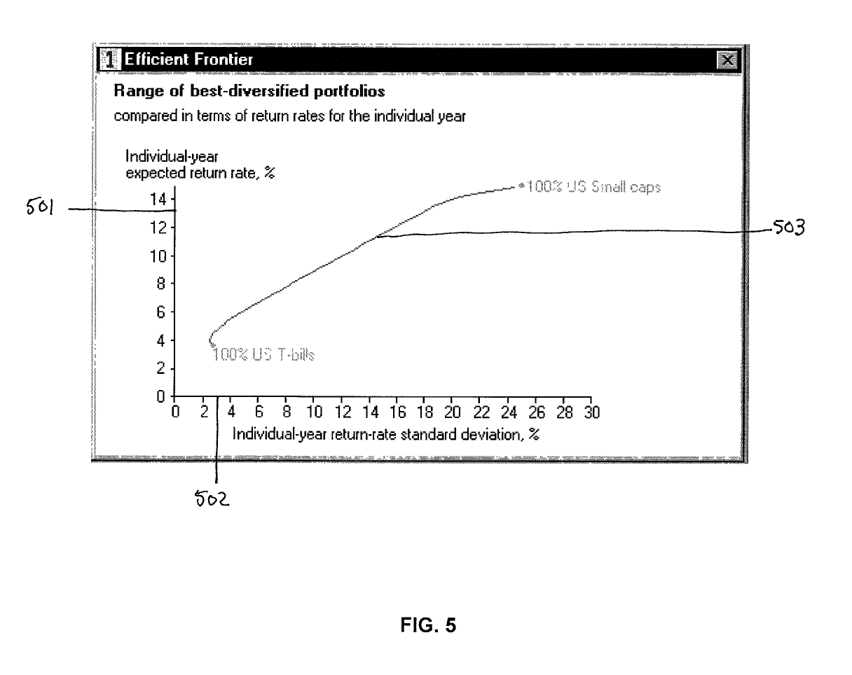

FIG. 5 illustrates an efficient frontier graph produced by the LTO software by applying known concepts and methods of Modern Portfolio Theory (“MPT”) to the return-rate data of the selected asset classes previously illustrated in FIG. 3, subject to any constraints specified by the user as illustrated in FIG. 4. The axes of this graph are probabilistic measures of individual-year rate of return, the vertical axis 501 representing expected individual-year return rate and the horizontal axis 502 representing individual-year return-rate standard deviation. The curve 503 represents a continuum of portfolio points each representing one of the best-diversified portfolios or allocation proportions of the selected asset classes or investment categories. At each return-rate height offered by any portfolio of these asset classes conforming to any constraints, the point on the curve represents the smallest return-rate standard deviation of any portfolio with that expected return rate. This curve is developed by the LTO software using a known method of MPT analysis such as a method known as modified Simplex linear programming. Other software products are known to produce similar graphs using the same or comparable methods. Along the curve 503 produced by these methods, portfolios represented by points along the curve can be identified in terms of allocation proportions of the component asset classes, and have allocation proportions of unlimited precision, commonly presented in known prior art software systems to the nearest tenth or hundredth of one percent. It must be noted that such precise allocation proportions cannot be justified by the underlying data upon which the analyses are based, for two reasons: the data represent too few historical periods to justify any such precision in specification of best-diversified portfolios, and the purpose of the graph is to represent portfolios to be selected for future periods when the asset classes' return rate probabilities are likely to differ from the asset classes' historical return-rate probabilities at least slightly in ways that cannot yet be known. Additionally, allocation proportions of such precision cannot be achieved and maintained by investors and therefore are not practical targets for investors.

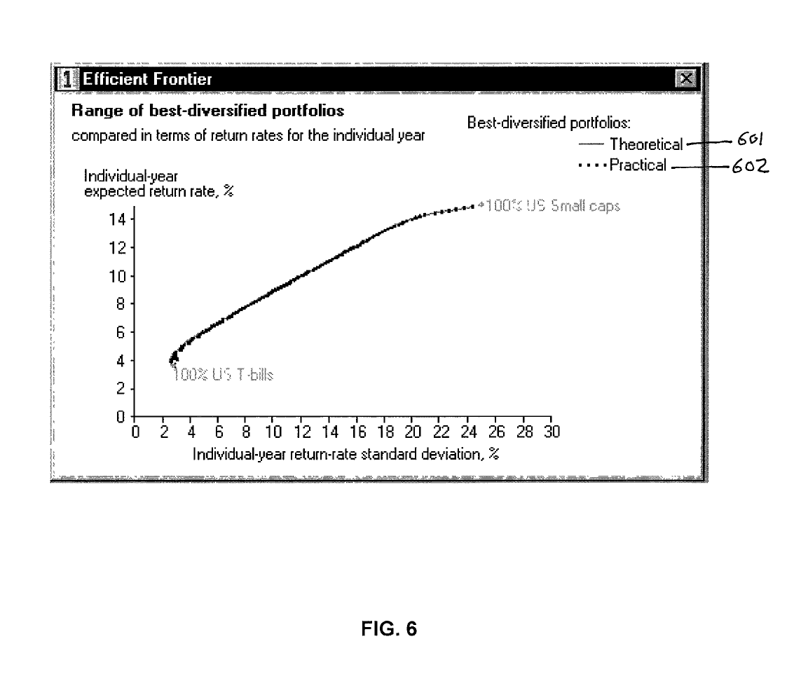

FIG. 6 illustrates a novel second version of the efficient frontier graph produced by the LTO software. On this graph the same efficient frontier curve shown in FIG. 5, developed through established MPT methods, is shown in gray and labeled Theoretical 601 in the key at the graph's upper right. On the same graph a second efficient frontier curve is depicted as a range of black dots and labeled Practical points 602 in the key at upper right. Generally, a practical-portfolio-points curve provided by the LTO software represents a range of the best-diversified in a population of all portfolios of the asset classes in which all allocation proportions are integer percentages. In FIG. 6 the particular practical portfolio points curve illustrated represents a range of best-diversified portfolios in which all allocation proportions are integer multiples of five percent. The practical-portfolio-points efficient frontier curve is developed by the novel LTO software using a novel method. The range of expected return rates that all portfolios of the asset classes offer is divided into small increments such as 0.1 percent increments. For each expected-return-rate increment, portfolios of the desired integer percent allocation proportions that offer expected return rates within that increment are identified and compared, and a point is added on the curve representing the smallest return-rate standard deviation offered by any of these portfolios. As can readily be seen from FIG. 6, the resulting efficient frontier curve of practical portfolio points lies essentially right on top of the theoretical efficient frontier curve, illustrating that portfolios of the practical-portfolio-points curve offers essentially the same best-diversification benefits as portfolios represented by the theoretical efficient frontier curve. The reason for this is that very large numbers of portfolios that are not exactly on the theoretical curve are nevertheless so close to it as to offer essentially the same best-diversification benefit, and these portfolios include many with integer percentage allocation proportions, as shown in the illustration. Advantages to investors of the novel practical-portfolio-points efficient frontier curve produced by the LTO software can readily be seen. The portfolios represented do not have the fractional-percentage allocation proportions of the points along the theoretical curve, which show precision the underlying data do not justify; and compared to the fractional-percentage allocation proportions of the portfolios represented by the theoretical curve, the practical-portfolio-points curve represents portfolios that are far more practical targets for investors to attain and maintain.

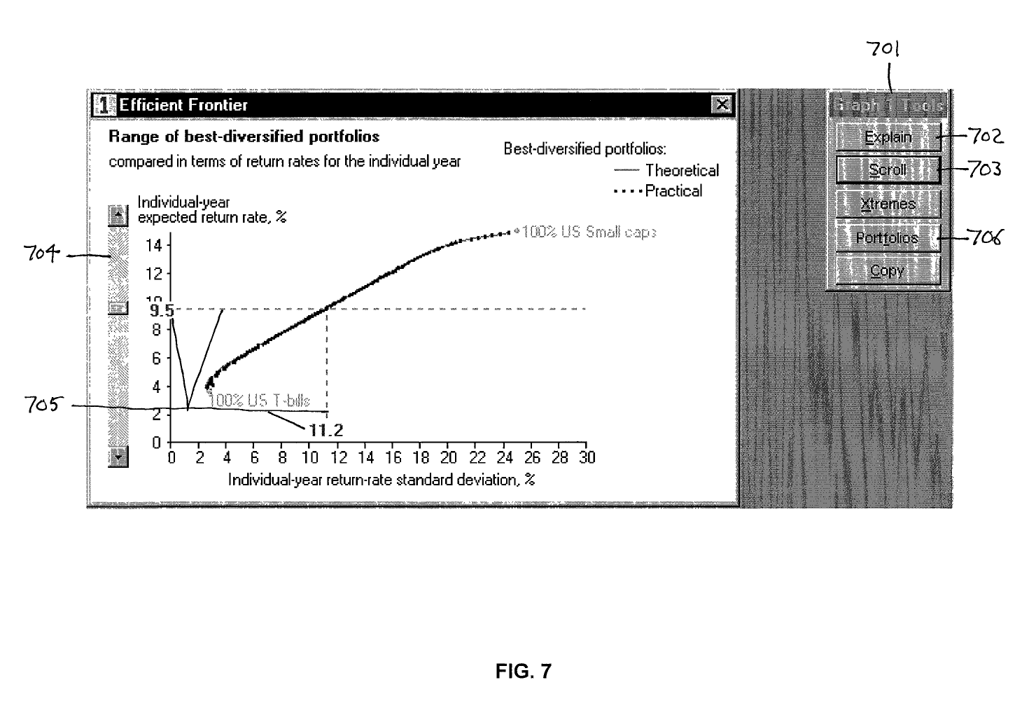

FIG. 7 is another illustration of the efficient frontier graph shown in FIG. 6 with additional items illustrated. To upper right of the graph window, a toolbox 701 is shown containing buttons for the user's interactive use of the graph. An Explain button 702 enables the user to obtain a window containing a text explaining the graph and explaining use of its interactive tools. The Scroll button 703 enables the user to obtain a scroll bar 704 at left of the graph, with which the user can move to various expected-return-rate heights along the curve of best-diversified portfolio points. At any height the user scrolls to, a pair of horizontal and vertical dotted lines and numbers 705 show both graphically and numerically the expected return rate and the return-rate standard deviation of the portfolio point moved to, as illustrated in FIG. 7. The Portfolios button 706 enables the user to display another window as described next.

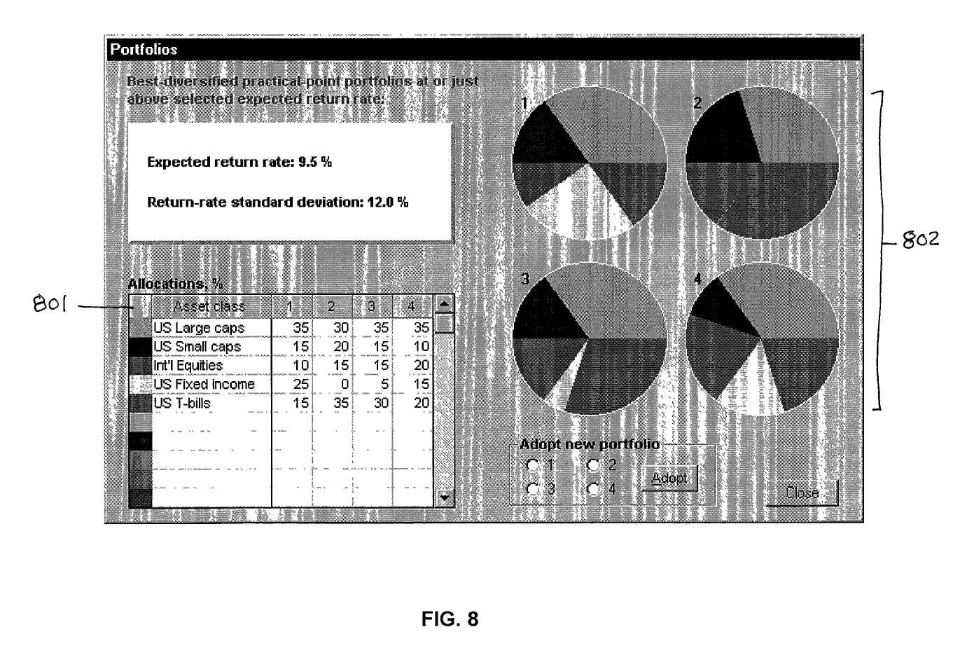

FIG. 8 illustrates a portfolios window. After scrolling to any portfolio point on the efficient frontier graph curve as illustrated in FIG. 7, the Portfolios button 706 enables the user to display the portfolios window showing allocation proportions of the asset classes or investment categories for each of a number of portfolios chosen to correspond to the portfolio point scrolled to. For each of these portfolios, allocation proportions are shown numerically in a table 801 and visually in pies 802. It should be noted that for a chosen portfolio point the LTO software commonly identifies a plurality of portfolios, as illustrated by the four portfolios identified for one portfolio point in FIG. 8. Established methods and tools identify only one portfolio for a portfolio point along the efficient frontier curve, and the LTO software's identification of a plurality of portfolios for one point is novel. In most cases, for a portfolio point along the curve there is indeed one portfolio that reflects the point exactly, indeed it is this portfolio that determines the point. However, here again it is essential to recognize that there are very large numbers of portfolios that while not exactly on the curve are so close that for all practical purposes they too are along the curve, and considering the lack of precision of the underlying investment-category return-rate data as representations of the future, there is no practical basis for considering each portfolio point to represent only one portfolio. To determine a plurality of portfolios with practical allocation proportions that best correspond to a chosen portfolio point, the LTO software applies a search method. A total population of all portfolios with allocation proportions that are integer multiples of integer percentage numbers is sorted into groups defined by increments of expected return rate. For a chosen portfolio point, the software identifies those portfolios with a corresponding expected return rate and smallest return-rate standard deviations, including at least one best portfolio and often one or more additional portfolios that correspond very well to the portfolio point.

The preceding descriptions with reference to FIGS. 3 through 8 describe an embodiment of the invention in which the LTO software performs parts 1 and 2 of the present invention process diagrammed in FIG. 2. As previously noted, these are the parts used in the prior art featuring use of Modern Portfolio Theory for comparing portfolios for selection of one portfolio for the length of the time horizon of a long-term financial plan. Accordingly, it is now appropriate to review that prior art with particular reference to its shortcoming which the present invention overcomes.

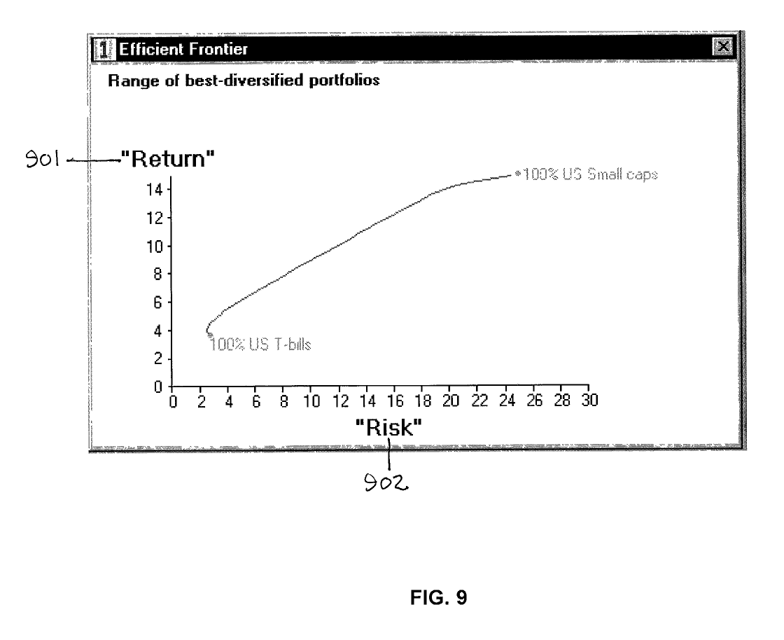

To select among the range of best-diversified single portfolios for a financial plan, in the prior art the comparison of the portfolios used is the efficient frontier graph first illustrated in FIG. 7, with the labeling of the measures represented by this graph's axes commonly changed as illustrated in FIG. 9. The measure represented by the vertical axis, expected return rate for the individual year, is commonly called simply “return” 901, and the measure represented by the horizontal axis, return-rate standard deviation for the individual year, is commonly called simply “risk” 902. To provide a criterion for selecting a single portfolio according to this comparison, college textbooks on investment various measures of this “risk/return” comparison of the portfolios along the curve and relate these measures to conceptions of investors' “indifference curves”. In practice, especially in software tools for professional financial planners who advise investing individuals and families, the criterion standardly used for selecting a portfolio according to the efficient frontier comparison is the investor's “risk tolerance.” In this criterion, “risk” means what the horizontal axis measures, which is actually return-rate standard deviation or variation for the individual year. So selecting a portfolio according to “risk tolerance” amounts to selecting a single portfolio for the length of a long-term plan on the basis of how much standard deviation or variation above and below an expected return rate the investor is willing to tolerate in the individual year.

From the preceding pages describing and illustrating development of the efficient frontier graph, one can readily see that this graph compares the portfolios in rate of return for just the individual year without using any information about the investor's financial plans and goals. But for virtually every investing individual or family, the financial plans and goals are measured in dollars and cover a time horizon of many years, and for longer term financial plans and investment time horizons, the portfolios compare very differently than shown for the individual year on the efficient frontier. Therefore, for a long-term financial plan, (1.) the assessments and comparisons should consider portfolio plans that comprise different portfolios in different time phases as the remaining time horizon shrinks, and (2.) to see which portfolio plans are best, the portfolio plans must be compared in probabilistic measures of results for the time horizon dimension of the plan instead of just for the individual year. This will be shown and illustrated. The purpose of part 3 of the process shown in FIG. 2 is to help users see and understand the powerful effects of time horizon in changing how portfolios compare and which portfolio plans are best, and thus see, understand, and gain the benefits the present invention provides.

Discussion is now addressed to part 3 of the present invention process diagrammed in FIG. 2, illustration of effects of time horizon that change portfolio comparison, for user and investor education.

In the embodiment of the present invention under current discussion, this illustration is provided through several interactive graphs supported by text explanations. The purpose of these illustrations and explanations is to help users and investors see, understand, appreciate, and gain the benefits from the advantages of the novel long-term optimizing analyses and graphs produced by the invention, which will be described and illustrated further on in this description. In light of the prevalence of the prior art in which the comparison of portfolio choices for selection compares only single-portfolio alternatives to be held for the full length of the plan, for which the comparison is shown only for the individual year, without consideration of the time horizon dimension of investors' plans and goals, this education can be important in helping many users and investors see and gain the benefits of the invention.

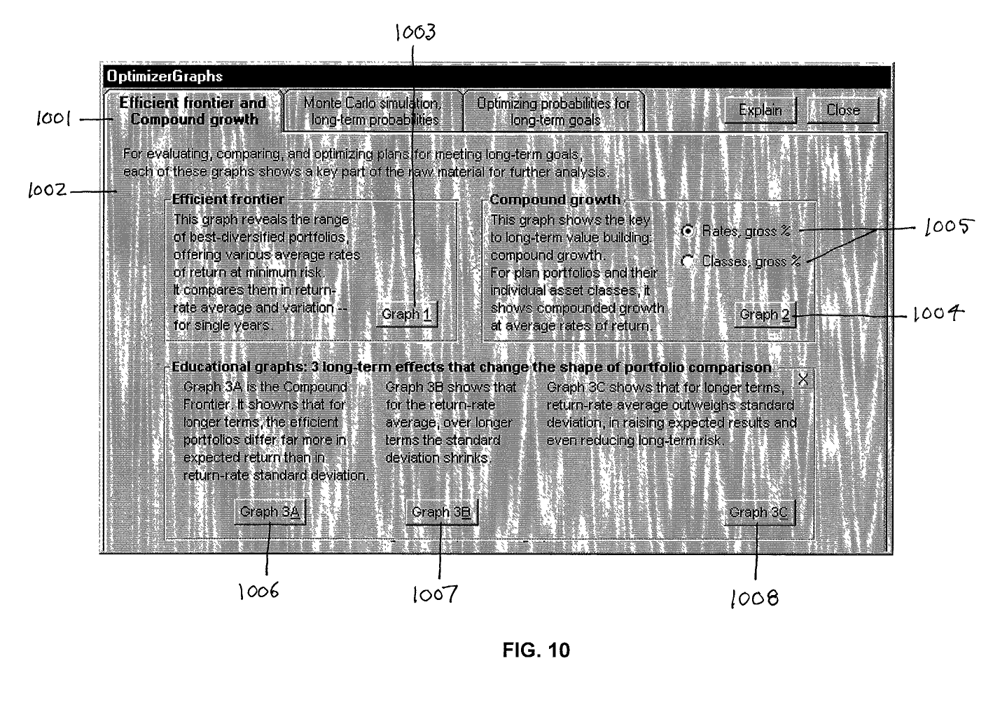

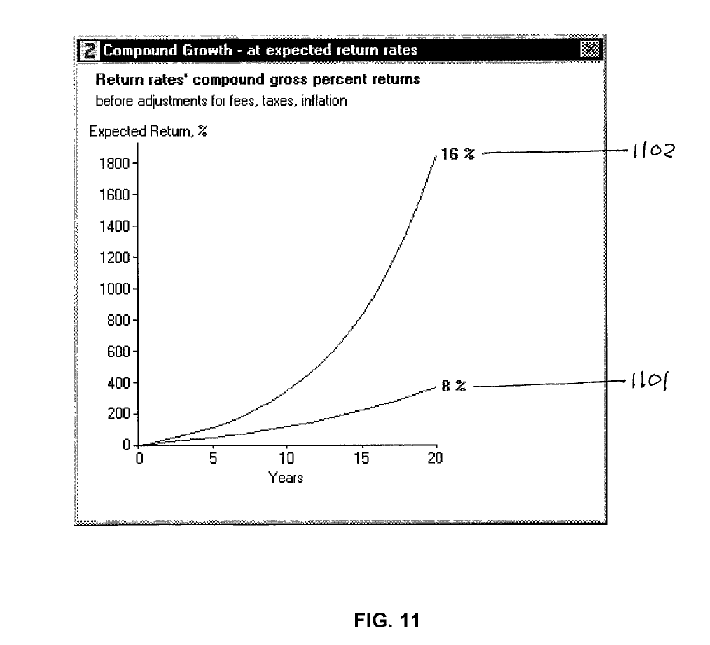

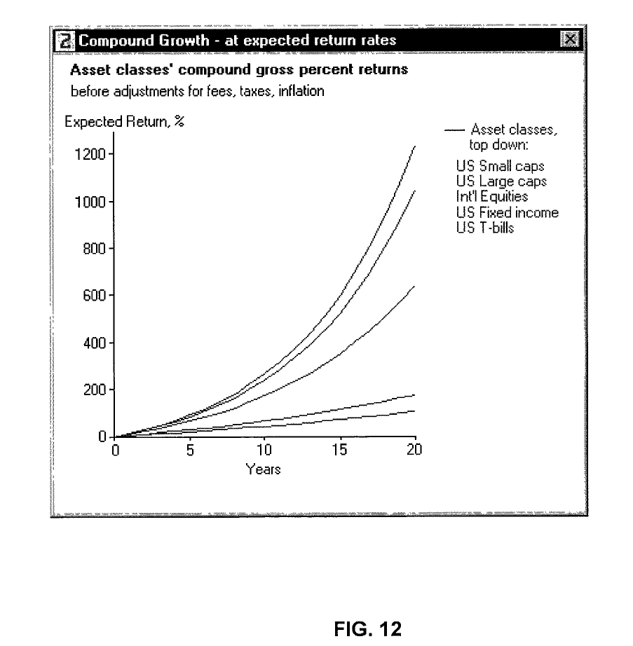

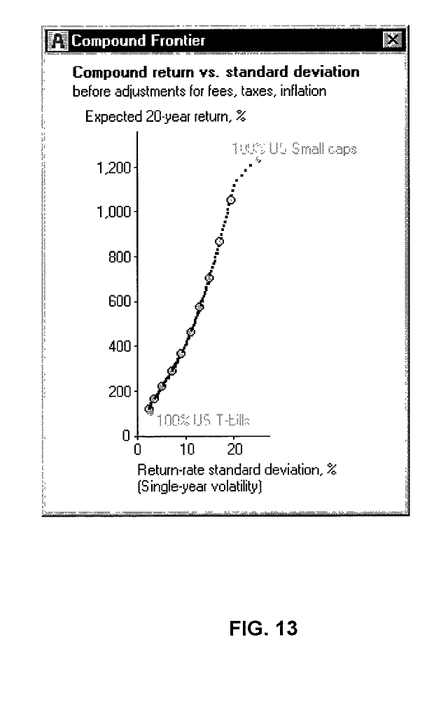

FIG. 10 illustrates a window that is accessible to the user from the LTO software's menubar and provides buttons that enable the user to select and display graphic analyses which the LTO software develops based on the user's entries and selections regarding investment categories, financial plans, and portfolio plans. This window has three tab-pages which the user can obtain by selecting the tabs 1001 and each tab-page has buttons for a different group of graphs. On the first tab-page 1002 illustrated in FIG. 10, the Graph 1 button 1003 enables the user to obtain an efficient frontier graph as previously discussed and illustrated in FIGS. 6 and 7. Other buttons on the first tab-page 1002 enable the user to obtain other graphs provided by the LTO software to help users and investors understand the reasons for and importance of (1.) considering portfolio plans comprising different portfolios in different time phases of the financial plan as the remaining time horizon shrinks and (2.) making portfolio comparison-and-selection in terms of prospects and risks for the time horizon dimension of the financial plan, instead of just comparing single-portfolio choices for just the individual year as shown on an efficient frontier graph. The Graph 2 button 1004, together with the option buttons 1005 just above it, enables the user to obtain the graphs illustrated in FIGS. 11 and 12 which will be discussed next, and Buttons 3a 1006, 3b 1007, and 3c 1008 enable the user to obtain the graphs illustrated in FIGS. 13, 14, and 15 which are discussed in subsequent paragraphs. For each of these graphs, the maximum number of years shown is the time horizon of the financial plan, which the user enters as illustrated and discussed later in this description.

With each of these graphs the LTO software displays a toolbox with buttons for user interaction with the graph as previously illustrated for the efficient frontier graph 701, including in each graph's toolbox an Explain button as previously illustrated 702 which enables the user to obtain a window containing text explaining the graph. For the graphs illustrated in FIGS. 11 through 15 as discussed below, intended for user and investor education, the text explanations are particularly important supplements to the graphs because of the user education purpose.

FIGS. 11 and 12 illustrate two graphs obtained using Graph 2 buttons 1004, 1005, each showing compound growth of total percent returns over various numbers of years out to a number of years entered for the time horizon of the investor's financial plan. FIG. 11 illustrates compound growth of return at various even-number individual-year return rates, and FIG. 12 illustrates compound growth of return at the expected individual-year return rate of each selected asset class. While compound growth is well known, these graphs illustrated in FIGS. 11 and 12 are developed and displayed to illustrate and explain one of two long-term effects that together make portfolios compare differently for longer investment time horizons than in individual-year return rates, making it essential to (1.) consider portfolio plans comprising different portfolios in different time phases of the financial plan and (2.) compare the portfolio plans for the time horizon of the investment plan rather than just individual-year rate of return. This long-term effect is that, for longer investment time horizons with larger numbers of investment years, higher individual-year rates of return produce disproportionately higher long-term returns. For example, over 20 years the total return from an individual-year return rate of 16% is over five times as high as that from an individual-year return rate of 8%, as can be seen in FIG. 11 showing return curves for 8% return rate 1101 and for 16% return rate 1102. When portfolios are compared in just individual-year rate of return, most of the advantages of higher expected return rates are not shown. To see the full longer-term advantages of higher expected return rates, an investor has to compare portfolio results for the total longer term.

FIG. 13 illustrates a compound frontier graph developed by the LTO software and accessed by the user through the Graph 3a button 1006. This compound frontier graph illustrated in FIG. 13 is identical to an efficient frontier graph in all respects except that the vertical axis compares the best-diversified portfolios in expected total percent return over the number of investment years entered for the time horizon of the financial plan instead of just expected percent return rate for the individual year. This graph provides an additional perspective on the powerful effect of long-term compounding and the importance of comparing portfolios for the full time horizons of long-term financial plans instead of just rate of return for the individual year. Specifically, it helps the investor to see the long-term penalty of choosing a portfolio further to left along the curve in order to reduce what known products featuring the prior art label as “risk” but is really return-rate standard deviation, a measure of short-term ups and downs in return rates of individual years. On an efficient frontier graph as standardly labeled and used in the current method of portfolio comparison-and-selection, as previously illustrated in FIG. 9, it appears that along most of the curve of the best-diversified portfolios, moving to left along the curve provides a relatively larger reduction in “risk” according to the labeling of the horizontal axis, with only a relatively smaller reduction in “return” according to the labeling of the vertical axis. But this is for only annual rate of return, for only the individual year. On the compound frontier graph shown in FIG. 13, the user can see that for a longer time horizon, in moving to left along the curve of best-diversified portfolios, what is reduced according to the horizontal axis is actually individual-year return-rate standard deviation, a measure of return-rate variation for just the individual year; and as shown by the vertical axis, the corresponding reduction in expected total long-term return is vastly larger than shown on an efficient frontier graph. The graph illustrated in FIG. 13 reveals that for longer time horizons, moving to a portfolio further to left along the curve is vastly less favorable than the prior art method illustrated in FIG. 9 makes the move appear.

The graph just described and illustrated in FIG. 13, when compared with the single-year efficient frontier graph previously illustrated in FIG. 6, provides one good visualization of the importance of the novel methods of portfolio plan definition and comparison for selection of the present invention. Together these two graphs show that portfolio comparison is powerfully changed by time horizon, suggesting the logic and advantage of considering portfolio plans comprising different portfolios for different time phases of a financial plan as the remaining time horizon shrinks as well as the importance of comparing the portfolio plans for the full time horizon of the financial plan.

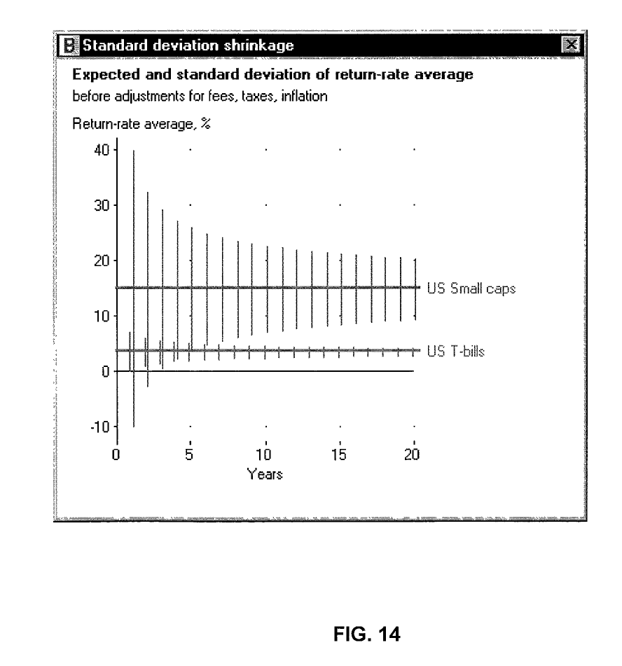

FIG. 14 illustrates the graph the user can obtain using the Graph 3b button 1007. This graph is developed and displayed by the LTO software to help the investor see and understand a second long-term effect that helps make portfolios compare differently for longer investment time horizons that in individual-year return rates, which effect the LTO software calls “standard deviation shrinkage”. For investments over longer time horizons of larger numbers of years, for the return-rate average the standard deviation shrinks. The graph shown in FIG. 14 illustrates this effect for each of two of the selected asset classes. For return-rate average for various numbers of investment years, for each asset class the horizontal line represents the expected return rate, and vertical ribs show the ranges from one standard deviation above the expected rate to one standard deviation below. It can be readily seen that for longer numbers of investment years, further to right on the graph, the standard deviation ribs are smaller. The reason this is true is that with more investment years, it is more likely that return rates will deviate high in some years and low in other years with partially offsetting effects, making the average return rate closer to the expected rate. For selecting portfolios for long-term financial plans with long-term goals, this long-term effect should be included in both defining and comparing portfolio plans, specifically considering portfolio plans comprising different portfolios in different time phases of the financial plan, instead of just single portfolios, and comparing the portfolio plans for the full time horizon of the financial plan instead of just the return rate for the individual year.

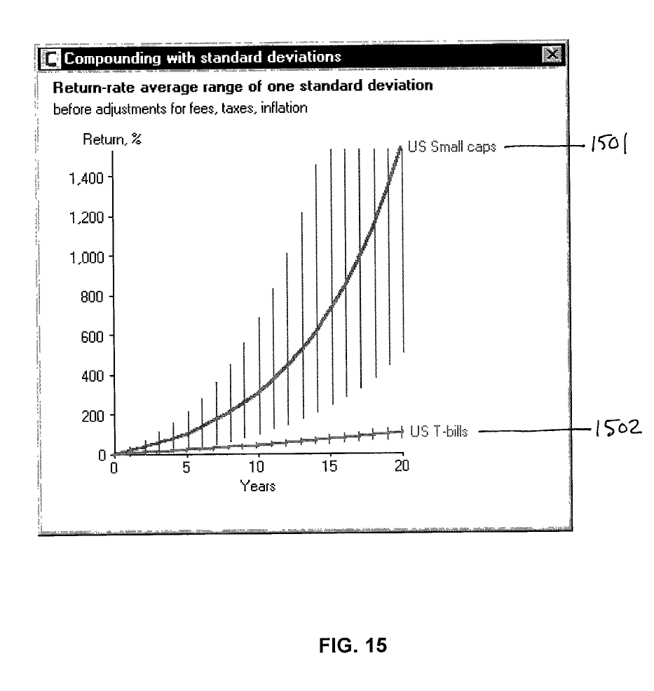

FIG. 15 illustrates the graph that the LTO software displays when the user selects the Graph 3c button 1008. The purpose of displaying and explaining this graph is to help investors see the powerful effects of compounding and standard deviation shrinkage together in making portfolios compare differently for longer investment time horizons; the advantage these effects create for longer investment time horizons; and because of these effects, the importance and advantage of portfolio selection based on considering portfolio plans comprising different portfolios in different time phases of the financial plan, instead of just single portfolios, and comparing the portfolio plans in prospects and risks for the long-term time horizon of the financial plan rather than just individual-year rate of return. This graph is identical to that shown in the preceding FIG. 14 except that instead of comparing the two asset classes in return-rate average over various time horizons, it compares them in compound total return over various time horizons. For various numbers of investment years, for each asset class the curve shows growth of total return at the expected return rate, and vertical ribs show how much higher or lower expected total return would be if the return-rate average were as much as one standard deviation above or below the expected return rate. On this graph the user can see that for longer investment time horizons of more years, the entire curve-and-ribs representation of the asset class with higher expected return rate 1501 grows so much higher than that of the other asset class 1502 that even the bottoms of its standard deviation ribs rise further and further above even the tops of the other asset class's ribs. The reason this is true is that, due to compounding and standard deviation shrinkage together, over longer time horizons the advantage of higher expected return rate increasingly outweighs the disadvantage of larger return-rate standard deviation. This produces a powerful advantage for the longer-term investor. Comparing portfolios along the curve of the best-diversified, for longer investment terms it makes portfolios with higher expected return rates and larger return-rate standard deviations become more and more favorable, not only in overall prospects but even in risk for the long-term result. For longer-term plans and goals, to see which portfolio plans are best and thus take full advantage of this powerful long-term investor's advantage, it is necessary to consider portfolio plans comprising different portfolios in different time phases of the financial plan, instead of just single portfolios, and to compare the portfolios in prospects and risks for the longer time horizon of the plans and goals instead of just rate of return for the individual year.

With respect to the graphs illustrated in FIGS. 11 through 15 developed and displayed by the LTO software and discussed in preceding paragraphs, it should be noted that they represent elements of one embodiment of the present invention provided for the purpose of helping users and investors to see, understand, appreciate the importance of, apply, and gain the benefits of the present invention's novel methods for defining and comparing portfolio plans for long-term plans and goals. Another embodiment of the present invention could approach this user and investor education purpose by developing and presenting different graphs, explanations, and illustrations, or might for this purpose rely on analyses and displays representing steps and results in the present invention's novel method and apparatus for developing and displaying such long-term assessments and comparisons, described and illustrated in text and figures that follow.

Attention is now turned to description and illustration of part 4 of the process shown in FIG. 2, namely obtaining of information pertaining to a financial plan, as performed by the LTO software in one embodiment of the present invention.

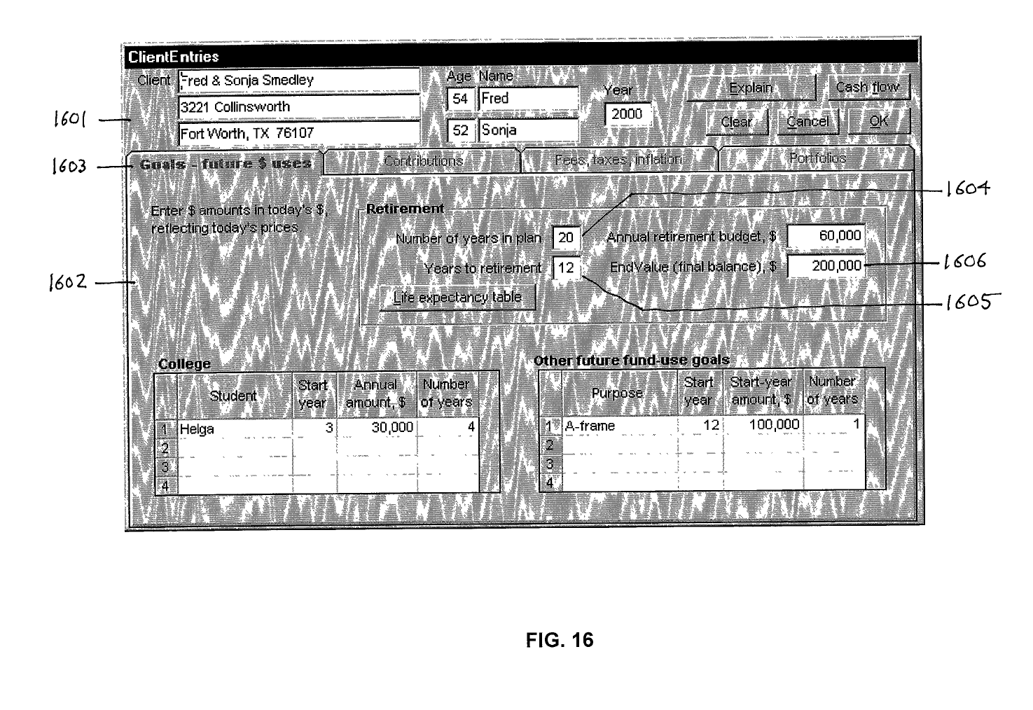

Referring to FIG. 16, the description of the novel long-term portfolio optimizer LTO software is continued. FIG. 16 shows a plan entry window that can be generated on a computer screen for user entry of data for an investor's financial plan. This window includes a top area 1601 with entry boxes for entry of data including identification of the investor and buttons for execution of actions desired by the user. Examples of user entries are shown in the entry boxes. In the lower area 1602 of the window, any one of four tab-pages may be displayed by user selection of tabs. In FIG. 16 the lower area 1602 of the window shows the first of these tab-pages accessed by user selection of the leftmost tab labeled “Goals” 1603. In this tab-page 1602, entry boxes are provided for user entry of the time horizon of the financial plan specified as “Number of years in plan” 1604, and number of “Years to retirement” 1605. Additional entry boxes and tables are provided in which the user can make entries to define desired future results of the plan in terms of values to be withdrawn by the user in various years, and a box 1606 is provided in which the user can enter an amount of final wealth desired to remain at the end of the time horizon of the financial plan labeled “EndValue” 1604.

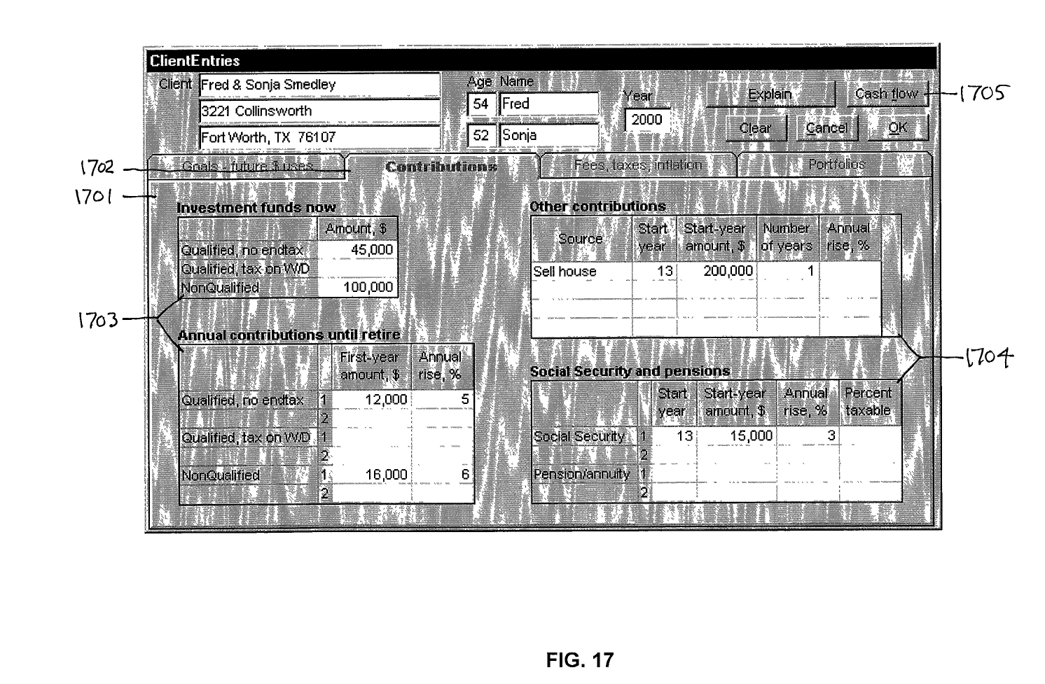

FIG. 17 illustrates the plan entry window with display of the second tab-page 1701 accessed by user selection of the second tab labeled “Contributions” 1702. This tab-page 1701 contains tables for users to enter years and amounts of value to be contributed to meet the goals entered as illustrated in FIG. 16. To the extent such contributions are not immediately needed to meet goals, they will be treated as investment amounts added to a portfolio plan in anticipation of investment returns providing additional value for meeting entered goals of later years and additional final wealth remaining at the end of the time horizon of the financial plan. The tables at left 1703 for entry of current contributions and annual contributions until retirement contain separate rows for separate entry of such contributions to be placed in separate portfolio plan components in differing classes of taxability. The tables at right 1704 provides rows for entering other contributions with columns for amounts, years, annual rise, and for Social Security and pensions the taxable percentages. FIG. 17 also illustrates a cash flow button 1705 for user display of a cash flow schedule, to which attention is now turned.

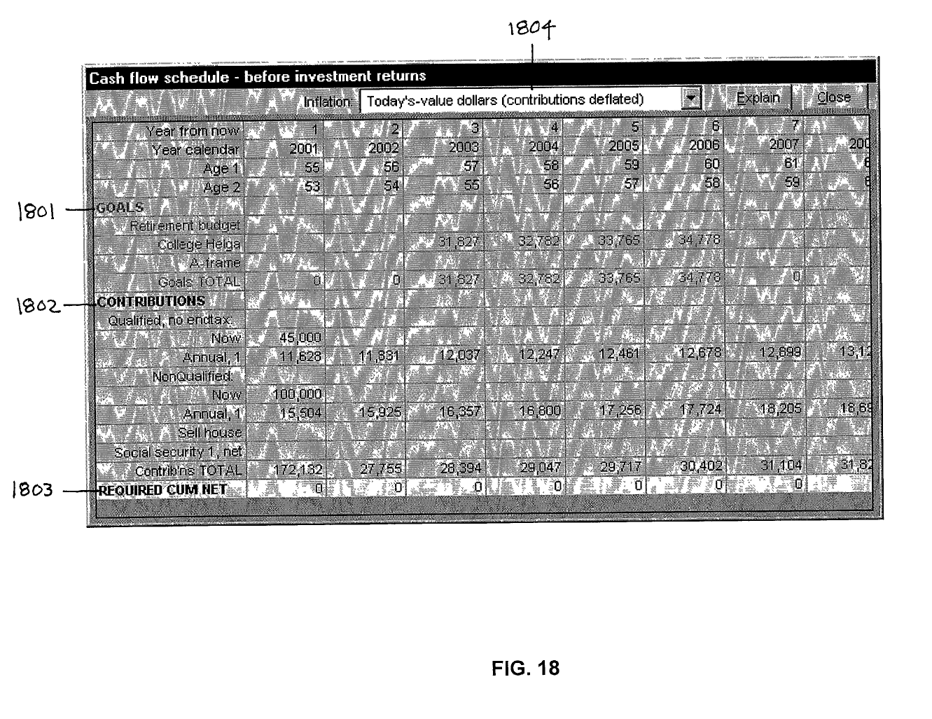

FIG. 18 illustrates a financial plan cash flow schedule window which the user can display using the cash flow button 1705. This window contains a display of a year-by-year schedule of amounts of goals 1801 and contributions 1802 electronically determined and calculated using user entries in the goals tab-page 1602 and the contributions tab-page 1701. In a row 1803 at the bottom of the cash flow schedule, for each year the net amount if any is shown by which cumulative goal amounts to that time exceed cumulative contribution amounts to that time and thus can be met only through previous net investment returns. In calculations to determine amounts for this row 1803, and in other analyses described later herein, for purposes of conservatism goal amounts for each year are assumed to be required and withdrawn at start of year, but contribution amounts for each year are assumed to be provided at end of year. At top center of the financial plan cash flow schedule window, a dropdown menu 1804 is provided enabling the user to select or toggle between two displays of the amounts shown in the schedule with respect to effects of inflation. One display of the amounts represents all amounts in terms of the value of a dollar at the time of user entry of the plan, while the other display represents all amounts in terms of physical dollars subject to declining value due to future inflation, based on inflation rates the user may enter or change as will be described and illustrated later herein. It should be noted that since future investment return rates are known to vary from year to year in ways that prevent advance knowledge of the investment returns for any individual future year, dollar amounts of such returns and associated deductions for fees and taxes cannot be known for any future year and are therefore not shown in the financial plan cash flow schedule table illustrated in FIG. 18. Instead these elements of the plan will be analyzed and presented in terms of probabilities, as will be described and illustrated later in this description of the present invention.

It should be recognized that the foregoing illustrations and descriptions of FIGS. 16, 17, and 18 represent one embodiment of the present invention's functions of determination and display of data for an investor's financial plan for period-by-period cash flows, and that the present invention could obtain or develop and display such data in other ways in other embodiments of the invention. Financial plan data could for example be determined, calculated, or displayed in terms of other time periods such as quarter-years or months; could be obtained and displayed in a more extensive or detailed manner, or in a simpler format to enable fastest entry; could be entered, calculated, and displayed in another software system such as spreadsheet software, which could include user entry of formulas for calculations; and could be obtained electronically from an electronic database or other computer or software or storage source. The embodiment of these functions illustrated in FIGS. 16, 17, and 18 is shown and described herein because this embodiment offers advantages including enabling rapid entry of plans by users without requirement of skills and time for entry of formulas such as those entered in spreadsheets. This embodiment defines the planned and desired cash flows in terms of values of critical dimension items of the financial plan in a manner that has additional advantages of focusing attention of users and investors on critical plan dimensions, and also facilitating computerized analysis and display of sensitivities of plan results to changes in these critical dimension items, as will be illustrated and described later in a description of part 9 of the process of the present invention shown in FIG. 2.

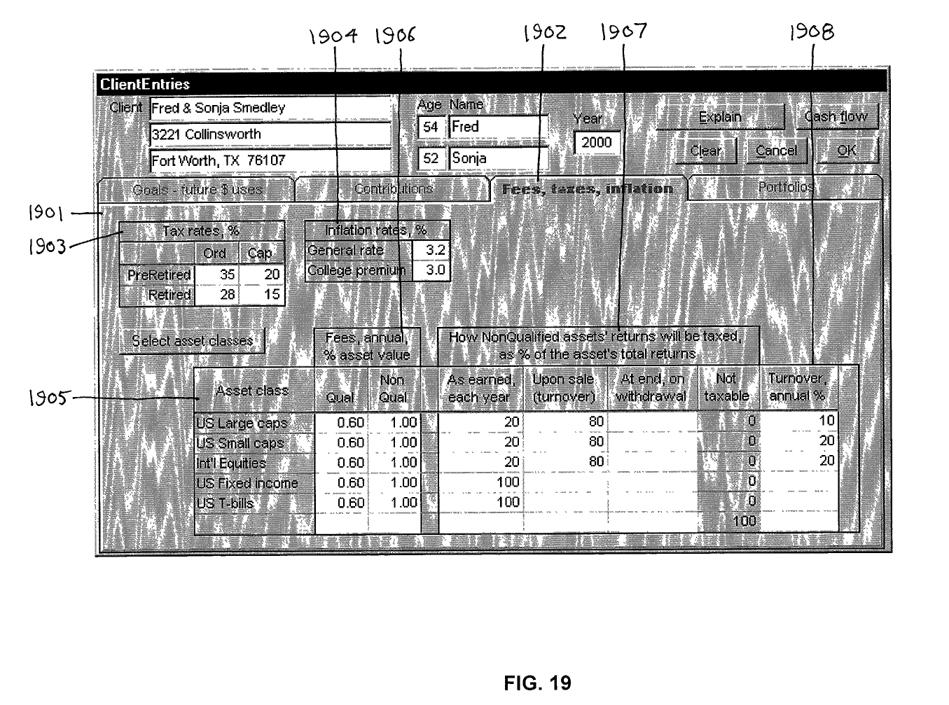

Returning attention to the plan entry window illustrated in FIGS. 16 and 17, FIG. 19 is an illustration of this window showing the third tab-page 1901 accessible by user selection of the third tab labeled “Fees-taxes-inflation” 1902. At upper left, small tables are provided for entry of tax rates 1903 and inflation rates 1904. A larger table 1905 provides rows with names of the asset classes or investment categories selected as illustrated in FIG. 3. For each asset class or investment category, columns are provided for entry of fees 1906, and additional columns 1907 are provided for entries defining how timings of taxes on investment returns are triggered, and for annual turnover rates 1908. It should be noted that in the present invention, methods for defining and obtaining data for determination of fees, taxes, and inflation could be quite different from those illustrated in FIG. 19, especially regarding taxes. For example, in another embodiment of the invention the development and analysis of tax data could be more intricate to reflect more of the intricacies in tax rules, or incorporate other income of the investor for use in determining tax rates on portfolio returns; or on the other hand simplified to facilitate usability for a wider population of investors and facilitate user focus on other aspects of portfolio plan comparison-and-selection.

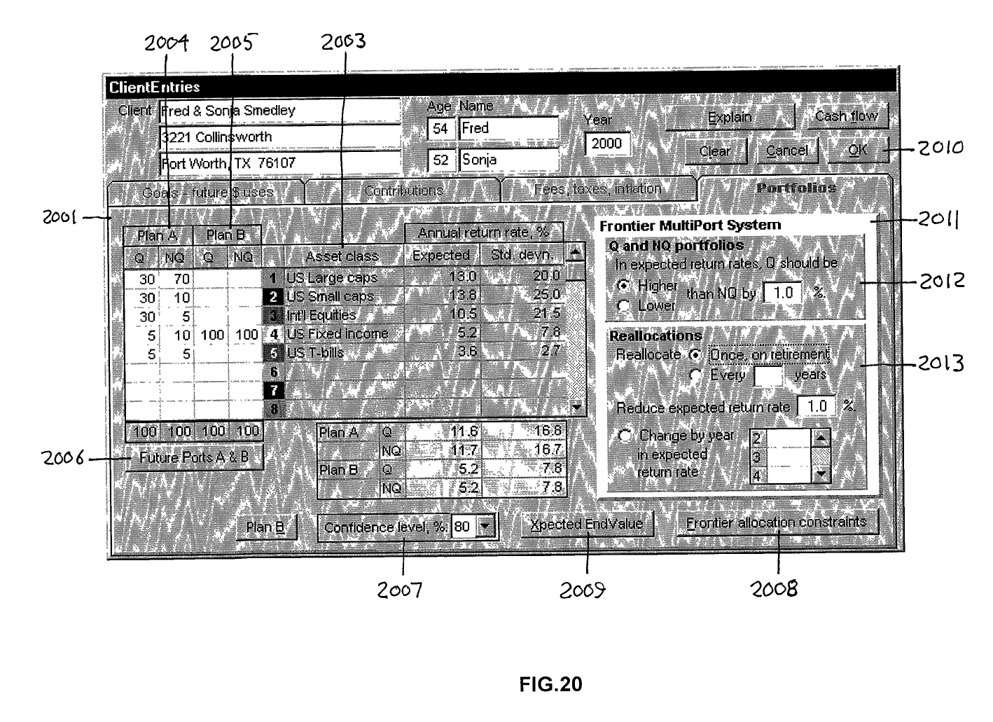

FIG. 20 illustrates a fourth tab-page 2001 of the same window obtained by user selection of the fourth tab labeled Portfolios 2002. This tab-page is intended for user entry or specification of certain allocation proportion characteristics of portfolio plans the user desires to assess for the financial plan. A table 2003 is provided with rows for the selected asset classes or investment categories, and columns for user entry of allocation proportions for an intended portfolio plan labeled Plan A 2004 and a second portfolio plan labeled Plan B 2005. It should be noted that while a particular portfolio has a specific set of allocation proportions, a particular portfolio plan specified by the user for Plan A 2004 or Plan B 2005 can have a plurality of portfolios simultaneously and sequentially. A method for specifying a plurality of portfolio plan components which can simultaneously contain different amounts invested for different purposes is illustrated by the provision of two allocation columns for portfolio Plan A 2004, enabling the user to specify two sets of allocation proportions for two portfolio plan components, in this case for investment amounts subject to differing tax rules. Similarly two columns are shown to enable specification of two portfolio plan components for Plan B 2005.

Just below the allocation entry columns 2004, 2005, which are for entry of immediate allocations for the first year of the financial plan, a “Future Ports A & B” button 2006 displays scrollable grids of similar columns for future years of the financial plan and rows for the asset classes like those for the columns 2004, 2005, in which the user may make entries for every future year in which the user desires Plan A or Plan B to be changed to another portfolio. In this way the user can specify each of these entered portfolio Plans A and B as having pluralities of portfolios with any desired allocation proportions for any future years of the entire time horizon of the financial plan as the remaining time horizon shrinks. However, the entry spaces for allocation proportions of portfolio Plans A and B also have another purpose, automatic receipt and display of allocations of best-diversified portfolio plans selected by the user from comparisons of a series of best-diversified portfolio plans on Goal Frontier graphs as will be discussed and illustrated further on in this description.

At bottom in the window and tab-page illustrated in FIG. 20 are tools enabling the user to determine additional specifications for the analyses to be performed, including a dropdown menu 2007 for user selection of a confidence or probability percentage the user wants to apply and a Frontier constraints button 2008 which enables the user to obtain a constraints window previously discussed and illustrated in FIG. 4. An Xpected button 2009 enables the user to obtain a display showing the expected portfolio final wealth at the end of the time horizon of the financial plan for each user-entered portfolio plan, Plan A and Plan B. These result measures, and all measures of future dollar results in all graphic analyses to be produced, are shown net of fees and taxes that have come due, and net of inflation so the amounts shown represent future value in terms of today's costs and prices familiar to investors. To indicate that future results are measured in these terms rather than physical future dollars that are likely to be reduced by payment for fees and taxes and have less value due to inflation, future dollar result measures are labeled as “P$” meaning net present-purchasing-power dollars.

An OK button 2010 at the plan entry window's upper right enables the user to indicate completion of plan entries, close this window, and proceed toward the LTO software analyses and preparation of graphs.

It must be recognized that in the present invention the data and choices accessed and obtained pertaining to the investment categories, the financial plan, and portfolio Plans A and B could be provided or obtained in forms and methods quite different from the LTO software embodiment described and illustrated in the preceding paragraphs and referenced figures, such as from electronically stored data, spreadsheet software, or entry displays, boxes, and tables and selection devices different in appearance or in how they define the data to be used in the analyses and graph preparations.

With description and illustrations having been provided for part 4 of the process of the invention shown in FIG. 2, obtaining of information pertaining to a financial plan, and also user specification of one or two particular portfolio plans to be assessed, attention is now turned to part 5 of the process, namely development of a probability distribution for portfolio final wealth at the end of the time horizon of the financial plan with a particular portfolio plan or with each of two portfolio plans for comparison.

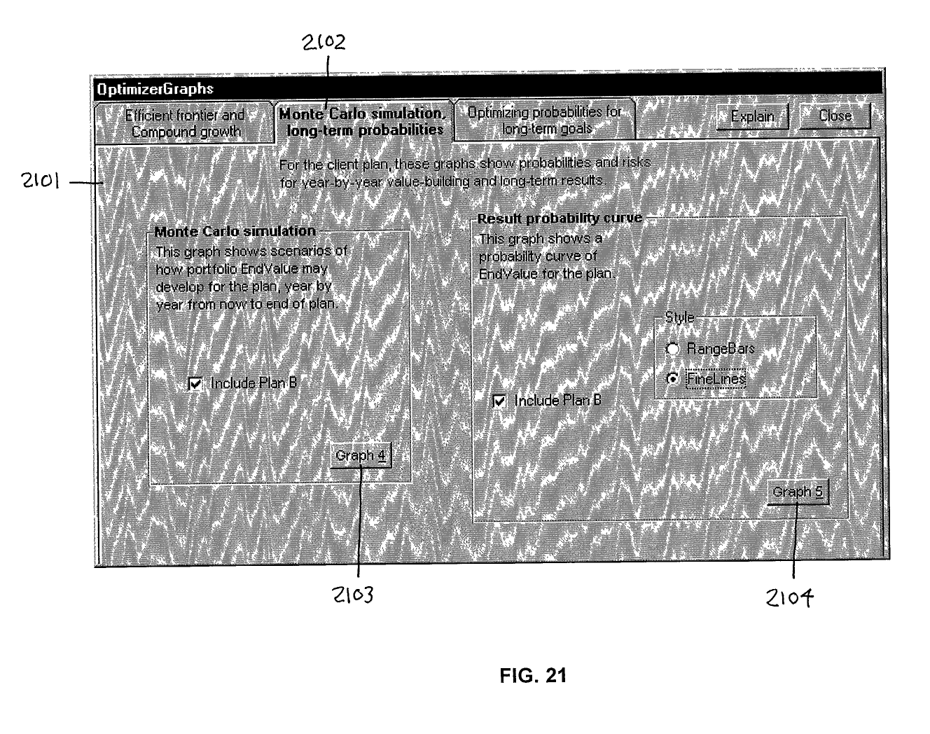

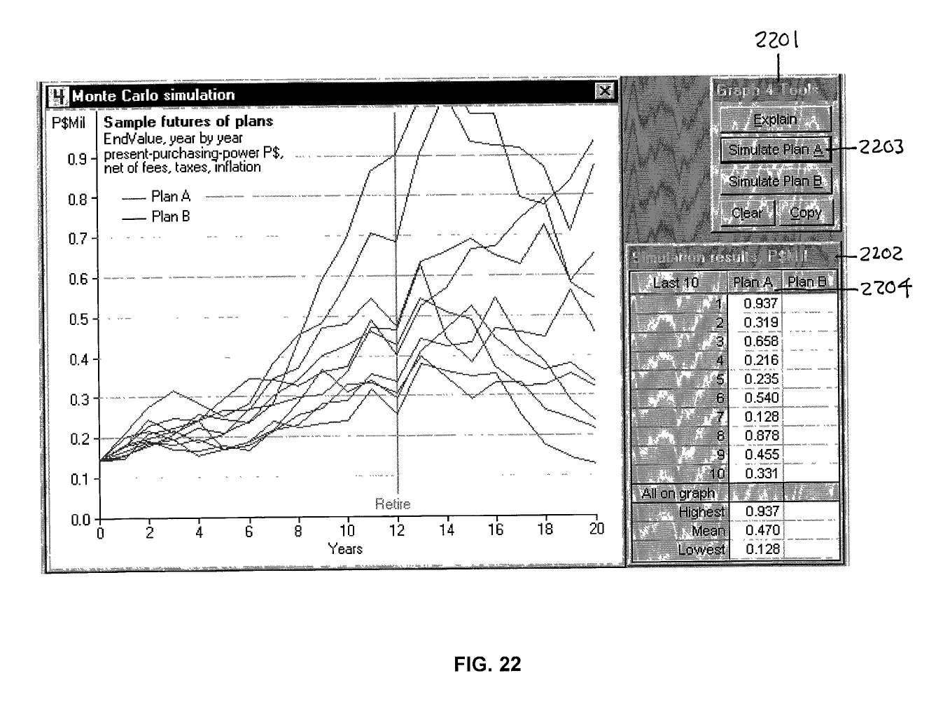

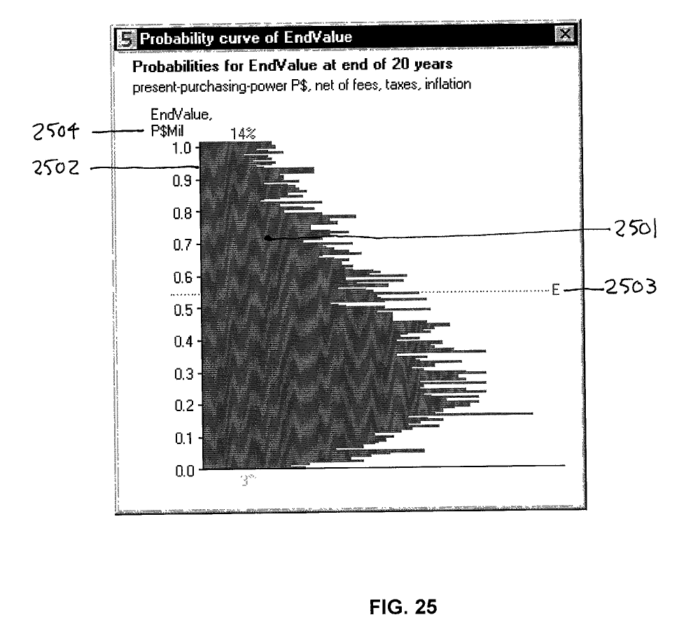

FIG. 21 illustrates the same window for obtaining graphs previously illustrated in FIG. 10, but in FIG. 21 this window's second tab-page 2101 is shown which the user can obtain by selection of the second tab 2102. The buttons on this tab-page enable the user to display graphs that illustrate probabilistic analyses of long-term dollar results for an investor's financial plan with a particular portfolio plan, or with each of two portfolio plans for comparison. The Graph 4 button 2103 enables the user to obtain graphs showing individual Monte Carlo simulations year by year through the years of a financial plan with a particular portfolio plan, and will be discussed immediately below and illustrated in FIGS. 22 through 24. The Graph 5 button 2104 enables the user to obtain graphs showing probability distributions for final wealth for a financial plan with a particular portfolio plan as will be discussed and illustrated in FIGS. 25 through 28. On each of these graphs, the user can obtain simultaneous displays for each of two portfolio plans for comparison.

FIG. 22 illustrates a graph obtained by user selection of the Graph 4 button 2103, together with the toolbox 2201 which is displayed with this graph at upper right and a results table 2202 displayed with this graph at lower right. The ten irregular lines across the graph illustrate ten year-by-year simulations of the entered financial plan with the entered portfolio Plan A, each simulation depicted as a year-by-year progression of portfolio value. When the graph is first displayed these simulations are not shown. When the user selects the Simulate Plan A button 2203, the first simulation line progresses across the graph year by year, after which additional simulation lines progress across the graph in the same way, one simulation at a time. As each simulation reaches final wealth at the end of the time horizon of the financial plan, its final wealth appears in the Plan A column 2204 of the results table 2202.

To develop these simulations the LTO software applies established methods of Monte Carlo simulation, using portfolio return-rate probability distributions developed using previously described and illustrated data on the Plan A asset class allocations 2004 and allocations for future different Plan A portfolios entered in a grid obtained using the previously described button 2006, together with the relevant asset classes' return-rate data as previously illustrated in FIG. 3. Progressing year by year to the time horizon of the financial plan 1604, for each year the preceding year's ending portfolio value is reduced by any amount required to be withdrawn to meet entered goals 1602 for that year as provided in the financial plan, then changed to reflect change in value from a return rate randomly selected from the appropriate portfolio's return-rate probability distribution, then increased by any amount required to meet contributions or investment amounts 1701 for that year as provided in the financial plan. As these calculations are made, additional calculations are made as appropriate to reflect entries for fees, taxes, and inflation 1901 so that portfolio values for ends of all years are calculated and shown in line with the previously described label of P$, representing value net of all fees and taxes that have come due and adjusted for inflation to express the value in today's-value dollars familiar to the investor. In the embodiment of the invention illustrated, for individual-year return rate probability distributions the shape assumed is the normal distribution. In another embodiment of the invention, lognormal or other distribution shapes could be assumed or used.

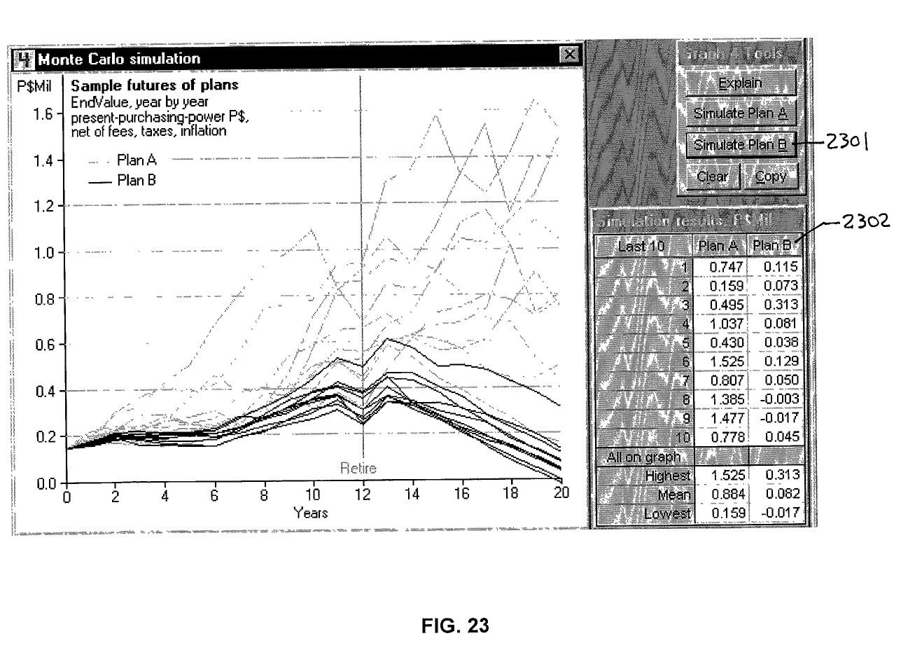

FIG. 23 illustrates the same graph shown in FIG. 22 with a second set of ten simulations obtained by user selection of the Simulate Plan B button 2301, representing the same financial plan with portfolio Plan B entered by the user as previously illustrated in FIG. 20. FIG. 23 also illustrates display of final wealths of these simulations in the results table's Plan B column 2302.

This graph produced by the LTO software with simulations reflecting two portfolio plans, as illustrated in FIG. 23, is especially valuable in investor education, particularly in illustrating the importance to long-term investors of advancing the method of portfolio comparison-and-selection from that of the prior art to that of the present invention. The general differences between the simulations of Plan A and those of Plan B illustrate a most-important aspect of how the best-diversified portfolios along an efficient frontier curve compare for longer time horizons, namely that portfolios with probabilities for smaller year-to-year variations also have probabilities of lower long-term results, as illustrated by Plan B compared to Plan A in FIG. 23. Or stated the other way, for better probabilities of higher long-term results, the investor has to accept greater probabilities of larger year-to-year variations along the way, as illustrated by Plan A compared to Plan B. The method of the prior art, in which the best-diversified portfolios are compared only in rate of return for the individual year, fails to reveal how the portfolios compare in long-term prospects. Instead it guides the investor to select a portfolio based on a comparison that emphasizes limitation of year-to-year variations, by making it appear that the year-to-year variation measure of return-rate standard deviation represents the biggest difference among the portfolios, further amplifying investor focus on this measure of year-to-year variations by labeling it with the powerful fear-word “risk”, and advising the investor to base the portfolio selection on a limit of probable year-to-year variations using the criterion called “risk tolerance”. From this graph illustrated in FIG. 23, one can readily see that for long-term plans and goals, the focus should be changed from limiting year-to-year variations to pursuit of higher long-term results, exactly what the present invention enables the user to do.

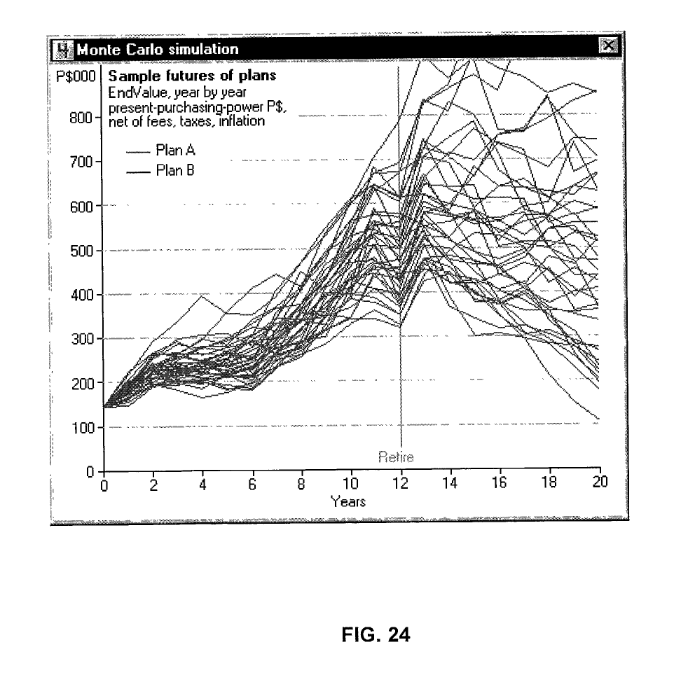

FIG. 24 is another illustration of the same Monte Carlo simulations graph, without simulations for portfolio Plan B but with several additional sets of ten year-to-year simulations for the financial plan with portfolio Plan A. The LTO software enables the user to add more simulations on the graph as many times as desired, by repeated selection of the Simulate Plan A button 2203. In this way the LTO software enables users and investors to obtain a particularly vivid illustration of how Monte Carlo simulations can be used to develop a probability distribution of portfolio final wealth for the financial plan with a portfolio plan. As more and more simulations are displayed, the viewer obtains a better and better sense of relative frequency of final wealth results in various height ranges, representing relative likelihoods for what the actual long-term result may be. With more simulations added, this graph can help users and investors build best understanding of a probability distribution for the long-term final wealth for the financial plan with a particular portfolio, which can be developed by producing a very large number of simulations.

FIG. 25 illustrates a graph which the user can obtain using the Graph 5 button 2104, showing a probability distribution 2501 of the portfolio final wealth for the investor's financial plan with portfolio Plan A. The LTO software develops this graph by producing 10,000 year-by-year simulations as previously described and keeping track of how many of the 10,000 final wealth results fall within various small final wealth ranges for display on the graph. The vertical axis 2502 represents portfolio final wealth at the end of the time horizon of the financial plan. Where the curve is wider, more simulation results occurred, and according to the simulations, actual results for the plan are more likely. The horizontal dotted line across the graph with “E” at its right end 2503 represents the expected final wealth of the portfolio plan. As on the previously illustrated graphs showing individual simulations, results are calculated and shown net of all fees and taxes that have come due and adjusted for inflation as indicated by the P$ label 2504.

With respect to development of a final wealth probability distribution for a financial plan with a particular portfolio plan as illustrated in FIG. 25, it should be noted that Monte Carlo simulation is not the only method that could be applied in the present invention. For example, in another embodiment of the present invention, a method of historical simulation could be applied, wherein for each time period of the plan, for all investment categories actual return rates of a randomly selected historical period is used; or wherein each simulation reflects a series of return rates for a different series of historical years equal in number to the years in the investor's time horizon. With such methods the number of different simulations would be limited by numbers of historical periods for which investment categories' return rates are available, but a frequency or probability distribution for the final wealth of the financial plan with the portfolio plan could be obtained.

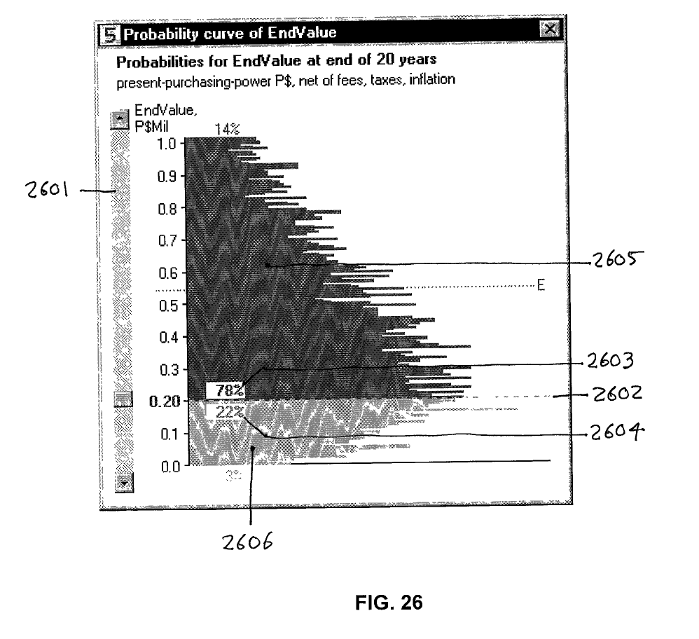

Returning to further discussion of the probability distribution developed by the LTO software using Monte Carlo simulation and illustrated in FIG. 25, FIG. 26 provides another illustration of the same graph, together with additional items shown for user interaction to obtain fullest understanding of and benefits from the graph. The user can obtain a scrollbar 2601 with which the user can move to various target heights for the final wealth. At whatever target final wealth height the user moves to, the LTO software displays a horizontal goal line 2602 across the graph; and shows numerically as well as graphically above the goal line the percentage 2603 of the probability distribution or curve area above the goal line representing probability of meeting-or-beating the target final wealth moved to, in this case 78%, and below the goal line the percentage 2604 of the distribution below the goal line representing the probability or risk of a result below the target final wealth, in this case 22%. These distribution or curve-area percentages representing probabilities of meeting-or-beating versus falling short of the target final wealth are also shown graphically by showing the areas of the curve above 2605 and below 2606 the goal line in different colors or shadings. For a long-term financial plan with a particular portfolio plan, this kind of probability-distribution graph provides a fullest and most valuable assessment of the long-term prospects and risks with concise visual clarity; and by interactive scrolling to various target final wealths users and investors can develop rich understanding of what the graph shows as well as probability assessments of prospects and risks relative to particular targets for the final wealth.

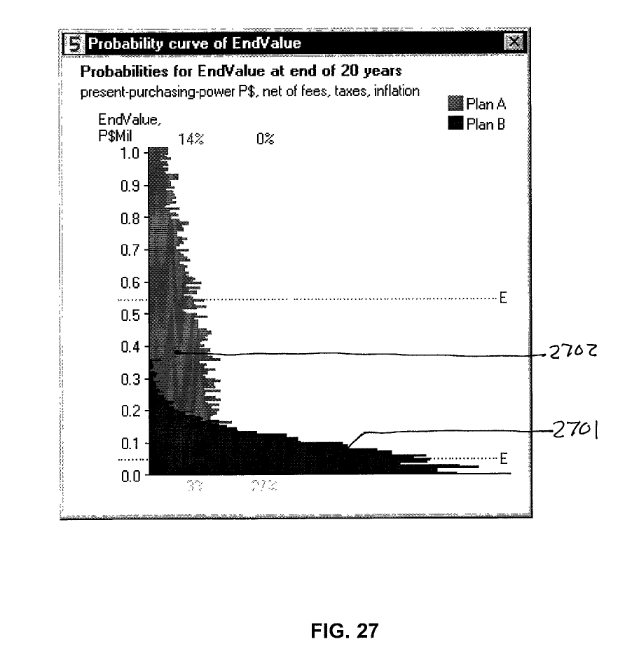

FIG. 27 provides another illustration of the same final wealth probability distribution graph with a second probability distribution added for the final wealth for the financial plan with portfolio Plan B 2701, for comparison with the final wealth probability distribution with portfolio Plan A 2702. From this graph it is readily apparent that while portfolio Plan B offers more likelihood that the final wealth will be within a much narrower range as measured by the vertical axis, the greater certainty as to approximately what the final wealth will be amounts to near-certainty that with portfolio Plan B, the final will be much lower than it is likely to be with portfolio Plan A.

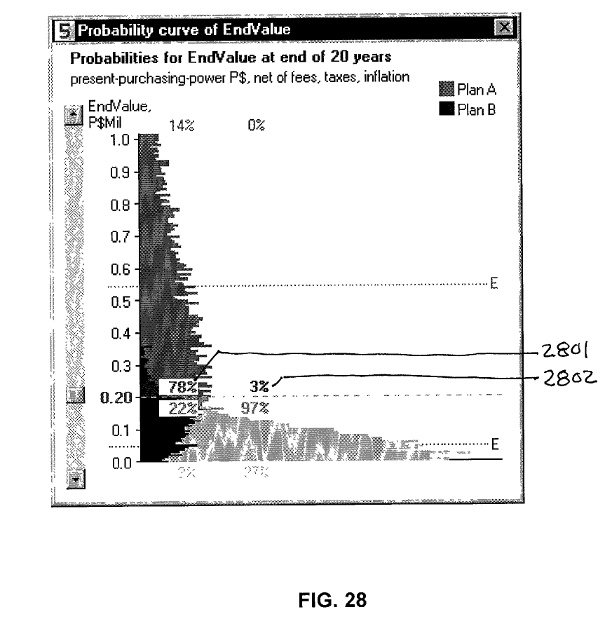

FIG. 28 illustrates the same graph shown in FIG. 27 with additional illustration of interactive user scrolling on the graph. This illustration shows that the LTO software enables the user to obtain and use the scrollbar on the graph with probability distributions for final wealth for the financial plan with each of the two portfolio plans A and B; and at whatever target final wealth height the user moves to, the LTO software displays the goal line and shows above the goal line the probabilities of meeting-or-beating the target final wealth height for each of the portfolio plans 2801, 2802, and below the goal line the probabilities or risks of falling short for each portfolio plan. In the illustration the user has again scrolled to the target final wealth height of 0.2 million dollars, or P$ 200,000, and the LTO software shows that while portfolio Plan A offers 78% probability 2801 of meeting-or-beating this target final wealth, portfolio Plan B offers only 3% probability 2802 of doing so and 97% probability or risk of failing to meet this target.

Descriptions and illustrations have now been provided for parts 1 through 5 of the process shown in FIG. 2, as provided by the LTO software in one embodiment of the present invention. These previously described and illustrated parts of the process provide analyses which are combined and used in a novel integration in parts 6, 7, and 8 of the process to produce and display comparisons of best-diversified portfolio plans compared in several probabilistic measures of prospects and risks for portfolio final wealth for a long-term financial plan. Reviewing, parts 1 and 2 provide an efficient frontier graph identifying a range of best-diversified portfolios or portfolio points defined in probabiliatic measures of rate of return for the individual year. Part 3 provides user education and illustration on the powerful effects of time horizon on how portfolios compare, and the resulting importance and advantages of the present invention's advancing of portfolio selection to incorporate the time-horizon dimension, specifically (1.) considering multi-portfolio plans comprising different portfolios in different time phases of the financial plan and (2.) assessing and comparing portfolio plans for the financial plan over its full time horizon. Part 4 provides information on a financial plan including time horizon, cash flow schedule of investment and withdrawal amounts, and data on fees, taxes, and inflation, and information concerning the allocation proportions of portfolios in one or two user-specified portfolio plans for consideration for the financial plan. Part 5 applies Monte Carlo simulation or other methods to develop a portfolio final wealth probability distribution for a financial plan with a particular user-specified portfolio plan or with each of two such portfolio plans for comparison, each of these user-specified portfolio plans comprising pluralities of portfolios as specified by the user. Parts 6, 7, and 8, which will be described next, combine and use data, analyses, and methods from these preceding parts of the process in a novel way to develop and display the desired comparisons of a series of best-diversified portfolio plans with respect to probabilistic measures of prospects and risks for the final wealth at the end of the full time horizon of the entered financial plan using novel Goal Frontier graphs.

Attention is now directed to part 6 of the present invention process illustrated in FIG. 2. In this part of the process, a series of best-diversified portfolio plans comprising pluralities of best-diversified portfolios is defined, for assessments and comparisons for the full time horizon of the entered financial plan. The most fundamental purpose in defining multi-portfolio plans is to provide the advantage changing to different portfolios as the remaining time horizon shrinks, as previously discussed. Other advantages include consistency with advice of seasoned financial advisors and common investor preferences. Additional advantages are obtained considering pluralities of “component portfolio plans” in a portfolio plan with different portfolios for separate investment accounts subject to different rules of taxation, to take fuller advantage of differences between such accounts in taxation and also in lengths of time amounts may be invested.

To define a series of best-diversified portfolio plans comprising pluralities of best-diversified portfolios, information from two sources is used. One is information on the range of best-diversified portfolios developed using concepts of Modern Portfolio Theory as illustrated in the efficient frontier graph shown in FIG. 6. The other is information specifying desired characteristics of portfolio plans in the series with respect to pluralities of portfolios, which will be described next.

In one embodiment of the invention, information on desired characteristics of the series of portfolio plans with respect to pluralities of portfolios is obtained as illustrated in the previously referenced FIG. 20, specifically in the box 2011 at right in that illustration. As previously discussed and illustrated with reference to FIG. 17, the user may enter or specify separate contributions or investment amounts subject to different rules of taxation. In another embodiment, investment amounts can be separated for another purpose. In the general case it will be advantageous to keep such separately specified investments in separate “component portfolio plans” comprising different portfolios to take advantage of differences in taxabilities and lengths of time amounts may be invested. In the box 2011, the upper inner box 2012 provides the user a method for specifying a desired difference between portfolios of separate component portfolio plans for separate invested amounts. In this box 2012, the qualified and nonqualified portfolios in a portfolio plan are labeled respectively Q and NQ. The difference between these portfolios in a portfolio plan in the series is defined by difference between the two portfolios in expected return rate, which will be explained after the two paragraphs immediately below.

For the portfolio plans in the series, or their component portfolio plans as specified by the user in the upper box 2012, a lower second box 2013 provides selection buttons and entry boxes for the user to provide specifications for a system of different portfolios to be held during different time phases of the financial plan. In this box 2013, the user may specify one portfolio change upon retirement or a series of portfolio changes at intervals of a specified number of years throughout the time horizon of the plan, and for either approach specify the portfolio change in terms of expected return rate. Or the user may specify in a grid portfolio changes of various dimensions in any desired years and specify each years change in terms of expected return rate.

The multi-portfolio system defined by the user in the illustrated box 2011 is applied to define a series of best-diversified portfolio plans each comprising a plurality of portfolios but only best-diversified portfolios, for assessment and comparisons for the full time horizon of the long-term plan. With every included portfolio being a best-diversified portfolio, every portfolio included in each of these portfolio plans can be identified by its expected return rate, using previously described analyses carried out to produce an efficient frontier graph as illustrated in FIG. 6 together with user specifications as illustrated for one embodiment of the invention in the box 2011. If for example in the upper box 2012 the user has selected “Higher” and entered “1.0” as illustrated 2012, then in any investment period in which the NonQualified portfolio has an expected rate of 8%, the Qualified portfolio has an expected rate of 9%, and both portfolios can be identified by reference to the analyses previously performed to develop an efficient frontier graph. Similarly, if in the lower box 2013 the user has indicated that over time there shall be one portfolio change upon retirement and for the expected return rate reduction of the change the user has entered “1.0” as illustrated, then in the same portfolio plan, upon retirement the nonqualified portfolio would have an expected return rate of 7% and the qualified 8%, both again defined by points of those heights on the curve of the efficient frontier graph. All specified increments of expected return rates are applied to the extent permitted by, and also constrained by, the expected return rate range of the efficient frontier curve. In this manner the user can specify definitions for a series of multi-portfolio best-diversified portfolio plans for analyses and comparisons with respect to probabilistic prospects and risks for final wealth reflecting performance over the entire time horizon, which analyses and comparisons will be described and illustrated in later sections of this description. Portfolio plans in the series will have different initial first-year nonqualified portfolios, and for each portfolio plan in the series, that portfolio together with the user entries in the box 2011 and the efficient frontier curve define all other portfolios in that portfolio plan.

For a portfolio plan with a plurality of component portfolio plans, as for example specified in the box 2012, correlations between return rates of component portfolio plans held in the same investment period are reflected in the simulations developed and displayed by the invention. For each year, the return rate of the first component portfolio plan is determined at random from the appropriate probability distribution, and then the return rate probability distribution for the second component portfolio plan is adjusted accordingly. The second component portfolio plan's expected return rate is adjusted by adding this product: the extent to which the first component portfolio plan's return rate exceeds its expected return rate, multiplied by the ratio of the two component portfolio plans' covariance to the first component portfolio plan's variance. The second component portfolio plan's variance is adjusted by subtracting the ratio of the covariance squared to the first component portfolio plans' variance.

It should be emphasized that while another embodiment of the present invention could provide a system for defining a series of best-diversified portfolio plans different from that illustrated 2011, the capability to define a series of best-diversified portfolio plans comprising pluralities of best-diversified portfolios, for the assessments and comparisons to be produced and displayed for investor selection, is essential for the purpose and benefit of the present invention. At the very heart of the present invention's uniqueness and benefit is the advance from the single-portfolio single-year comparison and selection system of the prior art to a system that defines, assesses, and compares portfolio plans for long-term financial plans considering their time-horizon dimensions. For this advance it is essential to define a series of best-diversified portfolio plans comprising different portfolios in different phases of the time horizon as the remaining time horizon shrinks, as well as to assess and compare the portfolio plans for the full financial plan over its full time horizon.

As previously stated, consideration of multi-portfolio plans also has advantages in obtaining fuller benefit from plans with separate invested amounts subject to different tax rules and in defining portfolio plans that more realistically reflect common investor preferences.

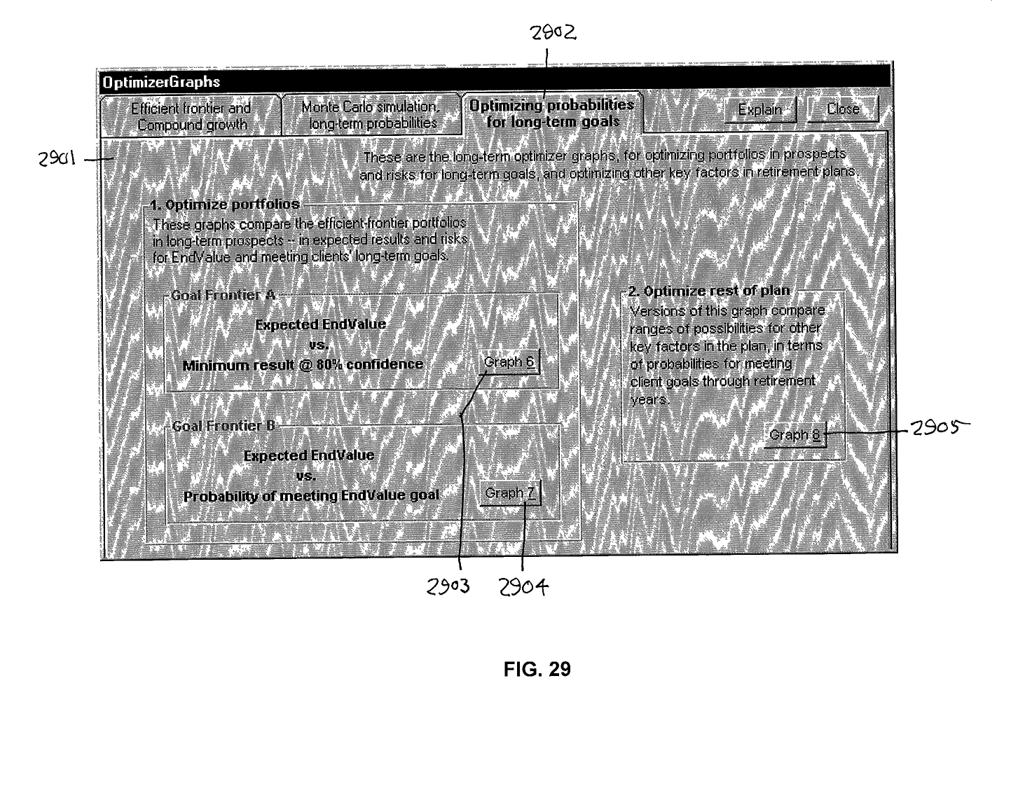

Turning now to description and illustration of parts 7 and 8 of the process as performed by the LTO software in one embodiment of the present invention, FIG. 29 illustrates the same window for graph selection previously illustrated in FIGS. 10 and 21, with the third tab-page 2901 illustrated which the user can obtain by selecting the third tab 2902. The Graph 6 button 2903 and the Graph 7 button 2904 enable the user to obtain two types of Goal Frontier graphs labeled respectively Goal Frontier A and Goal Frontier B. The Graph 8 button 2905 enables the user to obtain another type of graph to be discussed and illustrated at a later point, for display and interactive use after portfolio plan comparison and selection, for sensitivity analyses to optimize other elements of the financial plan.

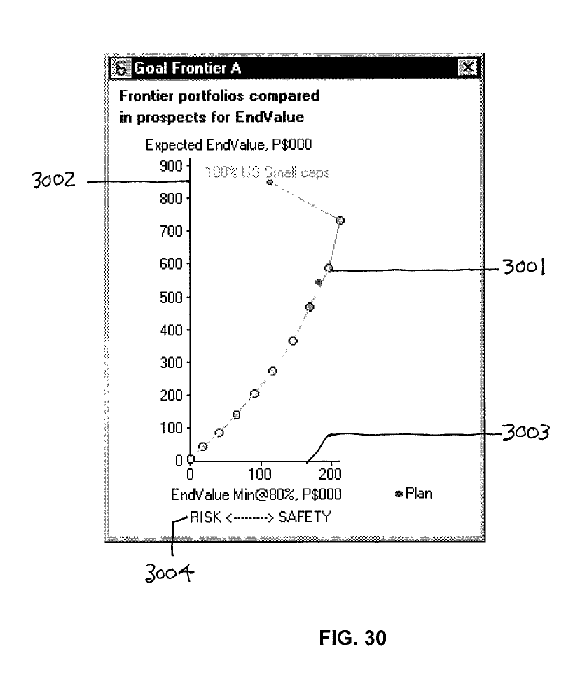

FIG. 30 illustrates one type of Goal Frontier graph developed and displayed by the LTO software in one embodiment of the present invention. The points along the curve, such as the point marked 3001, represent a series of best-diversified portfolio plans, comprising pluralities of best-diversified portfolios which would individually appear along the curve on an efficient frontier curve, which the LTO software has identified and for which it has determined return-rate probability measures using concepts and methods of Modern Portfolio Theory together with information on desired pluralities of portfolios in the portfolio plans as previously described and illustrated. On this graph the best-diversified portfolio plan points are assessed and compared in probabilistic measures of prospects and risk for final wealth for the investor's financial plan at the end of the full time horizon of the financial plan, after meeting all goals as well as conforming to other features of the financial plan. The vertical axis 3002 shows assessment and comparison of the portfolio plan points in expected value of the final wealth at the end of the time horizon of the financial plan, as a best single measure of overall probabilistic prospects for the final wealth. The horizontal axis 3003 shows assessment and comparison of the portfolio plan points in terms of how large a minimum or “Min” final wealth each portfolio plan point has a specific high confidence level or probability (in this case 80%) of meeting-or-beating. The confidence level at which the portfolio plans are assessed and compared relative to the horizontal axis is determined by the user, as previously discussed and illustrated 2007. This axis can be seen as a measure of risk for the final wealth for a portfolio plan: a larger Min value, to right on this graph, represents greater safety, and a smaller Min to left on this graph represents greater risk of a smaller final wealth, as represented symbolically below the horizontal axis 3004.

To determine the values of each portfolio plan point relative to the axes for positioning on this graph, the novel LTO software develops a final wealth probability distribution for the financial plan with that portfolio plan, applying Monte Carlo simulation using information defining the financial plan together with return-rate probability distribution dimensions for the portfolios in the portfolio plan previously determined using Modern Portfolio Theory. If the portfolio plans in the series comprise pluralities of component portfolio plans with separate portfolios having returns in the same years, correlations between the return rates of the simultaneously held portfolios are applied in developing the simulations and resulting final wealth distributions used to determine portfolio plan measures represented on the graph, as previously described. From these final wealth probability distributions for the various portfolio plans, the LTO software determines the values for positioning each portfolio plan point on the graph. In the Monte Carlo simulation for each portfolio, the LTO software has also used financial plan data for fees, taxes, and inflation to determine and express the final wealth amounts in the probability distribution and used for positioning on the graph to reflect portfolio value net of all fees and taxes that have become due and adjusted for inflation to reflect the final wealths values in today's value dollars familiar to the user and investor, as represented by the previously described P$ label.

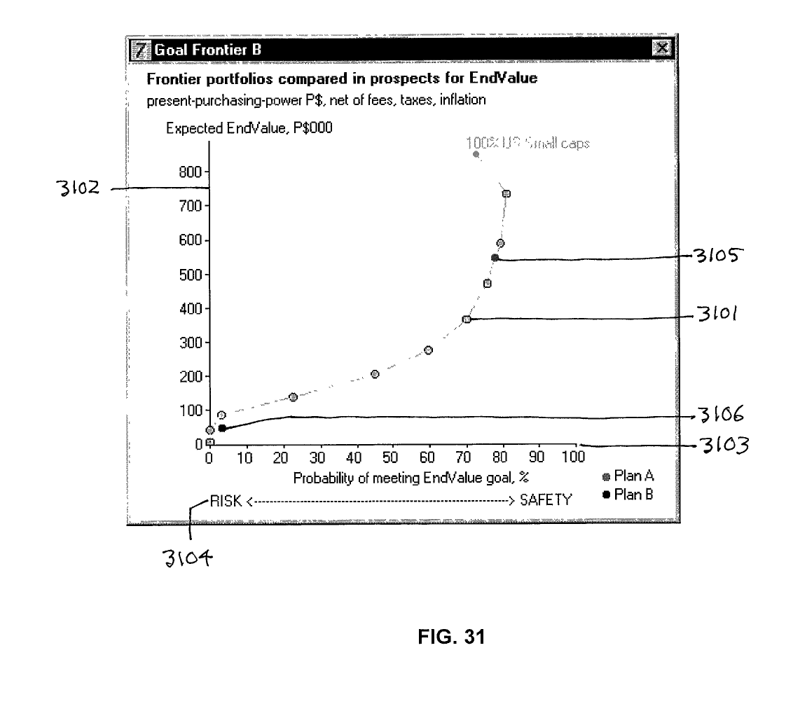

FIG. 31 illustrates another Goal Frontier graph developed and displayed by the LTO software. In most respects this graph is identical to the graph illustrated in FIG. 30. On this FIG. 31 graph too, the points along the curve, as typified by the point marked 3101, represent a series of best-diversified portfolio plans, comprising pluralities of best-diversified portfolios that would individually appear along an efficient frontier curve, and the vertical axis 3102 shows assessment and comparison of these portfolio plan points in expected value of the final wealth. However, in the graph shown in FIG. 31 the horizontal axis 3103 is different from that in the graph in FIG. 30, assessing and comparing the portfolio plan points in probability of meeting-or-beating the investor's final wealth goal previously entered in the plan entry window 1606. This axis can also be seen as a measure of safety versus risk. A greater probability of meeting-or-beating the final wealth goal, further to right, represents greater safety, while a smaller probability further to left on the graph represents greater risk of failure to meet the final wealth goal, as shown symbolically below the horizontal axis 3104. On this graph an additional point is displayed for each portfolio plan entered or designated by the user as previously described and illustrated 2004, 2005, 2006, as illustrated in FIG. 31 for portfolio Plan A 3105 and portfolio Plan B 3106. To develop the information required for this graph, the LTO software carries out the same previously described series of analytical steps as carried out to develop the graph shown in FIG. 30, using final wealth probability distributions for the financial plan with each portfolio plan to obtain the values for positioning of the portfolio plan points relative to the graph axes.

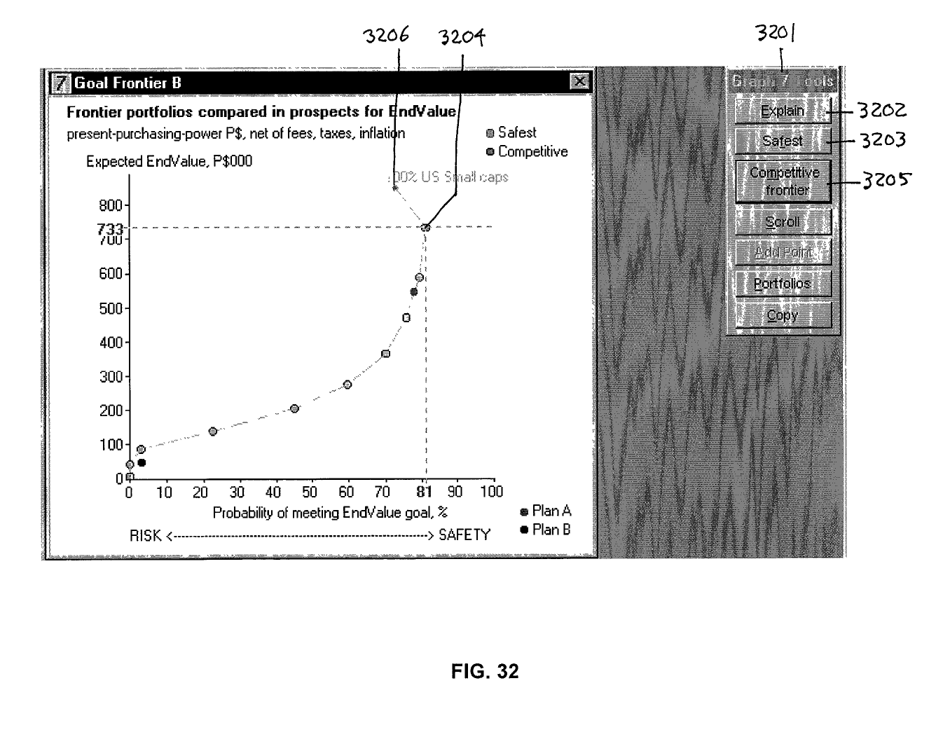

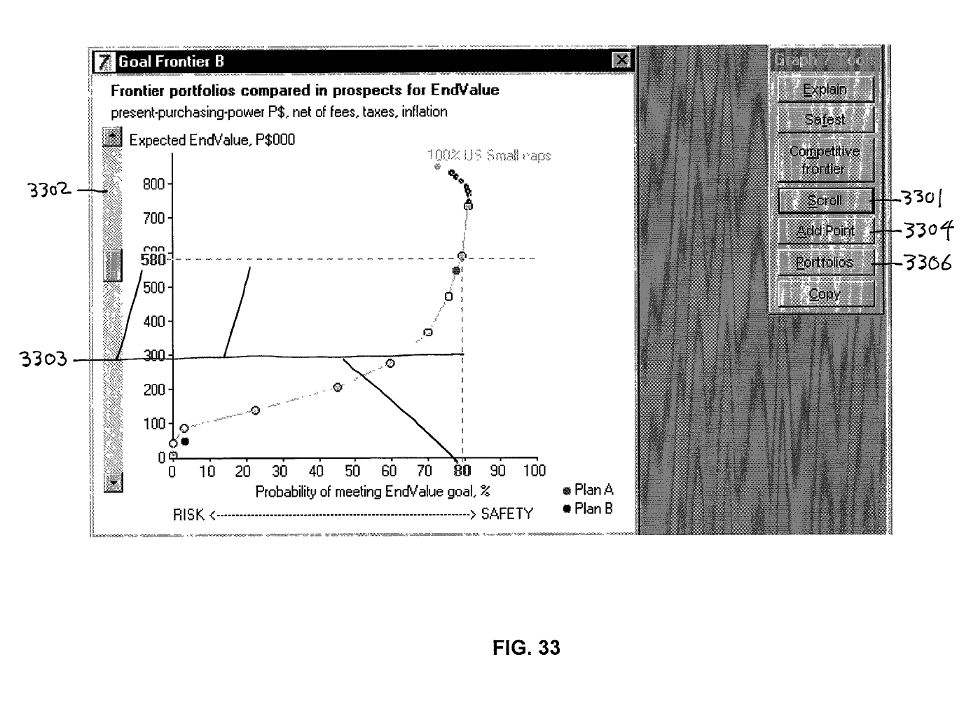

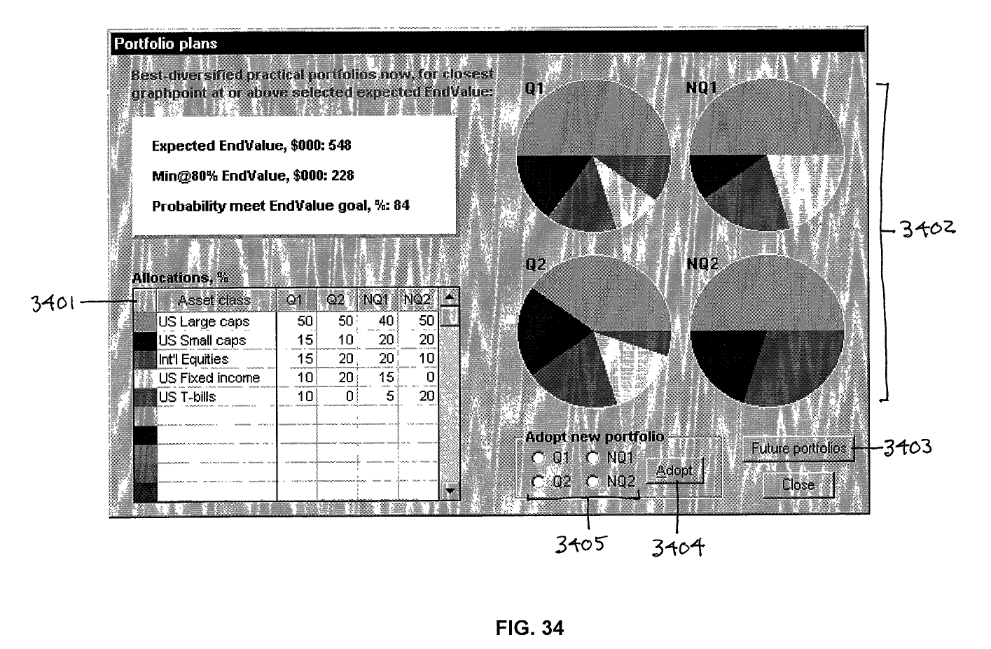

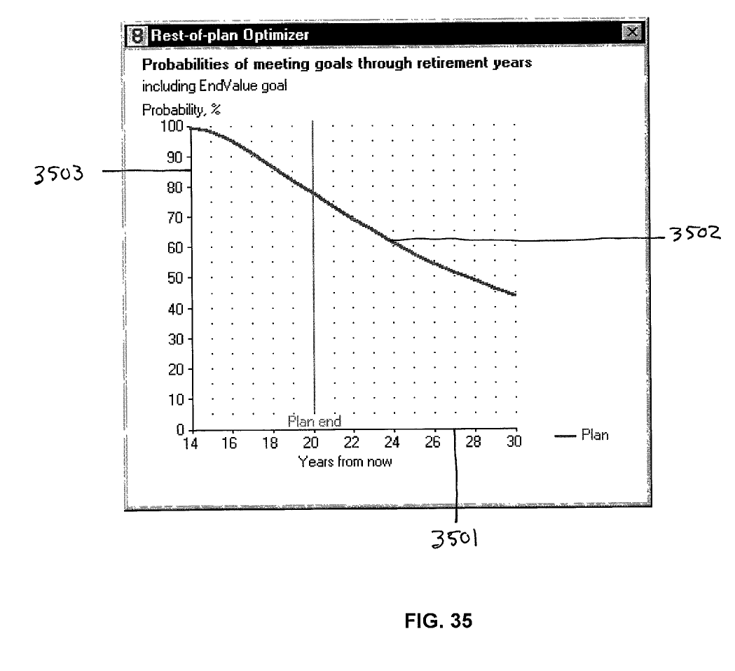

FIG. 32 illustrates the same Goal Frontier graph shown in FIG. 31 with additional illustration of the toolbox 3201 that the LTO software displays with this graph to provide user access to interactive tools, and also additional features illustrating use of some of the interactive tools. With the Goal Frontier graph illustrated in FIG. 30 the LTO software displays a toolbox like the toolbox 3201, enabling the user to perform with the graph shown in FIG. 30 all of the interactions described below and illustrated in FIGS. 32 and 33, including display and use of a portfolio plans window as described with reference to FIGS. 34 and 35.

The Explain button 3202 enables the user to obtain a window containing text explaining the graph and its use, including explanation of uses of the interactive tools. When the user selects the Safest button 3203, the LTO software identifies the portfolio plan point along the curve that is furthest to right on the graph 3204, representing greatest probability of meeting-or-beating the final wealth goal and thus least risk of falling short of the final wealth goal. When the user selects the Competitive frontier button 3205, the LTO software identifies the portfolio plan points above the safest 3206, distinguishing the portfolio plan points that, while being somewhat further to left than the safest portfolio plan point 3204 and thus shown to offer somewhat smaller probabilities of meeting-or-beating the final wealth goal, also are higher on the graph than the safest portfolio plan point 3204 and thus show better prospects of higher final wealth results, and therefore are deserving of investor consideration. By showing what each of these portfolio plan points offers and how they compare in both dimensions, probability of meeting-or-beating the final wealth goal as a measure of safety vs. risk and expected value of the final wealth as a measure of overall prospects for the final wealth, this graph provides users and investors an excellent basis for considering and choosing among these portfolio plan points relative to the tradeoff between these two measures.

FIG. 33 shows another illustration of the same graph shown in FIGS. 31 and 32 with the graph's toolbox, and other items shown on the graph to illustrate functions of other interactive tools. By selection of the Scroll button 3301 the user can obtain a scroll bar 3302 at left of the graph's vertical axis. The user can move to various heights for expected value of the final wealth relative to the vertical axis, and at any height moved to, lines and numbers 3303 are displayed on the graph showing both graphically and numerically the values relative to both graph axes of the portfolio plan point at or closest above or close to and corresponding to that height, thus displaying for that portfolio point both the expected value of the final wealth and the probability of meeting-or-beating the final wealth goal. By scrolling to various heights along the curve the graph and at each height selecting the AddPoint button 3304, the user can add more portfolio plan points along the curve, as illustrated by portfolio plan points 3305. By performing these steps repeatedly, the user can obtain a finer series of portfolio plan points in any segment of the curve. After adding portfolio plan points, the user can include them in the drawing of the curve and in subsequent interactive uses of the curve.

FIG. 34 illustrates a portfolio plans window displayed by the LTO software in one embodiment of the invention. After scrolling to a portfolio plan point along a Goal Frontier curve as illustrated in FIG. 33, the user can obtain the portfolio plans window shown in FIG. 34 by selecting the Portfolios button 3307. For the portfolio plan point to which the user has scrolled, the portfolio plans window displays information defining allocation proportions for each of a number of portfolio plans chosen to correspond to the portfolio plan point scrolled to. In the embodiment and example illustrated in FIG. 34, the portfolios window shows allocation proportions of portfolios for the present, for the first investment period, numerically in a table 3401 and graphically in pies 3402. Portfolios are shown for a portfolio plan that has two component portfolio plans with different portfolios for qualified and nonqualified investment amounts labeled Q and NQ. For each of these two component portfolio plans, two portfolios representing essentially identical prospects and risks for the financial plan are offered for user choice, labeled 1 and 2. An investor who desires to adopt the best-diversified portfolio plan represented in this window could choose either Q1 or Q2 and either NQ1 or NQ2. Similar information on different portfolios in the same portfolio plan for later investment periods can be accessed by the user by clicking the Future portfolios button 3403.

It must be recognized that in another embodiment of the present invention, comparison of a plurality of best-diversified portfolios in probabilistic measures of results or meeting of goals for a multi-period financial plan could be developed and displayed differently from the comparisons described above and illustrated in FIGS. 30 through 34. From probability distributions developed for long-term results for a financial plan with each best-diversified portfolio plan, other measures could be used for the axes of graphs similar to those illustrated, such as the median final wealth instead of the expected final wealth. Comparisons based on probability distributions of long-term results for each best-diversified portfolio plan could be developed and displayed using more fundamentally different graphic formats such as a bar graph or a graph displaying and comparing the probability distributions themselves as illustrated for portfolio Plans A and B in FIGS. 27 and 28. Comparison of best-diversified portfolio plans in probabilistic measures of long-term results for a financial plan could be presented in a format other than a graph such as a table containing such measures. Methods and interfaces for user interactions with and use of the comparisons could be different from those described and illustrated with reference to FIGS. 32 through 35.

Discussion is now directed to part 9 of the present invention process diagrammed in FIG. 2. For any portfolio plans represented along the curve on a Goal Frontier graph, the user can obtain additional graphic analyses and comparisons. After scrolling to a portfolio point along a Goal Frontier curve and then clicking the Portfolios button to obtain a portfolio plans window as described above and illustrated in FIG. 34, the user can select any displayed portfolio plan corresponding to the scrolled-to portfolio plan point by clicking the Adopt button 3403. If multiple portfolio plan choices are shown in the portfolio plans window, as illustrated in FIG. 34, the user can indicate which of these portfolio plans to adopt by selecting buttons 3404, before selecting the Adopt button 3403 as previously described. When the user adopts a portfolio plan, that portfolio plan's allocation proportions or specifications are entered for portfolio Plan A 2004, 2006 in the plan entry window's Portfolios tab-page 2001. Then after steps to prepare new graphs with these Plan A portfolio allocations, the user can display and use interactively new graphs featuring the adopted portfolio plan as Plan A. Of particular value at this point are the LTO software's Monte Carlo simulations graphs, on which the user can obtain individual simulations of how the portfolio value may develop year by year through the time horizon of the plan with the adopted portfolio plan depicted as Plan A, and optionally with another portfolio plan entered as Plan B for comparison, as previously illustrated in FIGS. 22 through 24; and the LTO software's probability distribution graphs, on which the user can see and by scrolling examine probabilities that the final wealth for the financial plan will meet-or-beat or fall short of various target values with the adopted portfolio plan depicted as Plan A, and optionally also with another portfolio entered as Plan B for comparison, as previously illustrated in FIGS. 25 through 28.

With discussion related to characteristics of the present invention completed relative to its principal purpose, namely development and display of information to enable and educate investors and users to select and maintain portfolio plans offering best prospects for their long-term financial plans, goals, and priorities, before proceeding to discuss additional features to help the user in optimizing other items in the financial plan it is useful to summarize key aspects of the present invention relative to novelty and investor benefit. The invention is intended for the benefit of individuals and families throughout the investing public. These intended beneficiaries have financial plans and goals which can be defined in the form of schedules of cash flows through a future number of years or time horizon which is commonly decades in length, with year-to-year irregularities in the planned and desired cash flows such as receipt of lump sums to be invested and withdrawals for children's college educations in particular future years, and these cash flows and their net usable values will be reduced by investment-related fees and costs and taxes as well as by inflation. The present invention enables the user or investor to specify realistic summaries of such plans, goals, and related factors relative to a time schedule through the time horizon. To meet future goals over such time horizons, investment selection is typically the most important decision area, with potential to produce through investment returns most of the means available to meet the long-term goals. As characteristics of what various potential investments offer, the best generally available information is probabilistic measures of annual rates of returns based primarily on history, especially for asset classes, which the present invention accesses, obtains, or provides. To select investments with best prospects for long-term goals, including consideration of risk relative to the long-term goals, it is essential to apply diversification, and most essential to consider and evaluate alternatives relative to the time-horizon dimension of the plans and goals. Through its application of Modern Portfolio Theory to identify a range of the best-diversified portfolios and use of information on desired pluralities of portfolios in a portfolio plan with regard to the shrinkage of the remaining time horizon over the life of the plan as well as other advantageous considerations, the present invention defines a series of best-diversified portfolio plans comprising pluralities of best-diversified portfolios. The present invention then applies Monte Carlo or other simulation to assess and compare the best-diversified portfolio plans in probabilistic measures of prospects and risks for the full financial plan over its full time horizon, thus developing information that is most important and useful for identifying portfolio plans that are optimal with respect to particular investors' long-term financial plans, goals, and priorities. In particular, compared to the prior art, the present invention provides information of surpassing superiority in portfolio selection value in (1.) considering portfolio plans comprising different best-diversified portfolios in different time phases of the financial plan as the remaining time horizon shrinks, and (2.) assessing and comparing the portfolio plans in probabilistic measures of prospects and risks for the full financial plan over its full time horizon.

Further, the present invention provides and displays results in unique ways that have unique value and benefit for the investor, specifically graphic displays of comparisons of the best-diversified portfolio plans with respect to several measures of most importance to investors, enabling the investor to see the portfolio plans assessed and compared in several measures and characteristics so each investor can select a portfolio plan offering best prospects for his/her particular plans, goals, and priorities relative to the various measures and characteristics. In particular the Goal Frontier graphs compare the entire series of best-diversified portfolio plans in combinations of most-important measures of prospects and risks for the final wealth including probabilities of meeting all goals, “Min” value assured at a user-specified confidence level, and expected value of the final wealth. Additionally, for portfolio plans represented on these graphs, other displays offer graphic assessments and comparisons in additional important measures and characteristics, including final wealth probability distributions on which the investor can see probabilities of meeting-or-beating various target values for the final wealth, and sample year-by-year simulations on which the investor can compare portfolio plans in the tradeoff between long-term prospects and short-term ups and downs along the way. Through production and display of these unique comparisons of the portfolio plans relative to numerous most relevant measures and characteristics, the present invention provides investors unique information for finding, judging, selecting, and maintaining portfolio plans offering best prospects for the investor's particular financial plans, goals, and priorities.

With a portfolio plan adopted as described and illustrated in FIG. 34 or otherwise designated by the user, additional analyses and displays are provided enabling the user to explore effects on probabilistic measures of long-term results for a financial plan from changes in values of items in the financial plan. FIG. 35 illustrates a graph developed by the LTO software which enables the user to make such explorations visually as well as numerically. For each of a range of values for the number of years in the time horizon of the financial plan shown along the horizontal axis 3501, a curve 3502 shows the probability, with the selected portfolio plan, of meeting all goals in the financial plan, including the final wealth, as represented by the vertical axis 3503. To develop this curve, for each number of years along the horizontal axis the LTO software develops a probability distribution of the final wealth using Monte Carlo simulation or another method as described with reference to FIG. 25 and FIG. 30. The desired probability is determined by ascertaining the percentage of the distribution representing final wealths higher than the investor's desired final wealth 1606. To determine an appropriate range of numbers of years to be represented by this graph's horizontal axis and the curve, in the illustrated embodiment the LTO software proceeds from the entered number of years in the plan 1604 backward to the entered number of years to retirement 1605 and forward to ten years beyond the entered number of years, developing a final wealth probability distribution for each number of years and determining the desired probability and proceeding no further in either direction if the probability exceeds 99% or is less than 1%.

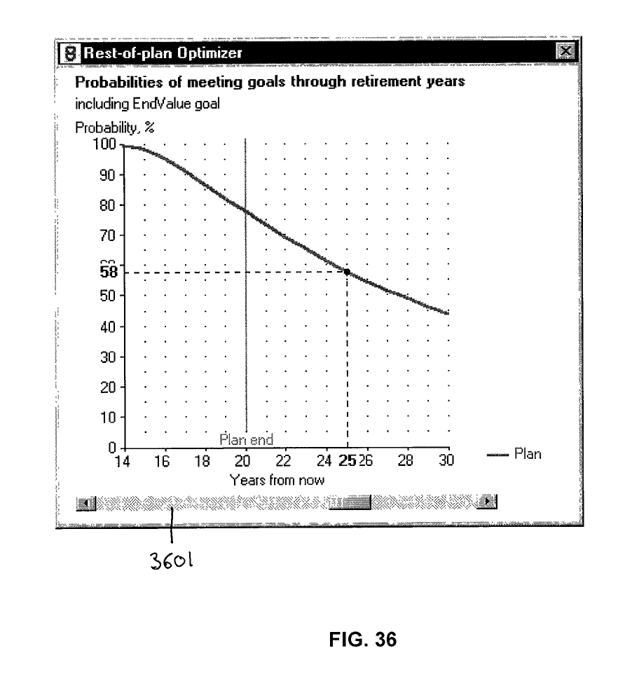

FIG. 36 illustrates the graph shown in FIG. 35 together with a scrollbar 3601 and its use to move along the curve to a number of years. For the number of years moved to the LTO software displays graphically and numerically the number of years moved to and the probability of meeting all goals including the desired final wealth with a time horizon of that number of years. From the graph illustrated in FIGS. 35 and 36 the user or investor can gain valuable information for assessing the adequacy of the financial plan with the selected portfolio plan relative to potential change in the desired number of years in the time horizon, such as living to an older age than was anticipated when the entry for number of years 1604 was made.

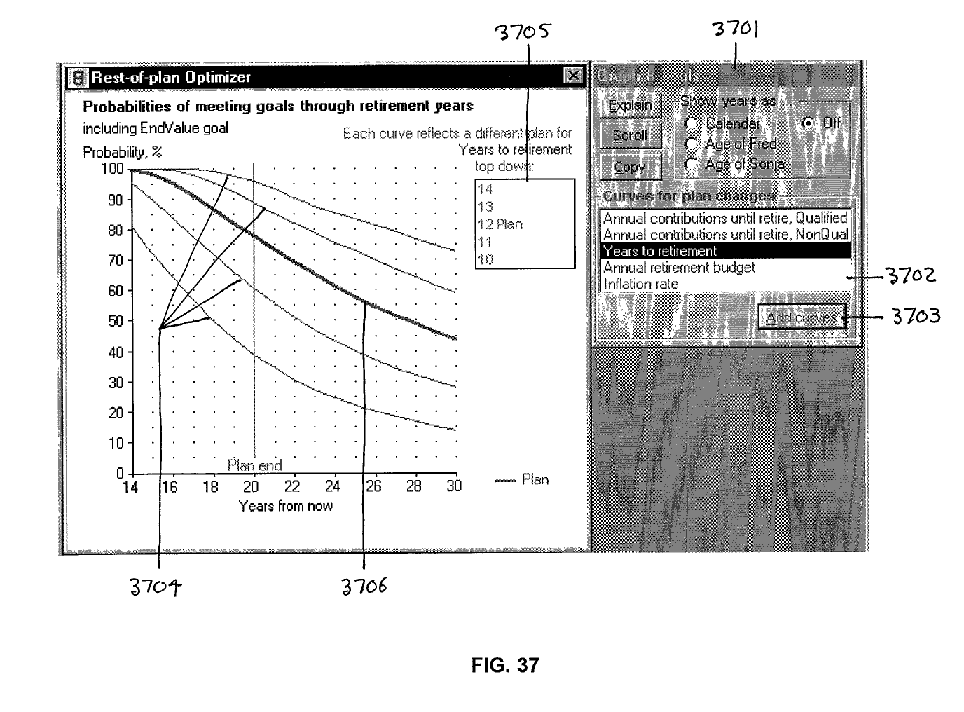

FIG. 37 illustrates the same graph shown in FIG. 35 together with a toolbox 3701 for user interaction with the graph and additional items on the graph illustrating user interactions and resulting performance of the LTO software. The toolbox 3701 for this graph includes a menu 3702 listing a number of financial plan items for which values have been entered in the financial plan, as previously described and illustrated with reference to FIGS. 16 through 19, for which the user may wish to explore effects of changes in values. When the user selects one of the financial plan items in the menu 3702 and then clicks the Add curves button 3703, the LTO software displays a number of additional curves 3704 on the graph, illustrating what the probabilities for meeting goals through various numbers of years would be if values of the selected financial plan item were changed to other values. At upper right of the graph, the LTO software displays a box 3705 containing labels of the curves defining the differing values the curves represent for the selected financial plan item. The top row in this box 3705 corresponds to the curve that is highest on the graph, and the other rows correspond to other curves, including the curve 3706 shown before use of the Add curves button 3703, down to the bottom row corresponding to the curve that is lowest on the graph. In the particular example illustrated on the graph in FIG. 37, the selected financial plan item for which the different curves represent different values is Years to retirement, and the curves represent values for this item from 14 years to retirement for the top curve down to 10 for the bottom curve.

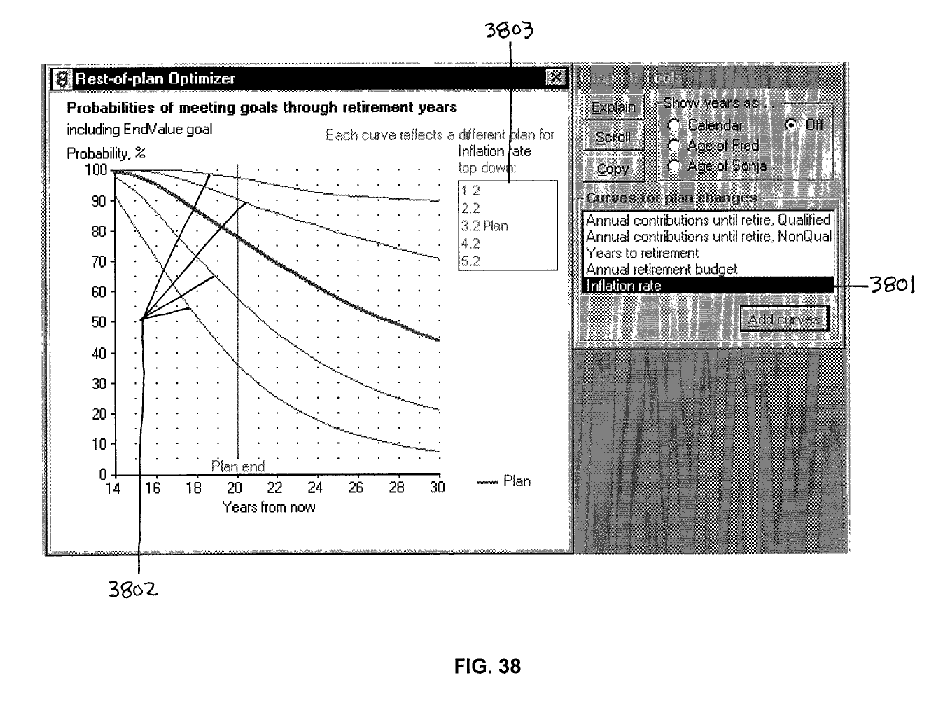

FIG. 38 illustrates the same graph shown in FIG. 37 except that in FIG. 38 the financial plan item selected in the toolbox menu is Inflation rate 3801, and a new set of curves 3802 is displayed on the graph representing different values for this financial plan item. The box 3803 to upper right of the graph identifies the different values represented by the curves 3802, from 1.2 percent inflation rate for the highest curve down to 5.2 percent inflation rate for the bottom curve.

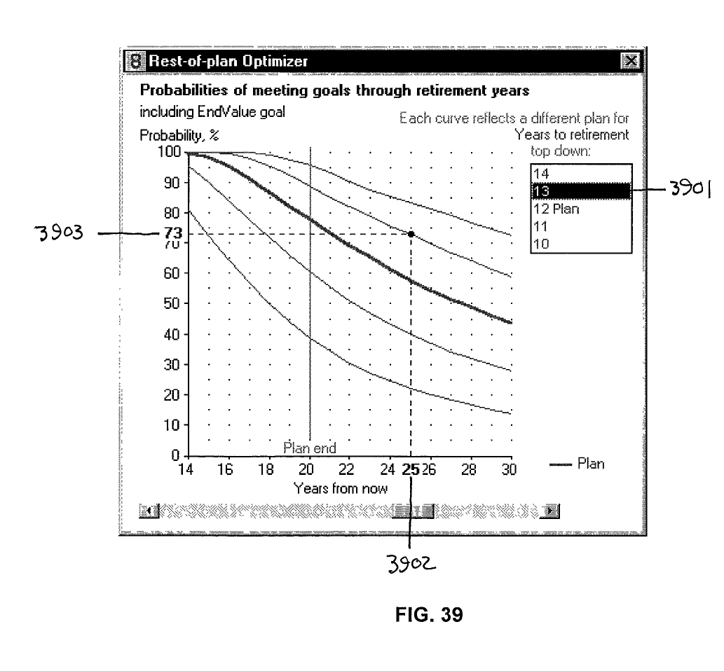

FIG. 39 illustrates the same graph shown in FIG. 37 with additions illustrating further user interaction on the graph to obtain display of values for a selected combination of values for two financial plan items. The user can select any one of the curves to scroll on by selecting that curve's value label 3901 in the box at the graph's upper right; and on the selected curve, the user can scroll to any of the numbers of years 3902 for the time horizon along the horizontal axis. Wherever the user moves along any of the curves, the LTO software displays graphically and numerically the values moved to for the two financial plan items, and also displays the probability 3903 of meeting all goals including the final wealth goal with this combination of values for the two financial plan items. In the example illustrated on the graph in FIG. 39, the user has selected the curve for 13 years to retirement 3901, and along that curve scrolled to a time horizon of 25 years 3902; and the LTO software displays information graphically and numerically showing that for this combination of values for the financial plan, the probability 3903 of meeting all goals including final wealth is 73%.

For an investor who has previously selected an appropriate best-diversified portfolio plan as previously described and illustrated, the value of this graph with its user interactions for users and investors in optimizing a financial plan with respect to values of items in the financial plan and resulting probabilities of meeting goals is readily apparent. The investor or user can simultaneously see and compare an entire field of combinations of values for two financial plan items assessed and compared in a measure of probability relative to the investor's goals in the long-term plan. Through such comparisons, investors and their professional advisors can see and compare alternatives and tradeoffs to zero in on combinations of financial plan item values and resulting probabilities of meeting goals that optimally reflect the investor's priorities.

For analysis and display of alternatives for financial plan items and resulting probabilistic measures of prospects and risks for long-term results and meeting of goals with best-diversified portfolio plans, in another embodiment of the present invention different analyses, displays, and user interactions and interfaces could be provided. With reference to FIGS. 35 through 39, the vertical axis could represent another measure based on probability distributions for long-term results, such as expected final wealth, or the “Min” final wealth measure previously described with reference to the horizontal axis 3003 of the Goal Frontier graph illustrated in FIG. 30. The horizontal axis could represent a financial plan item other than number of years of the time horizon of the financial plan, or the toolbox menu 3701 could offer sets of curves for financial plan items other than those shown in FIGS. 37 through 39. More generally, the analyses of how measures based on probability distributions for long-term results are affected and compare for various values for financial plan items with a best-diversified portfolio plan could be developed using different methods of obtaining and analyzing relevant data or displayed in different formats such as bar graphs or tables of data.

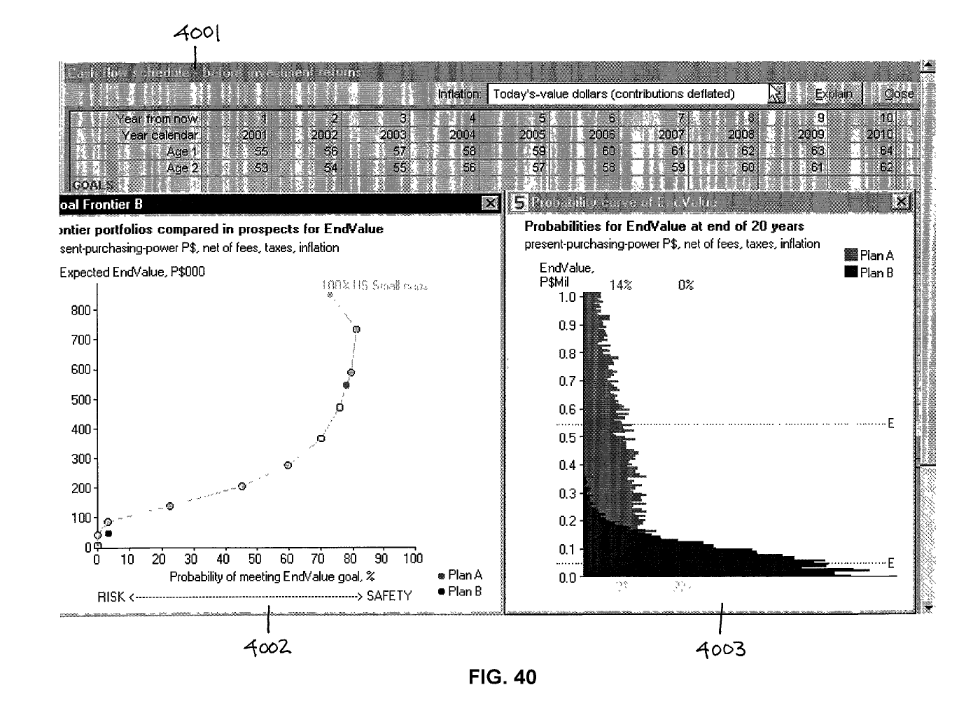

Attention is now turned to capabilities, methods, and formats of input to and output from the LTO software relative to data, selections, displays, and user interactions previously described and illustrated. FIG. 40 illustrates simultaneous display by the LTO software of a plurality of previously illustrated displays shown in different windows, including the financial plan cash flow schedule 4001 previously illustrated in FIG. 18, a Goal Frontier graph 4002 previously illustrated in FIG. 31, and a final wealth probability distribution graph 4003 previously illustrated in FIG. 27. More generally, in the Microsoft “Windows” software environment the LTO software enables the user to obtain simultaneous display of various user-selected combinations of previously illustrated displays or windows containing displays. In another software environment similar capabilities could be provided using different methods and user interfaces and exhibiting different appearances.

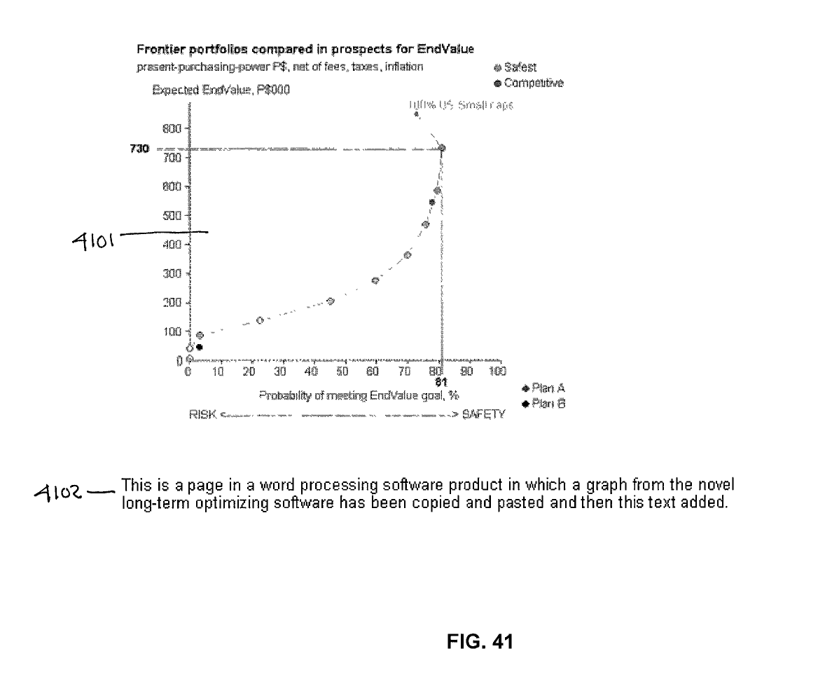

FIG. 41, which includes both the graph 4101 and the text 4102 beneath the graph, illustrates a graph produced and displayed by the LTO software reproduced in a page of a popular word processing software product together with text which has been created in the word processing software product. The graph was copied to the Microsoft “Windows” clipboard by the LTO software when the user selected the Copy button in the toolbox displayed by the LTO software with the graph, and then pasted into the word processing software page by the user using a command such as Paste in the word processing software according to established user interface conventions of the Microsoft “Windows” software environment. In this manner the LTO software provides capabilities and user interface features for the user to reproduce in other software products any graph produced by the LTO software. The user can place the graph copy in a page or document in the word processing software which contains previously created text and other contents or create added text and other contents after placing the graph copy, and in the word processing software manipulate the graph in various ways such as resizing or adding labels, and generally manipulate and use the page or document containing the graph copy using the full capabilities of the word processing software product. In the same way the same capabilities and interface features of the LTO software enable the user to place and use copies of graphs produced by the LTO software in other software products such as graphics software and presentation software.

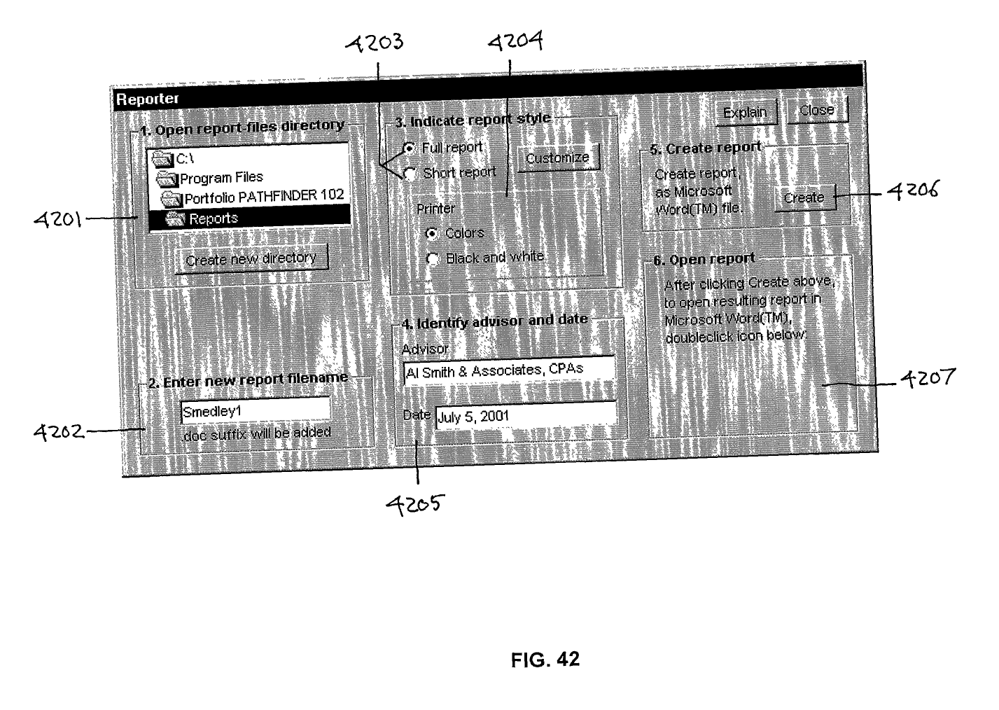

FIG. 42 illustrates a window displayed by the LTO software for production of printable reports containing previously illustrated graphs, tables, and other data obtained or developed by the LTO software, concerning investment categories, financial plans, portfolio plans, and assessments and comparisons, together with text providing explanations and other information pertaining to the financial plans, graphs, tables, and other data. In the embodiment of the present invention reflected by the illustration in FIG. 42, the reports to be produced are designed for production by professional financial planners using the LTO software for advising clients, and are addressed from such planners to clients the planners advise. A report developed using the window illustrated in FIG. 42 is produced in the form of a file saved on disk in a format usable in popular word processing software products including the Microsoft Word software product, where the user can modify the report using the full capabilities of the word processing software and print and save the report to disk in the word processing software. Referring to specific parts of the user interface of the window illustrated in FIG. 42, six user steps are displayed from top left to bottom right. The user can designate a disk directory for location of the report file 4201, enter a name for the report file 4202, select one of a plurality of report designs 4203, select color or black & white for the intended printer for which the report will be optimized 4204, and enter the name of the financial planner or firm and the date 4205 to be shown on the report cover page. Upon user selection of the Create button 4206, the LTO software creates the report as a file according to the user selections and entries in steps 1 and 4 as previously described, and upon completion of this step displays an icon for the word processing product in the step 6 box at the window's lower right 4207, which enables the user to open the word processing software product and the report file in the word processing product ready for user manipulation and printing. The report file is created by the LTO software by making a copy of one of a number of previously created model report files stored on disk, and inserting in the report file copies of graphs, tables, and other elements created by the LTO and containing information regarding the financial plan for which the report is desired. For this insertion, each graph, table, and other element to be inserted in the report is temporarily saved as a file on disk, and the user can make other uses of any of these files created for report insertions. The model report files used by the LTO software to create report files are also stored on disk, in a format usable in the word processing software, and this feature enables the user to customize all subsequently created reports by customizing a model report file in the word processing software. In this way, the user could for example add, delete, or revise text in a model report file using the word processing software, and thereafter every report created by the LTO software using that model report file will contain these user revisions.

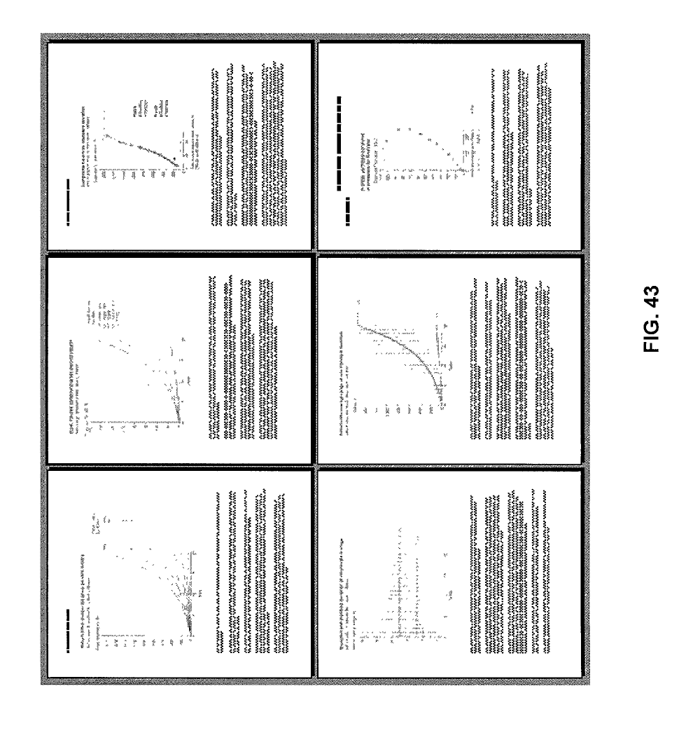

FIG. 43 illustrates a display provided by the word processing software showing six pages of a report which was created as a word processing file by the LTO software as described and illustrated with reference to FIG. 42.

In another embodiment of the present invention, methods and user options and interfaces for creation of printable reports or documents could be different from those described and illustrated with reference to FIGS. 42 and 43. For example, with respect to user choice of report designs 4203, more or different designs could be offered, or a list or menu of report pages or elements could be provided and the user enabled to select any combination of the pages or elements organized in any sequence. Instead of creating a report as a file formatted for use in word processing software, the LTO software could create the report for use within the LTO software and include capabilities and user interfaces for editing, printing, and saving the reports.

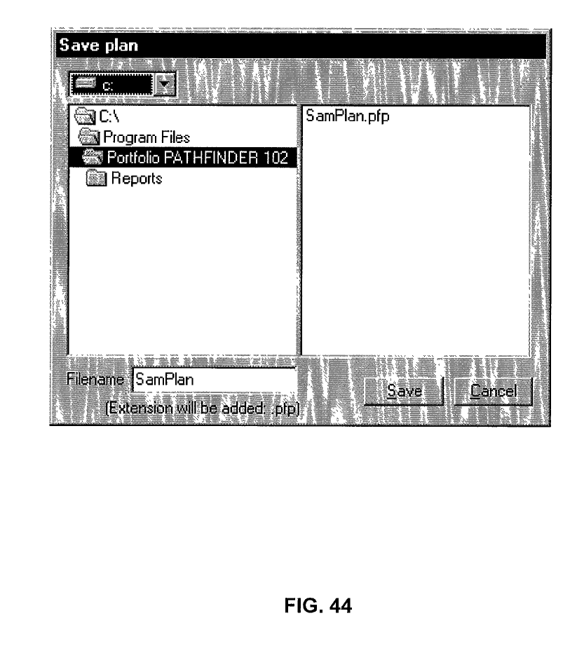

FIG. 44 illustrates a window provided by the LTO software that enables the user to save to disk a plan file containing data entered, selected, and calculated for a financial plan. The LTO software also provides a similar window enabling the user to open or restore in the LTO software the data previously saved for a financial plan. Each of these windows enables user designation of the disk and directory location of the file to be saved and user designation of the name of the file according to methods and interface conventions commonly used for software products designed for use in the Microsoft “Windows” software environment. The information saved in a plan file includes all data and selections regarding investment categories as displayed at the time the file is saved as illustrated in FIG. 3, as well as information on all financial plan and portfolio plan entries and selections in the plan entry window as illustrated in FIGS. 16, 17, 19, and 20. For repeated use of modified investment category information, the user can make a file containing only investment category information with the desired modifications, and open this file each time use of the modified investment category information is desired. The information saved in a file is sufficient to produce, after opening of the file, all graphs and other information displays which can be displayed in the LTO software at the time the file is saved. Additionally, any data calculated for display of graphs and user interactions on the graphs which is available at the time the file is saved and required any time to prepare is included in the data saved in the file, so that when the plan file is opened all previously prepared graphs and graph interaction capabilities are available immediately.

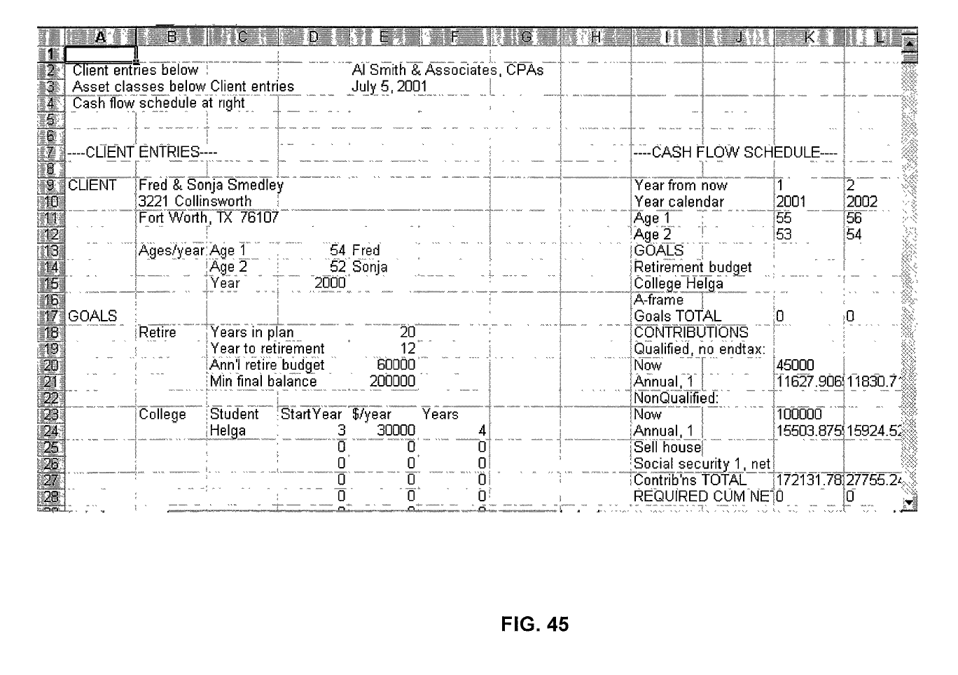

FIG. 45 illustrates information in an LTO plan file opened and displayed in a spreadsheet software product. Each plan file created by the LTO software is created in a format that can be opened and used in popular spreadsheet software products including the Microsoft Excel product. Such spreadsheet products and their files are widely used as standard formats for exchanges of data among various software products and electronic data storage and retrieval systems. Thus the format in which the LTO software saves and opens plan files enables two-way exchange of plan data including importing of data from other software and storage sources for use in LTO software plans and export of data from LTO software plans for use in other software and data systems, including exchanges of data between remote computers via networks, the internet, and wireless communication. For example, data prepared in other software for an individual or family's budget or tax plan could be electronically entered in appropriate places in the windows and tab-pages illustrated in FIGS. 16, 17, and 19 for the LTO financial plan, or data entered for the LTO software financial plan could be electronically entered for the budget or tax plan. Furthermore, in a spreadsheet software product the user can build financial models of great sophistication using formulas, functions, and other spreadsheet capabilities, and by locating certain elements of a model in certain cells of a spreadsheet model, save the model as a file which when opened in the LTO software will enter appropriate elements of the model in appropriate entry boxes for the LTO financial plan in accordance with the plan entry tab-pages illustrated in FIGS. 16, 17, 19, and 20. In this way the user can apply the spreadsheet compatibility of LTO plan files and the modeling capabilities of spreadsheet software to apply the analyses provided by the LTO software to almost any financial plan or model that can be developed in spreadsheet software.

The preceding description includes discussion and illustration of the nine principal parts of the process of the present invention shown in FIG. 2. Through user interaction investment categories are accessed with return-rate data and used to determine a range of best-diversified portfolios or portfolio points, effects of time horizon on portfolio comparison are illustrated, financial plan information is obtained, a method of simulation for developing final wealth probability distributions for a financial plan with a portfolio plan is applied, and these data and methods of analysis are integrated in a novel way to define a series of best-diversified portfolio plans comprising pluralities of best-diversified portfolios and develop and display comparisons of the best-diversified portfolio plans in probabilistic measures of final wealth prospects and risks for the financial plan, using novel Goal Frontier graphs, and enabling user interactions with respect to the comparisons. The user is thus enabled and informed to see, compare, judge, select, and maintain portfolio plans that are optimal in probabilistic prospects and risks for the investor's long-term financial plans, goals, and priorities. With a financial plan and a portfolio plan thus selected, and a second portfolio plan for comparison, further analyses are developed and graphically displayed providing interactive final wealth probability distributions on which the user can see probabilities of meeting and risks of falling short of various target values, and simulations of year-by-year progression of portfolio value from present through the time horizon of the financial plan. For the selected portfolio plan, additional graphic assessments are shown of effects on probabilistic long-term prospects from changes in values of key items in the financial plan, enabling users to optimize the financial plan for investor priorities. Printable reports and plan files are created in formats usable in popular word processing and spreadsheet software products enabling great user flexibility in inputs, uses, and outputs of the LTO software relative to data and capabilities of other software and computer and electronic products.

The foregoing discussion of the invention has been presented for purposes of illustration and description. Further, the description is not intended to limit the invention to the form described herein. Consequently, variations and modifications commensurate with the above teachings, within the skill or knowledge of the relevant art, are within the scope of the present invention. The embodiments discussed hereinabove are further intended to explain the best mode known to practicing the invention and to enable others skilled in the art to utilize the invention in such, or in other embodiments, and with the various modifications required by their particular applications or uses of the invention. It is intended that the appended claims be construed to include alternative embodiments to the extent permitted by the prior art.

What is claimed is:

1. A method that relates to finding best investment portfolio plans for long-term financial plans and goals, comprising:
obtaining information on a plurality of investment categories, information on a financial plan, and information on portfolio plans, said information on a plurality of investment categories including data on return rates per investment period including an expected return rate and a return rate standard deviation for each of said investment categories and a return rate correlation coefficient for each pair of said investment categories; said information on said financial plan including a time horizon comprising a plurality of investment periods, at least a first investment amount in a portfolio plan in a first investment period in said time horizon, and at least a second investment amount put into or a first withdrawal amount taken from said portfolio plan in a subsequent investment period of said time horizon; and said information on portfolio plans including information useful for defining a series of portfolio plans in which at least a first portfolio plan in a series comprises a plurality of portfolios, each portfolio being a number of said investment categories in particular unique allocation proportions; and
providing at least a first comparison of a series of best-diversified portfolio plans with respect to at least a first criterion relative to the final wealth of a portfolio plan, wherein:
each of said best-diversified portfolio plans conforms to said information on portfolio plans and comprises a number of best-diversified portfolios, each of said best-diversified portfolios having an expected return rate and the smallest return rate standard deviation of any portfolio having the same said expected return rate in a population of portfolios each comprising a number of said investment categories;
said final wealth is the value of a portfolio plan at the end of said time horizon using said portfolio plan for said financial plan and has a probability distribution; and
said first criterion comprises a value for said final wealth and a probability that said final wealth will equal or exceed said value and is determined for a portfolio plan using simulation.

2. A method, as claimed in claim 1, wherein:
said investment period is the year.

3. A method, as claimed in claim 1, wherein:
at least one of said investment categories is an asset class.

4. A method, as claimed in claim 1, wherein:
at least one of said investment categories is a mutual fund or other investment vehicle.

5. A method, as claimed in claim 1, wherein:
said obtaining step includes displaying identifications of a number of investment categories from which the user may choose said plurality of investment categories.

6. A method, as claimed in claim 5, wherein:
said displaying step includes displaying said data on return rates of said investment categories.

7. A method, as claimed in claim 6, wherein:
said displaying step includes enabling revision or replacement by the user of at least one of said identifications or said data on return rates.

8. A method, as claimed in claim 1, wherein:
said financial plan includes a desired value for final wealth of a portfolio plan at the end of said time horizon.

9. A method, as claimed in claim 1, wherein:
said financial plan includes a plurality of investment amounts or portions of investment amounts subject to different rules of taxation.

10. A method, as claimed in claim 1, wherein:
said financial plan includes said first withdrawal amount.

11. A method, as claimed in claim 1, wherein:
said financial plan includes data to enable calculation of amounts and time periods of deductions from a portfolio plan for fees and costs and for taxes including deductions based on investment returns, withdrawals from a portfolio, and portfolio value.

12. A method, as claimed in claim 1, wherein:
said financial plan includes at least a first inflation rate to enable calculation of inflation adjustments of future values.

13. A method, as claimed in claim 1, wherein:
said financial plan includes information defining as a probability distribution said number of said investment periods in said time horizon, said first inflation rate, or any other item of said information on said financial plan.

14. A method, as claimed in claim 1, wherein:
any investment amount, withdrawal amount, final wealth, or other measure of financial value may be expressed either before or after adjustment for any of the following: any fees and costs, any taxes, any inflation.

15. A method, as claimed in claim 1, wherein:
said providing step includes applying concepts of Modern Portfolio Theory using said data on return rates of said plurality of investment categories to obtain information defining an efficient frontier curve on a graph, said curve comprising a range of portfolio points each representing a number of best-diversified portfolios in said population.

16. A method, as claimed in claim 15, wherein:
said applying step includes applying concepts and methods known collectively as CAPM including investing or borrowing at a rate commonly termed a “risk-free” rate.

17. A method, as claimed in claim 1, wherein:
said population of portfolios includes only portfolios having allocation proportions that conform to at least a first allocation constraint defining a minimum or maximum total allocation proportion for a number of said investment categories.

18. A method, as claimed in claim 1, wherein:
said population of portfolios includes only portfolios in which the allocation proportions of said investment categories are integer multiples of an integer allocation percentage increment.

19. A method, as claimed in claim 18, wherein:
said portfolios are grouped and characterized with respect to expected return rate according to an incremental sequence of expected return rates.

20. A method, as claimed in claim 15, wherein:
said applying step includes displaying said efficient frontier curve on an efficient frontier graph with axes representing expected return rate and return rate standard deviation.

21. A method, as claimed in claim 20, wherein:
said displaying step includes showing on said efficient frontier graph a number of portfolio points each representing a user-specified portfolio.

22. A method, as claimed in claim 20, wherein:
said displaying step includes enabling user interaction with said graph including choosing at least a first portfolio point and showing information for said first portfolio point graphically and numerically, said information including an expected return rate, a return rate standard deviation, and allocation proportions of at least a first portfolio corresponding to said first portfolio point.

23. A method, as claimed in claim 22, wherein:
said information includes allocation proportions for each of a plurality of portfolios in said population determined to best correspond to said first chosen portfolio point.

24. A method, as claimed in claim 22, wherein:
said information includes upper and lower limits at a specified confidence level for the highest and lowest return rate in the best and worst investment periods of said time horizon.

25. A method, as claimed in claim 1, wherein:
each of said portfolio plans comprises a plurality of component portfolio plans in which separate investment amounts or separate portions of investment amounts may be placed.

26. A method, as claimed in claim 25, wherein:
said component portfolio plans in a portfolio plan are subject to different rules of taxation.

27. A method, as claimed in claim 25, wherein:
said component portfolio plans in a portfolio plan comprise different portfolios.

28. A method, as claimed in claim 1, wherein:
at least one portfolio plan or component portfolio plan is rebalanced at the end of at least a first investment period, having at the start of the next investment period the same portfolio as at the start of said first investment period.

29. A method, as claimed in claim 1, wherein:
at least one portfolio plan or component portfolio plan is reallocated at least once during said time horizon, comprising one portfolio before said reallocation and another portfolio after said reallocation.

30. A method, as claimed in claim 1, wherein:
said series comprises portfolio plans that each have the same number of component portfolio plans and are all defined according to a common system of increments and limits regarding portfolios in the first investment period of said time horizon and times and methods of rebalancing and reallocation of portfolios in subsequent investment periods of said time horizon.

31. A method, as claimed in claim 1, wherein:
said first criterion is the probability that said final wealth will equal or exceed a desired value for final wealth.

32. A method, as claimed in claim 1, wherein:
said first criterion is the highest value that said final wealth has a predetermined probability of equaling or exceeding.

33. A method, as claimed in claim 1, wherein:
said providing step includes producing a number of simulations of said financial plan using a portfolio plan for which assessment is to be performed.

34. A method, as claimed in claim 33, wherein:
said producing step includes determining separately for each investment period of each simulation a return rate for at least a first portfolio of said portfolio plan for said investment period by random selection from a probability distribution for the return rate of said portfolio.

35. A method, as claimed in claim 34, wherein:
said probability distribution for a return rate is determined using an expected return rate and a return-rate standard deviation and assuming one of a number of shapes for said probability distribution.

36. A method, as claimed in claim 35, wherein:
said assuming step includes assuming that said shape of said probability distribution is normal or lognormal.

37. A method, as claimed in claim 34, wherein:
said determining step includes establishing said probability distribution for the return rate of at least one portfolio in at least one investment period using at least a first serial correlation coefficient reflecting an effect upon said probability distribution of at least one return rate in at least one previous investment period.

38. A method, as claimed in claim 34, wherein:
said determining step includes ascertaining for at least one investment period a return rate for at least a second portfolio in said portfolio plan in said investment period by random selection from a probability distribution for said return rate determined using a return rate randomly selected for said first portfolio for said investment period and the covariance of the return rates of said first portfolio and said second portfolio.

39. A method, as claimed in claim 33, wherein:
said producing step includes for each simulation determining a return rate for each portfolio in a portfolio plan in each investment period of said time horizon by random selection of a historical investment period using actual historical return rates of investment categories for the selected historical investment period.

40. A method, as claimed in claim 33, wherein:
said producing step includes for each simulation using historical return rates of investment categories for a series of consecutive historical investment periods equal in number to the number of investment periods in said time horizon.

41. A method, as claimed in claim 33, wherein:
said producing step includes determining values of a number of items in said financial plan by random selection from probability distributions of values of said items.

42. A method, as claimed in claim 33, wherein:
said producing step includes grouping final wealths produced by said simulations according to a scale of value increments to develop a final wealth frequency distribution, interpreting said final wealth frequency distribution as a final wealth probability distribution, and using said probability distribution to determine specifications of said probability distribution such as the expected final wealth or the median final wealth, the probability that the final wealth will equal or exceed a value, or the largest value that the final wealth has a probability of equaling or exceeding.

43. A method, as claimed in claim 33 wherein:
said producing step includes producing said simulations using each portfolio plan in said series.

44. A method, as claimed in claim 1, wherein:
said providing step includes comparing in said first comparison a number of portfolio plans designated by the user.

45. A method, as claimed in claim 1, wherein:
said providing step includes displaying for each of said series of portfolio plans a plurality of the following: identifying name, symbol, or number; expected final wealth; median final wealth; probability that the final wealth will equal or exceed a predetermined amount; highest amount that the final wealth has a predetermined probability of equaling or exceeding; an expected return rate characteristic of the portfolio plan; a return-rate standard deviation characteristic of the portfolio plan; a lowest-return-rate characteristic of the portfolio plan for an individual investment period relative to a predetermined probability; and a lowest-return-rate characteristic of the portfolio plan for the investment period in which said characteristic is lowest of all investment periods in said time horizon relative to a predetermined probability.

46. A method, as claimed in claim 1, wherein:
said providing step includes presenting said first comparison graphically.

47. A method, as claimed in claim 46, wherein:
said presenting step includes displaying said first comparison in a graph with a first axis representing said first criterion, a second axis representing a second measure of said portfolio plan, and a portfolio plan point representing each portfolio plan in said series relative to said first axis and said second axis.

48. A method, as claimed in claim 47, wherein:
said second measure is one of the following: identifying name, symbol, or number; expected final wealth; median final wealth; probability that the final wealth will equal or exceed a predetermined amount; highest amount that the final wealth has a predetermined probability of equaling or exceeding; an expected return rate characteristic of the portfolio plan; a return-rate standard deviation characteristic of the portfolio plan; a lowest-return-rate characteristic of the portfolio plan for an individual investment period relative to a predetermined probability; and a lowest-return-rate characteristic of the portfolio plan for the investment period in which said characteristic is lowest of all investment periods in said time horizon relative to a predetermined probability.

49. A method, as claimed in claim 47, wherein:
said displaying step includes choosing by the user of at least a first portfolio plan point represented on said graph.

50. A method, as claimed in claim 49, wherein:
said choosing step includes choosing by the user of a value along an axis of said graph from which value said first portfolio plan point is designated.

51. A method, as claimed in claim 49, wherein:
said choosing step includes displaying values associated with said first portfolio plan point relative to each axis of said graph.

52. A method, as claimed in claim 49, wherein:
said choosing step includes identifying at least a first portfolio plan designated to correspond to said first portfolio plan point.

53. A method, as claimed in claim 52, wherein:
said identifying step includes displaying allocation proportions of at least a first portfolio of said first portfolio plan.

54. A method, as claimed in claim 53, wherein:
said displaying step includes presenting additional information necessary to determine all allocation proportions of all portfolios in said first portfolio plan in each investment period of said time horizon.

55. A method, as claimed in claim 49, wherein:
said choosing step includes identifying each of a plurality of portfolio plans designated to correspond to said first portfolio plan point.

56. A method, as claimed in claim 49, wherein:
said choosing step includes selecting at least a first portfolio plan corresponding to a point on said graph.

57. A method, as claimed in claim 56, wherein:
said selecting step includes displaying a probability distribution graph showing a probability distribution of the final wealth of said first portfolio plan.

58. A method, as claimed in claim 57, wherein:
said displaying step includes showing on said probability distribution graph a probability distribution of the final wealth of a second portfolio plan.

59. A method, as claimed in claim 57, wherein:
said displaying step includes indicating by the user of a target value for the final wealth of a portfolio plan.

60. A method, as claimed in claim 59, wherein:
said indicating step includes showing for each of a number of portfolio plans represented on said probability distribution graph the probability that the final result will equal or exceed said target value.

61. A method, as claimed in claim 56, wherein:
said selecting step includes displaying a simulations graph showing at least a first simulation of the progression of portfolio value investment period by investment period through the time horizon for said first portfolio plan.

62. A method, as claimed in claim 61, wherein:
said displaying step includes showing on said simulations graph a plurality of said simulations.

63. A method, as claimed in claim 61, wherein:
said displaying step includes showing on said simulations graph a number of said simulations for a second portfolio plan.

64. A method, as claimed in claim 56, wherein:
said selecting step includes displaying a sensitivity graph in which a first axis represents a range of values for a first item of said financial plan, a second axis represents a range of values for said first criterion, and values are represented for said first criterion of said first portfolio plan for each of a plurality of values of said first item of said financial plan.

65. A method, as claimed in claim 64, wherein:
said first item of said financial plan is said time horizon.

66. A method, as claimed in claim 64, wherein:
said displaying step includes showing on said sensitivity graph values for said first criterion of a second portfolio plan for each of a plurality of values of said first item of said financial plan.

67. A method, as claimed in claim 64, wherein:
said displaying step includes showing on said sensitivity graph a plurality of curves each representing a different value for a second item of said financial plan and showing values of said first criterion of said first portfolio plan for each of a plurality of values of said first item of said financial plan.

68. A method, as claimed in claim 64, wherein:
said displaying step includes choosing by the user of a value for each of a number of items of said financial plan and displaying a corresponding value of said first criterion for said first portfolio plan.

69. A method, as claimed in claim 1, wherein:
said obtaining step includes providing a user interface on a screen of a computer or other electronic device for user selectable display of said information including entry boxes in which the user may make entries or changes in said information and buttons or other interaction objects by which the user may make selections pertaining to said information.

70. A method, as claimed in claim 1, wherein:
said providing step includes providing a user interface on a screen of a computer or other electronic device for user selectable display of a number of said comparisons, graphs, and information on portfolio plans, including scrollbars, buttons, or other objects through which the user may make selections and carry out other interactions relative to said comparisons, graphs, and information.

71. An apparatus that relates to finding best investment portfolio plans for long-term financial plans and goals, comprising:
computer memory for storing information on a plurality of investment categories, information on a financial plan, and information on portfolio plans, said information on a plurality of investment categories including data on return rates per investment period including an expected return rate and a return rate standard deviation for each of said investment categories and a return rate correlation coefficient for each pair of said investment categories; said information on said financial plan including a time horizon comprising a plurality of investment periods, at least a first investment amount in a portfolio plan in a first investment period in said time horizon, and at least a second investment amount put into or a first withdrawal amount taken from said portfolio plan in a subsequent investment period of said time horizon; and said information on portfolio plans including information useful for defining a series of portfolio plans in which at least a first portfolio plan in a series comprises a plurality of portfolios, each portfolio being a number of said investment categories in particular unique allocation proportions; and
at least a first computer processor for providing at least a first comparison of a series of best-diversified portfolio plans with respect to at least a first criterion relative to the final wealth of a portfolio plan, wherein:
each of said best-diversified portfolio plans conforms to said information on portfolio plans and comprises a number of best-diversified portfolios, each of said best-diversified portfolios having an expected return rate and the smallest return rate standard deviation of any portfolio having the same said expected return rate in a population of portfolios each comprising a number of said investment categories;
said final wealth is the value of a portfolio plan at the end of said time horizon using said portfolio plan for said financial plan and has a probability distribution; and
said first criterion comprises a value for said final wealth and a probability that said final wealth will equal or exceed said value and is determined for a portfolio plan using simulation.

72. An apparatus, as claimed in claim 71, further comprising:
an electronic display screen for displaying at least said first comparison including display of said first comparison in a graph.

73. An apparatus, as claimed in claim 71, further comprising:
input devices for the user to enter, select, change, and otherwise determine said information and information on portfolio plans and to interact with said comparisons including selection of said information and comparisons to be displayed on an electronic display screen.

74. An apparatus, as claimed in claim 71, further comprising:
communication devices for obtaining electronically said information from other computers and for sending said information and comparisons to other computers.
